(19) United States
(12) Patent Application Publication
(10) Pub. No.: US 2023/0221611 A1
(43) Pub. Date: Jul. 13, 2023

(54) Multi-Layer Polymorphic Dashboard

(71) Applicants: Paul Atkinson, Poway, CA (US); John Rilum, Tustin, CA (US); Ben Reeves, Missoula, MT (US)

(72) Inventors: Paul Atkinson, Poway, CA (US); John Rilum, Tustin, CA (US); Ben Reeves, Missoula, MT (US)

(21) Appl. No.: 17/572,902

(22) Filed: Jan. 11, 2022

(51) Int. Cl. G02F 1/1676; G02F 1/155; G02F 1/167

(52) U.S. Cl. CPC G02F 1/1676; G02F 1/155; G02F 1/167

(57) ABSTRACT

Described herein is a polymorphic dashboard that has (1) a first set of indicators with front and back electro-optic layers having different operable properties and (2) a second set of indicators with a front and back electro-optic layers having different operable properties. Of the four electro-optic layers, at least one of the layers has different operable properties as compared to the others. For each indicator, its optical state is a composite of the optical states of that indicator's front electro-optic layer and back electro-optic layer.

### RELATED APPLICATIONS

This application is a continuation in part to U.S. patent application Ser. No. 16/553,572, filed Aug. 28, 2019 and entitled “Polymorphic electro-optic Displays,” which claims priority to U.S. provisional patent application No. 62/723,835, filed Aug. 28, 2018, and entitled “Novel Display Device.” This application is also a continuation-in-part application to U.S. patent application Ser. No. 15/958,813, filed Apr. 20, 2018, and entitled “Polymorphic electro-optic Displays,” which is a continuation in part application to U.S. patent application Ser. No. 15/890,312, filed Feb. 6, 2018, and entitled “Polymorphic Electro-Optic Displays,” which claims priority to U.S. provisional patent application No. 62/478,216, filed Mar. 29, 2017 and entitled “Hybrid Displays,” and to U.S. provisional patent application No. 62/455,502, filed Feb. 6, 2017, and entitled “Hybrid Displays,” all of which are incorporated herein by reference. This application also claims priority to U.S. provisional applications Nos. 63/139,201; 63/141,763; 63/144,776; and 63/168,750. This application is related to U.S. patent application Ser. No. 13/002,275, filed Dec. 30, 2010, now issued as U.S. Pat. No. 9,030,724; and to U.S. patent application Ser. No. 14/797,141, filed Jul. 12, 2015, both of which are incorporated herein by reference.

### FIELD OF THE INVENTION

The field of the invention is manufacture and use of electronic displays comprised of electro-optic pixels.

### BACKGROUND

The internet of things (IoT) and other emerging markets for inexpensive, and often disposable, intelligent electronic devices are creating demand for smaller, thinner, often flexible, ruggedized, and fit-for-purpose electro-optic displays. Currently known display devices are constructed of multiple pixels, that when viewed together, display a message or symbol to the user. The pixels of these conventional displays, are of the same type. A mono-stable display for example will have only mono-stable pixels while a bi-stable display will have only two stable-states, electrically switchable pixels. The pixels of common (non cholesteric) LCDs are mono-stable, but each is the same as the others. The pixels of three-color electrophoretic displays are multi-stable, that is they are stable in three states, but the pixels themselves are all the same.

### SUMMARY

Described herein is an emissive/non-emissive display, which is a unitary apparatus constructed such that a wide variety of electro-optic functions are enabled. The emissive/non-emissive display, even when having multiple pixels, enables sharing of selected structures among the pixels. In a multi-pixel construction, there sets of pixels in the display that exhibit different combinations of emissive and non-emissive properties, and advantageously operable properties, such as stability, sequencing, and switching properties, and another set of pixels that are different from the first set. In such a way, a highly flexible emissive and non-emissive may be construed to satisfy a wide range of display needs. The emissive and non-emissive display may be polymorphic.

Also described herein is a polymorphic display, which is a unitary apparatus constructed such that a wide variety of electro-optic functions are enabled. The polymorphic display, even when having multiple pixels, enables sharing of selected structures among the pixels. In a multi-pixel construction, there is a set of pixels in the display that exhibit one set of operable properties, such as particular stability, sequencing, and switching properties, and another set of pixels that are different from the first set. That is, they have different stability, sequencing, or switching properties. In such a way, a highly flexible polymorphic display may be construed to satisfy a wide range of display need.

The ability to create different, fit-for-purpose transition sequences is an important benefit of polymorphic displays and as described below, of polymorphic pixels. Of particular benefit of the property of transition sequencing is the ability to selectively and dynamically determine and effect a transition sequence, and therefore the operable properties of a polymorphic pixel or polymorphic display, responsive to different electrical signals. And further, where the electrical signals are generated responsive to various conditions, events and actions etc., such as those common to intelligent display devices described later herein.

### BRIEF DESCRIPTION OF THE DRAWINGS

FIG. 1 is a diagram showing operable states and corresponding optical states for a display in accordance with the present invention.

FIG. 2 is a diagram showing operable states and corresponding optical states for a display in accordance with the present invention.

FIG. 3 is a diagram showing operable states and corresponding optical states for a display in accordance with the present invention.

FIG. 4 is a diagram showing operable states and corresponding optical states for a display in accordance with the present invention.

FIG. 5A is a block representative of a display in accordance with the present invention.

FIG. 5B is a block representative of a display in accordance with the present invention.

FIG. 6A is a block representative of a display in accordance with the present invention.

FIG. 6B is a block representative of a display in accordance with the present invention.

FIG. 6C is a block representative of a display in accordance with the present invention.

FIG. 6D is a block representative of a display in accordance with the present invention.

FIG. 6E is a block representative of a display in accordance with the present invention.

FIG. 7 is a diagram showing operable states and corresponding optical states for a display in accordance with the present invention.

FIG. 8 is a diagram showing operable states and corresponding optical states for a display in accordance with the present invention.

FIG. 9A is a block representative of a display in accordance with the present invention.

FIG. 9B and FIG. 9C are block representatives of a display in accordance with the present invention.

FIG. 10A is a block representative of a display in accordance with the present invention.

FIG. 10B is a block representative of a display in accordance with the present invention.

FIG. 11 is a legend to the stippling used in the Figures.

FIG. 12A is a block representative of a display in accordance with the present invention.

FIG. 12B is a block representative of a display in accordance with the present invention.

FIG. 12C is a block representative of a display in accordance with the present invention.

FIG. 12D is a block representative of a display in accordance with the present invention.

FIG. 13 is a diagram showing operable states and corresponding optical states for a display in accordance with the present invention.

FIG. 14 is a block representative of a display in accordance with the present invention.

FIG. 15A is a block representative of a display in accordance with the present invention.

FIG. 15B is a block representative of a display in accordance with the present invention.

FIG. 15C is a block representative of a display in accordance with the present invention.

FIG. 15D is a block representative of a display in accordance with the present invention.

FIG. 15E is a block representative of a display in accordance with the present invention.

FIG. 16A is a block representative of a display in accordance with the present invention.

FIG. 16B is a block representative of a display in accordance with the present invention.

FIG. 16C is a block representative of a display in accordance with the present invention.

FIG. 17 is a diagram showing operable states and corresponding optical states for a display in accordance with the present invention.

FIG. 18 is a diagram showing operable states and corresponding optical states for a display in accordance with the present invention.

FIG. 19 is a diagram showing operable states and corresponding optical states for a display in accordance with the present invention.

FIG. 20A is a block representative of a display in accordance with the present invention.

FIG. 20B is a block representative of a display in accordance with the present invention.

FIG. 20C is a block representative of a display in accordance with the present invention.

FIGS. 21A-G each illustrate a block representative of a display in accordance with the present invention.

FIG. 22 is a block representative of a display in accordance with the present invention.

FIGS. 23A-B each illustrate a block representative of a display in accordance with the present invention.

FIGS. 24A-B are diagrams showing operable states and corresponding optical states for a display in accordance with the present invention.

FIG. 25 is a diagram showing operable states and corresponding optical states for a display in accordance with the present invention.

FIG. 26 is a diagram showing operable states and corresponding optical states for a display in accordance with the present invention.

FIG. 27 is a diagram showing operable states and corresponding optical states for a display in accordance with the present invention.

FIG. 28 is a diagram showing operable states and corresponding optical states for a display in accordance with the present invention.

FIG. 29A is an illustration of an exemplary polymorphic dashboard.

FIGS. 29B-D are diagrams showing operable states and corresponding optical states for a display in accordance with the present invention.

FIG. 29E is an illustration of different visual messages presented by the exemplary polymorphic dashboard of FIG. 29A.

FIG. 30A is an illustration of an exemplary polymorphic dashboard.

FIGS. 30B-C are diagrams showing operable states and corresponding optical states for a display in accordance with the present invention.

FIG. 30D is an illustration of different visual messages presented by the exemplary polymorphic dashboard of FIG. 30A.

### DESCRIPTION

Described herein are polymorphic electro-optic displays (“polymorphic displays”). Polymorphic displays are unitary apparatus having multiple operable properties. Of particular interest are the operable properties, individually and in combination, of stability, switching and transition sequencing.
Mono-stable, bi-stable, multi-stable, permanent
Electrically switchable, self-switchable, non-switchable
Reversible, irreversible, repeatable

Polymorphic displays may be constructed to have multiple types of electro-optic display pixels (“pixels”), each type having different operable properties. Polymorphic displays may also be constructed with “polymorphic pixels” described herein, that individually have multiple operable properties, and are independently operable to produce different operating states.

The operable properties of a polymorphic display's pixels determine its possible operating states, e.g. whether the pixel is stable or volatile, switchable or self-switching from one state to another or not switchable once in a previously switched to state, or the transition sequence is forward, forward-only (irreversible), reverse, or branching, or a combination thereof.

The optical state of a polymorphic display's pixel corresponds to the pixel's operating state[s] according to the pixel's optical properties. For example, one polymorphic display pixel may be white in a stable, first state, and dark blue in a volatile, second state, and red in a third, stable state.

It is important to note that the pixels of conventional electro-optic displays, are of the same type. A mono-stable display for example will have only mono-stable pixels while a bi-stable display will have only two stable, electrically switchable pixels. The pixels of common (non cholesteric) LCDs are mono-stable, but each is the same as the others. The pixels of three-color electrophoretic displays are multi-stable, that is they are stable in three states, but the pixels themselves are all the same.

Pixels have at least two optical states according to their optical properties that typically include color perceptible to the human eye. For a passive (non-emissive) display pixel the optical state of the pixel may in general be determined by the resulting optical reflectivity, transmission, or polarization, of the pixel (at a specific wavelength or wavelength range of the illuminating source), whereas for an emissive display it may be determined by the intensity, polarization and spectral composition of the emitted light. In the case of displays intended for machine reading, the optical state of the pixel may, e.g., be determined by a pseudo-color in the sense of a change in reflectivity at electromagnetic wavelengths outside the human visible range.

Pixels may be of various sizes, shapes, patterns and configured to stand alone or in groups (e.g. as segments to create alphanumeric characters, or RGB super pixels). Pixels typically comprise an electro-optic layer with electrodes either in direct contact with, or in close proximity to, the electro-optic layer. Depending on desired operable properties of the display pixels, the composition of their electro-optic layers may comprise for example, electrochromic materials, liquid crystals, electrophoretic particles, electrowetting fluids, electro-liquid powder materials, etc.

Display pixels may be categorized according to the operable properties associated with them being mono-stable, bi-stable and multi-stable, and polymorphic. Descriptions of the pixel types are described in general below, and later in detail.

Mono-Stable Pixels

Mono-stable pixels have one, stable operating state (and corresponding optical state) and a second, volatile operating state (and corresponding optical state). Mono-stable pixels also have the stability operable properties of being reversible and self-switching. That is, they automatically, or “self”, switch from their volatile operating state to back their stable, first operating state when power to the pixel is terminated (or drops below a threshold necessary to maintain the state).

A mono-stable pixel's first, operating state is stable without power. When an electrical switching signal is applied to a mono-stable pixel, the pixel transitions from a stable, first operating state to a volatile, second, operating state. The volatile operating state is maintained as long as a maintenance signal is applied to the pixel. When the maintenance signal is terminated (for whatever reason) the pixel self-switches from the second operating state back to the first, stable operating state. Examples of mono-stable displays comprised of mono-stable pixels are common LCDs (liquid crystal displays), EPDs (electrophoretic and ECDs (electrochromic displays), and LEDs (light-emitting diodes) and OLEDs (organic light-emitting diodes).

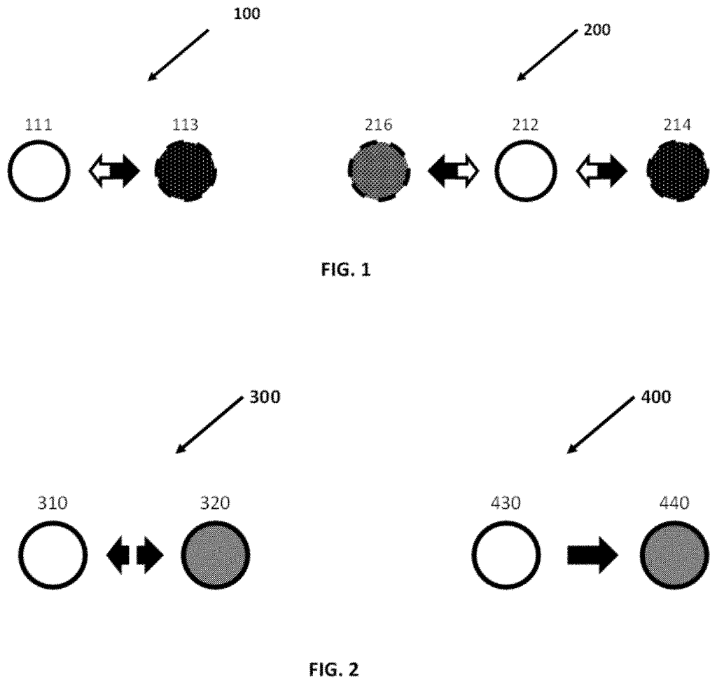

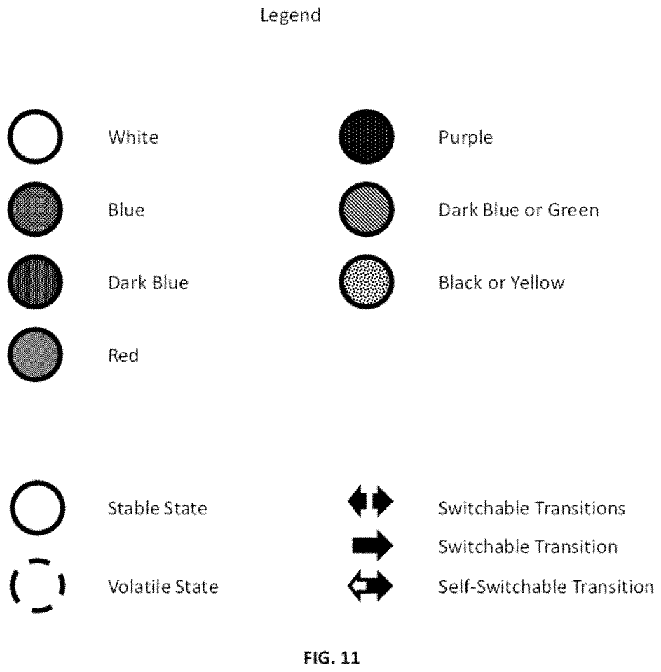

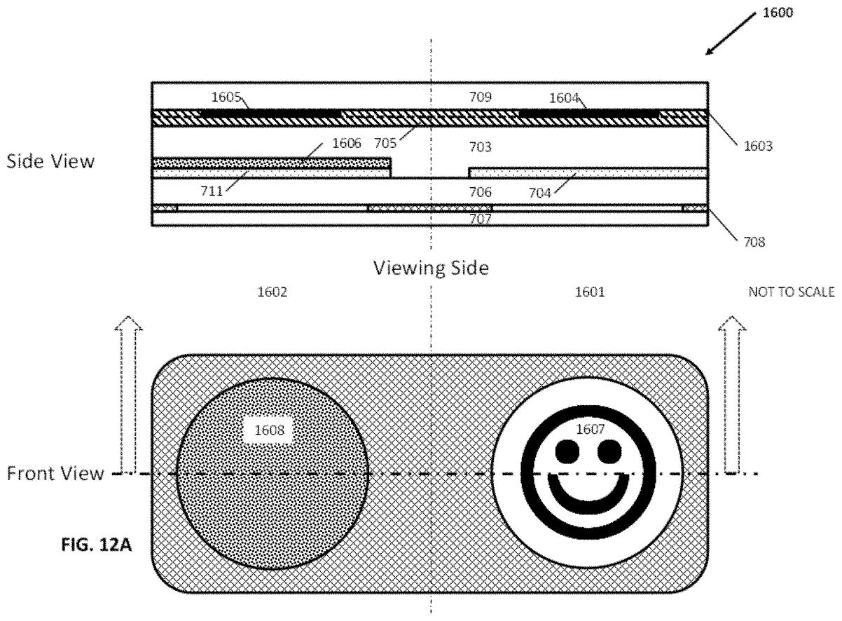

The operable states and corresponding optical states of an exemplary mono-stable pixel 100 are illustrated in FIG. 1. In this example, the first operating state 111 is stable and switchable, and its corresponding optical state (color) is white. Note that FIG. 11 presents a legend for colors-to-patterns, shapes and symbols used in the other figures. The second operating state 113 is volatile, self-switchable (reversible), and its corresponding optical state is purple. When self-switched (power is terminated to the pixel) the pixel transitions back (reverses) to the stable, first operating state 111, and corresponding optical state (white).

FIG. 1 Also illustrates a mono-stable pixel 200 similar to mono-stable pixel 100. Mono-stable pixel 200 however has an optional second volatile, self-switching operating state 216, and a corresponding blue optical state. As with the first volatile, self-switching operating state of pixel 100, pixel 200 self-switches from the optional second volatile operating state 216 to the stable, first operating state 212 when power to the pixel is terminated or disrupted.

The pixel 200 has the transition sequence property (described later) of branching, that is the property whereby the transition sequence depends on the current state of the pixel and the switching signal. In this example, a first switching signal transitions the pixel from its stable, switchable first operating state 212 to a first volatile, self-switchable operable state 214, and a corresponding optical state, in this case purple. After the pixel 200 has self-switched to the stable, switchable first operating state 212, a second switching signal (different than the first) transitions the pixel to a second volatile, self-switchable operable state 216, and corresponding optical state, in this case blue.

Bi-Stable and Multi-Stable Pixels

Bi-stable pixels have two stable operating states. Switching between the two, stable operating states is accomplished with an electrical switching signal. Once switched, the operating state (and the corresponding optical state) persists when the power is terminated (without a maintenance signal).

Bi-stable pixels may be reversible (e.g. EPDs, conventional ECDs, cholesteric, ferroelectric or zenithal bistable LCDs) or irreversible (as described in U.S. Pat. No. 9,030,724 Flexible and Printable Electrooptic Devices). Conventional bi-stable pixels are electrically switched and are not self-switching (but always switchable). Some pixels characterized as bi-stable however, have limited persistence in one or the other optical states. In other words, some bi-stable pixels are self-switching over time. Such pixels, may therefore be more accurately considered mono-stable with limited persistence in the second operating state (the first being unpowered).

The operable states and corresponding optical states of exemplary bi-stable pixels are illustrated in FIG. 2. Pixel 300 has a first operating state 310 that is stable and switchable, and a corresponding optical state (color) that is white. The second operating state 320 is also stable and switchable (and reversible), and its corresponding optical state is red. Note that a maintenance signal is not required for the pixel to remain in the second operating state once switched from the first operating state. Note further that the second operating state is not self-switching, and a switching signal is required to switch from the second, stable operating state, and corresponding optical state, back to the first stable operating state.

Pixel 400 is also bi-stable however unlike the pixel 300 in the previous example, once switched from the first stable, switchable operable state 430 to the second, stable operable state 440, pixel 400 is non-switchable (not switchable or self-switching). In the second operable state, pixel 400 is irreversible and permanent. It cannot be switched (transitioned from the second operable state to the first) and has the stability property of being non-switchable and a transition sequence property of being irreversible.

In addition to bi-stable pixels there are a few types of multi-stable pixels, typically having three, stable states. One example are the pixels in three-color, electrophoretic displays. Each pixel contains three distinct particle types (e.g., pigment or dye particle) corresponding to different colors. Note however that as with conventional mono-stable and bi-stable displays, the operable properties of the pixels are the same.

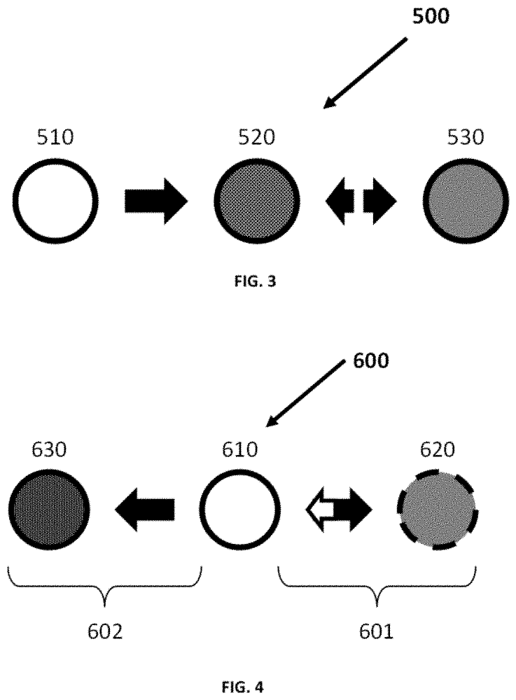

The operable states of a multi-state pixel 500 are illustrated in FIG. 3. In the first operating state 510 pixel 500 is stable, switchable (forward-only, irreversibly) with a corresponding optical state (color) that is white. The second operating state 520 is also stable and switchable, with a corresponding optical state (color) that is blue. In the second operating state however, the transition sequence is forward-only to the third operating state 530. It cannot be switched to the first stable operating state from the second stable operating state. The third operating state 530 is also stable and switchable, and has a corresponding optical state (color) that is red. Unlike the pixel when in the second operating state 520, when the pixel is in the third stable operating state 530, it can be switched back to its previous operable state 520. And further, unlike the transition from the first operating state to the second, the transitions from the second operating state to the third operating state, and the reverse, are repeatable. The transition sequence therefore comprises three inter-state transitions (described later), one which is forward-only and irreversible, and two that are forward-only, reversible and repeatable.

Polymorphic Pixels

Polymorphic pixels may be constructed to have various combinations of operable properties. Polymorphic pixels have at least two stable operating states, an unpowered, first state and at least one other stable state which may for example be irreversible and permanent as previously described. They also have one or more volatile operating states.

FIG. 4 illustrates the operable states of a polymorphic pixel 600. The pixel has two stable operating states 610 and 630 and one volatile operating state 620. Pixel 600 also has two transition sequence branches 601 and 602. The transition sequence branch is selected with a switching signal that determines the next operating state. Branch 601 comprises a first operating state 620 that is stable, switchable with a corresponding optical state (color) that is white. Branch 601 also comprises a second operating state 620 that is volatile, self-switching with a corresponding optical state (color) that is red. Upon termination or disruption of a maintenance signal, pixel 600 will self-switch and transition from the volatile, self-switching state 620 to the previous operating state 620. Branch 601 comprises two inter-state transitions which are both reversible and repeatable, until and unless, transition sequence branch 602 is selected with a switching signal that transitions to operating state 630.

Branch 602 comprises the same first operating state 620 as branch 601, however unlike branch 601 it has a second operating state 630 that is irreversible and permanent. Because operating state 630 is irreversible and permanent, branch 602 comprises only one inter-state transition, a forward, irreversible transition from operating state 620 to operating state 630. Once switched (transitioned) along branch 602 to operating state 630 by an appropriate switching signal, the pixel is no longer switchable (non-switchable). In total the transition sequence property for pixel 600 includes three inter-state transitions (two repeatable, and one irreversible).

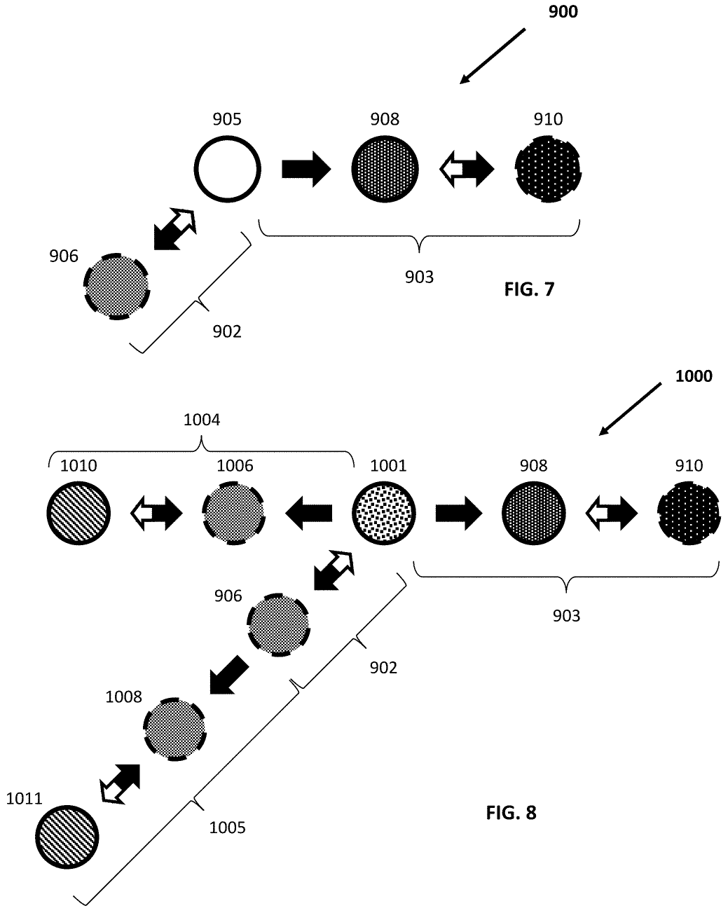

FIG. 7 illustrates the operable states of another exemplary polymorphic pixel 900. The pixel in this case has two stable operating states 905 and 908 (and two corresponding optical states, white and black respectively). Pixel 900 also has two volatile operating states 906 and 910 (and two corresponding optical states, red and purple respectively). In total, polymorphic pixel 900 has four possible operating states and corresponding optical states (red, white, black and purple). Unlike polymorphic pixel 600 polymorphic pixel 900 has a transition sequence comprising two branches 902 and 903. The branch selected depends on the switching signals and the prior operating states of the pixel. In the first operating state 905 pixel 900 is stable, switchable with a corresponding optical state (color) that is white. The transition sequence along branch 902 consists of a stable, switchable first operating state and a volatile, self-switching second operating state. Branch 902 is reversible and repeatable until the pixel is operably switched to branch 903.

The transition sequence along branch 903 consists of the same first operating state 905, stable, switchable with a corresponding optical state (color) that is white. Branch 903 also comprises a stable, switchable second operating state 908 with a corresponding optical state (color) that is black. Once switched from the first operating state 905 to the second operating state 908, the pixel cannot transition back to operating state 905. The transition sequence from 905 to 908 is not reversible (irreversible) and is therefore not repeatable. From operating state 908 the transition sequence is only forward to operating state 910. The third operating state 910 along branch 903 is volatile, self-switching with a corresponding optical state (color) of purple. The inter-state transitions between operating states 908 and 910 are therefore reversible and repeatable.

The transition sequence along the entire branch 903 from operating state 905 to operating state 910 includes both forward, irreversible transitions and forward, reversible transitions. Note that the once the polymorphic pixel 900 is switched and transitions to branch 903 (from operating state 905 to operating 908) it cannot be switched, transition to branch 902 and operating state 908. The polymorphic pixel 900 can however effect different operating states along branch 902 and then switch be switched, transition to branch 903.

Transition Sequencing

An operable property of pixels is transition sequencing, that is, the property of being able to transition between multiple, different operating states in sequences that include forward, forward-only (irreversible), reverse (reversible), repeatable and non-repeatable and combinations thereof. A transition sequence is comprised of inter-state transitions, that is transitions between two consecutive operable states of a pixel. Exemplary transition sequences are described below and illustrated in embodiments 100, 200, 300, 400, 500, 600, 900, and 1000. Transition sequencing also includes branching. Branching is the property of being able generate different sequences of inter-state transitions from a particular operable state of the pixel. A branch is created by effecting one of a plurality of transitions according to different electrical signals. Embodiment 200 illustrates simple transition sequence including branching for a mono-stable pixel. Of particular interest are complex transitional sequences for polymorphic pixels including branching properties such as those illustrated in embodiments 900 and 1000.

Note that the conventional terms reversible and irreversible imply the ability, or lack of ability, of a pixel to reverse or switch back to a previous operating state. Polymorphic displays introduce the ability to electrically switch (with a switching signal) or self-switch (by terminating a maintenance signal) the operating state from one to another operating state that is other than the previous one. Note as well, that the transition sequencing property of polymorphic pixels can be produced using a variety of different polymers and combinations of them, e.g. with mixtures combining more than one type, or depositing more than one layer of them within the polymorphic pixel.

The ability to create different, fit-for-purpose transition sequences is an important benefit of polymorphic displays and as described below, of polymorphic pixels. Of particular benefit of the property of transition sequencing is the ability to selectively and dynamically determine and effect a transition sequence, and therefore the operable properties of a polymorphic pixel or polymorphic display, responsive to different electrical signals. And further, where the electrical signals are generated responsive to various conditions, events and actions etc., such as those common to intelligent display devices described later herein.

Polymorphic Displays

In its simplest embodiment, a polymorphic display is an electro-optic display comprising a single polymorphic pixel. More typically however, a polymorphic display is a unitary apparatus constructed having at least two pixels, the pixels having at least some of the following elements in common: structure, materials, circuitry, and optionally a display driver IC. As previously described, the display pixels may be of different types according to their operable properties.

The structure of a polymorphic display determines its physical form. The structure comprises for example, substrates, spacers, matrices, separators, spacers, barriers, sealants, transparent/viewing surfaces (e.g. ‘windows’) etc. typically, but not always, organized in layers that preferably lend themselves to high volume manufacturing processes (e.g., printing, spray casting, roll-to-roll manufacturing etc.). A polymorphic display's structure complements that of the electro-optic materials, other materials (e.g. adhesives) and electrical circuitry (including electrodes). For example, the electro-optic layers of different pixel types (e.g. electrochromics, LCDs, EPDs etc.) are often constructed with materials that are fluid or semi-solid and therefore that depend on various structures to hold them. And importantly, to reliably couple to the electrical circuitry.

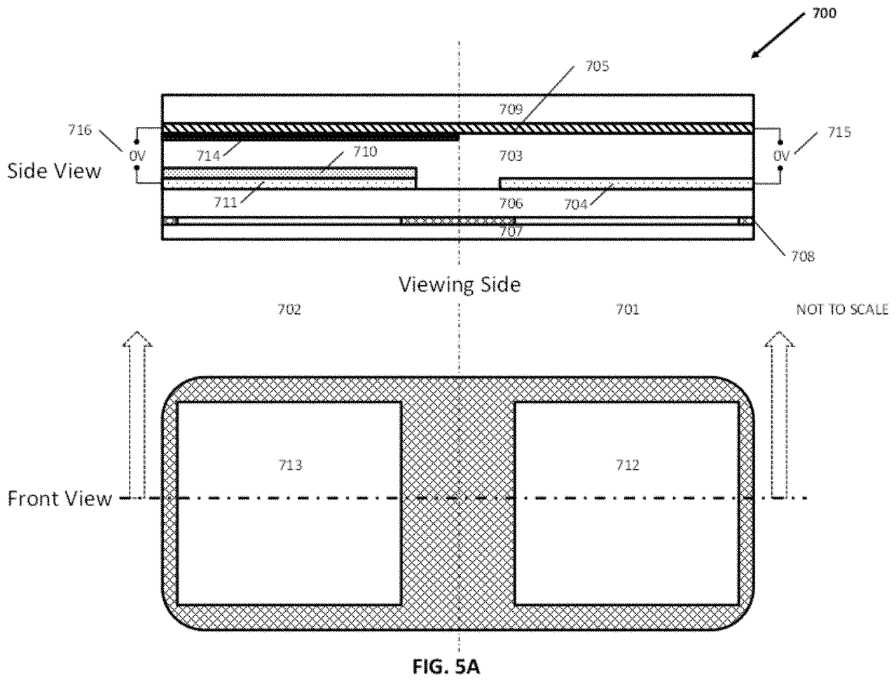

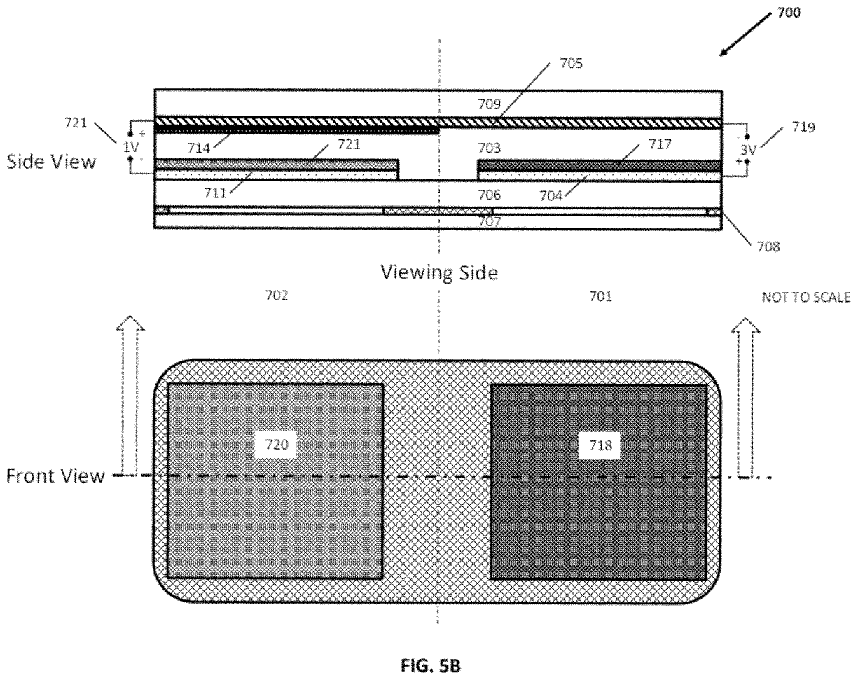

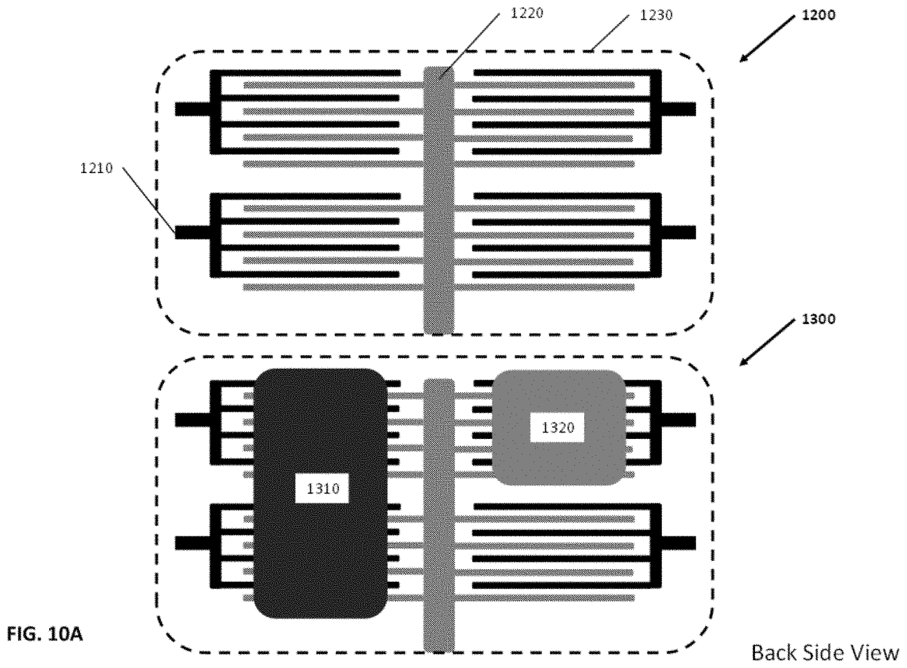

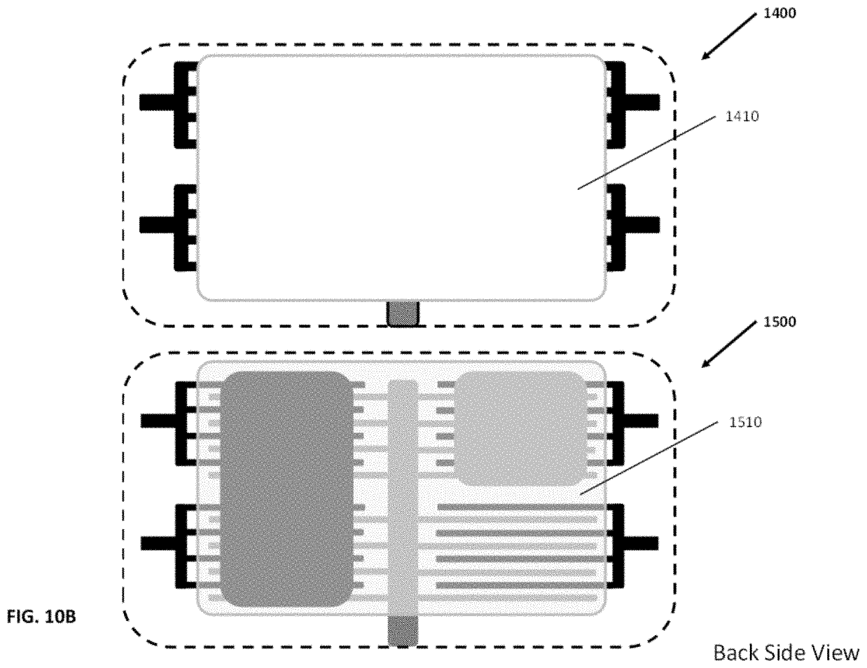

A polymorphic display's electro-optic layer, and the pixels of which they are made, may share common materials. Such materials may for example be constructed as a single, continuous layer across multiple pixels, such as the electrolyte illustrated in FIGS. 5A and 10A. Alternatively, a material (e.g. the electro-optic material 710 of FIG. 5A and 1310 and 1320 of FIG. 10A) may be common to some but not all the pixels, and may be constructed as discrete, spatially separated elements within same physical layer (or the same manufacturing process). Such patterning advantageously allowing for other common materials to be interspersed among them.

As noted previously, a pixel comprises an electro-optic layer with electrodes either in direct contact with, or in close proximity to, the electro-optic layer. The electrodes are configured for applying electrical signals to the pixels individually or in groups and are typically formed on common structure (e.g. flexible substrates or layers). The electrodes may be configured in various ways including vertical (e.g. on the top and bottom surfaces of an electro-optic layer, interdigitated (both electrodes are on the same layer), or combinations of both. Typically, but not always, the electrodes on the side or sides of the electro-optic layer facing the viewing surface or surfaces, are transparent e.g. ITO or transparent, conductive silver-inks patterned on PET.

The pixel electrodes may be exposed for connection to circuitry of another device such as an intelligent display device describe herein. The electrodes may also be coupled to additional circuitry and components (e.g. display driver IC, backplane etc.) constructed as part of the polymorphic display apparatus (e.g. using common structure), for pixel addressing, signal management/noise reduction, visible verification (such as that described in U.S. patent application Ser. No. 14/927,098 Symbol Verification for an Intelligent Label Device, and Ser. No. 15/368,622 Optically Determining Messages on a Display) etc.

As illustrated in FIGS. 5A, 6A and 9A, exemplary display pixels 700, 800 and 1100 are configured with electrodes on the surfaces of the electro-optic layer (e.g. front and back). The electrodes however may be configured as interdigitated pairs located on a single surface. This may allow for simpler, lower cost manufacture, thinner devices, and in some cases may advantageously enable different operable and optical properties. And in some designs, interdigitated electrodes may work cooperatively with conventional surface electrodes. FIGS. 10A and 10B is an exemplary four-pixel structure employing interdigitated electrodes and different, patterned material layers to create pixels having different operable (and associated optical) properties. The viewing perspective is from the back of the structure. Note that the illustrations are intended only to focus on certain elements of a polymorphic display and not completed devices. Note further, the common material layers of which some are patterned and some continuous across the pixels.

The first layer 1200 of the four-pixel structure (viewed from the back) is a transparent substrate 1230 having interdigitated electrode 1220 and four companion electrodes 1210 (of which only one is numbered). Electrode 1220 is common to the four companion electrodes, all of which are collectively part of the display circuitry. Each of the interdigitated patterns are the foundation for four individual pixels. Structure 1300 shows layer 1200 with printed (or otherwise deposited) polymer 1310 and a different polymer 1320. Polymer 1310 spans two pairs of interdigitated electrodes so the corresponding pixels will have the same operable properties. Polymer 1310 covers a single electrode pair and the corresponding pixel will have operable properties different from the other three. Structure 1400 shows layer 1300 with a printed (or otherwise deposited) opaque electrolyte 1410. Electrolyte 1410 is an opaque EC mix. In this example, all three of the pixels with polymer layers will have the properties of being volatile, self-switchable. The fourth interdigitated electrode pair (the one without a polymer layer) will have the properties of being stable, switchable, irreversible and permanent. Structure 1500 is the same as structure 1400 with a transparent EC mix instead of the opaque EC mix 1410. This integrated, process friendly structure comprises four separately operable pixels, three having the properties of being volatile, self-switching (two of one type, and one of another) and one having the same operable properties of being irreversible and permanent.

Signal Protocol

A signal protocol is used by the processor to manage the different switching signals and maintenance signals according to the types of pixels which comprise the polymorphic display. The signal protocol provides the timing, duration, pattern (e.g. pulse shape, sequence), frequency, voltage or current, polarity etc. required by the processor to generate the appropriate signals.

Switching Signal

A switching signal is an electrical signal applied to a pixel for setting the operating states of the pixel (e.g. for switching from one operating state to another).

Maintenance Signal

A maintenance signal is an electrical signal applied to a pixel in a volatile state (self-switching) to maintain its current operating state. The maintenance signal is often different from the switching signal that switched the pixel to the current volatile operating state that is maintained by the maintenance signal.

Intelligent Display Device

An intelligence display device is an apparatus comprising a polymorphic display, and some or all of electronics, a power apparatus and appropriate to the application, a communication apparatus, sensors, and actuators. An intelligent display device is typically a unitary apparatus configured to be coupled or combined with a good or its packaging. Often, but not always, the intelligent display device is low cost, often disposable, low power and small in size. In some applications, though the intelligent display device is significantly larger and designed to present high-content messages or messages to be read by humans or machines at a distance. Exemplary configurations include labels, patches, tags, smart-cards, loyalty cards, packaging, containers, seals, caps, documents, test/sensing/monitoring devices, terminals, electronic-shelf labels, free-standing displays, electronics devices etc.

Electronics

In addition to a polymorphic display, intelligent display device includes electronic functions, for example, processor, memory, clock/timer, security, verification, communications and sensors, etc. that may be integrated into a single electronic device or implemented with discrete components.

The electronics will also typically include display driver circuitry configured to store and process appropriate data and algorithms (e.g. a signal protocol), temperature compensation etc. to generate the electricals to the polymorphic display and pixels it comprises. The display driver circuitry may be advantageously configured with the processor and memory or one or more separate components. And further, the display driver circuitry may be configured as part of the polymorphic display or as part of the electronic functions of the intelligent display device, or, distributed between the two.

Power Apparatus

The intelligent display device includes one or more power apparatus for powering the electrical functions in the intelligent label including a polymorphic display. Exemplary power apparatus include internal energy storage such as batteries or charged capacitors, wired interfaces capable of receiving electrical energy, wireless energy harvesters, or a combination thereof. The energy harvester for example, may produce electric energy from light (e.g. solar cell), RF energy (e.g., antenna/rectifier), thermal energy (e.g., thermopile), or shock and vibration (e.g. strain gauges, nanogenerators, MEMS devices) that the intelligent label device is subject to.

Communication Apparatus

Typically, the intelligent display device also has electronics that enable wireless or wired communication to or from the intelligent label. Exemplary wireless communication apparatus includes those that support Wi-Fi, Bluetooth, BLE, RFID (e.g. RAIN or NFC), ZigBee and other local area wireless networks, low power wide area (LPWN) and cellular and other wide area networks. Intelligent display devices may include support for portable memory chips, cards, sticks and other portable memory storage devices.

Sensors

An intelligent display device may have one or more sensors sensing the inside or outside environment (outside or inside the intelligent display device), the polymorphic display or other components or systems of the intelligent display device. Exemplary sensors include a temperature sensor, a humidity sensor, and altitude sensor, a pressure sensor, an optical sensor, a vibration sensor (including a shock sensor), a humidity sensor, biological or a chemical sensor (including a gas sensor, a pH sensor), a magnetic sensor, a smoke sensor, a radiation sensor etc. It will be appreciated that a wide variety of sensors could be used depending upon the particular application.

Actuators

Depending on the application, an intelligent display device, may have one or more actuators. Actuators activate, deactivate or otherwise effect control over electrical functions in the intelligent display device in response to external or internal stimulus, e.g. mechanical action, sensor input, electrical or wireless signals etc. Actuators may be used to activate different electrical functions at different times, e.g. when an item is shipped (the package is sealed) or when an item is received (the package is opened).

Actuators may also minimize power consumption, and thereby maximizing the shelf-life/operating life of intelligent display devices having internal power apparatus, by activating electronics only when appropriate to the application. Actuators, in cooperation with timers/clocks may also be used to establish the time/date an event occurs.

Exemplary actuators include mechanical switches (e.g. the open or close an electrical circuit), electro-optic, electrochemical, electro-mechanical and electro-acoustic devices, wired connectors (for receiving electrical signals), wireless receivers (for harvesting RF energy, receiving RF signals) etc., and are described in U.S. Pat. No. 9,471,862 An Intelligent Label Device and Method.

### Example 1 (Polymorphic Display)

FIG. 5A shows an exemplary configuration of a polymorphic display 700 comprising two pixels, each having different operable properties, in side view and front view. For illustration purposes, only two pixels are shown although it is to be understood that a polymorphic display may comprise many such pixels. The right pixel 701 is bi-stable, having a bi-stable, permanent and irreversible second operating state (such as 200 in FIG. 2), whereas the left pixel 702 is mono-stable and self-switchable (such as 100 in FIG. 1).

In regard to bi-stable pixel 701, detailed embodiments of bi-stable, permanent and irreversible display devices and pixels, are disclosed in U.S. Pat. No. 9,030,724 Flexible and Printable Electrooptic Devices. For simplicity, only the key aspects pertaining to the configuration and function of such pixels within a polymorphic display are described herein and presented in 700 in FIG. 5A. Exemplary embodiment 700 consists of an electro-optic layer 703 further including an electropolymerizable monomer, an electrolyte (e.g. ionic liquid), and (optionally) highly reflective particles (e.g. TiO₂) collectively, here and throughout, referred to as an “EC mix” (“electrochromic mixture”). The EC mix as illustrated is of a substantially uniform composition. The electro-optic layer 703, in this example, the EC mixture, is sandwiched between a pair of electrodes; a front electrode 704 and a back electrode 705. The front electrode is at least partially transparent (e.g. ITO) and configured on a substantially transparent substrate 706 (e.g., glass, plastic, etc.) and is advantageously sealed with a barrier/protective layer. The back electrode 705 and back substrate/barrier 709 may both either be transparent (for front and back side viewing of the display) or opaque (front side only viewing).

An advantageous mono-stable pixel 702 is now described that is complementary to the exemplary bi-stable pixel 701. Mono-stable pixel 702 uses a conjugated (conductive) polymer film 710 that can switch reversibly between two distinctly different operable states when the polymer is in contact with an electrolyte (such as the one contained in the EC mix 703). The operable states correspond to a conductive (oxidized chemical) state and an insulating (neutral or reduced chemical) state according to the presence of a switching signal followed by a maintenance signal, or the termination or disruption of the maintenance signal. In the presence of an electrical switching signal, the pixel 702 transitions from a stable, first state to a volatile second state. The pixel remains in the volatile second state for the duration of the maintenance signal. When the maintenance signal is terminated (or disrupted for any reason) the pixel self-switches (transitions back) to the stable, first state.

Note that the EC mix 703 of pixel 701 comprises an electrolyte that can function as the electrolyte for pixel 702. The monomer and other materials in the EC mix do not prevent the electrolyte from use in both pixels. Furthermore, as illustrated in FIG. 5A, the two pixels can have in common electrode 705, top and bottom substrates 706, 709, and barrier/protective layer 707. Additionally, they can share a common, patterned electrode layer (and manufacturing process) comprising the pixel's respective front electrodes 704 and 711. They can also share mask layer 708 described below. Not shown is the structure that would encapsulate the entire apparatus (e.g. the side barrier/protective structure) and the appropriate display driver circuitry with connections to the pixel electrodes.

In summary, polymorphic display 700 is a unitary apparatus comprising two pixels, each a different type according to their respective operable properties (bi-stable, permanent and irreversible, and mono-stable), and further that have in common, structure, materials and circuitry.

As noted above, the two pixels 701 and 702 share a single, common electrolyte layer. Furthermore, the switching voltages for the polymer films in the mono-stable pixel 702 are typically significantly lower (near 1V) than that typically required for electropolymerization (near 3V) in the bi-stable pixel 701. This provides an upper threshold means to keep the monomer in the EC mix from electropolymerizing yet allowing the self-switching polymer 710 to switch between operating states by applying a switching signal followed by applying and then terminating maintenance signal across the common back electrode layer 705 and the front electrode 711. Although, the front electrodes, 704 and 711, for the two operable pixel types of the polymorphic display 700 can be made of different (transparent conductor) materials, it is preferably made of the same material by patterning a single front electrode layer deposited onto the single substrate 706. Depending on the locations of the address lines/circuitry to the pixel electrodes of the display (not shown in FIG. 5A), while providing a high display contrast (dark background of the pixel openings), it may be advantageous to mask certain areas by an opaque, light absorbing material 708.

Of particular interest are self-switching mono-stable electrochromic polymers having one stable and one volatile operating state, and two corresponding optical states. These self-switching polymers may be divided into two groups according to their chemical properties corresponding to their operable properties.

One group of electrochromic polymers are switchable from a stable, un-powered operating state corresponding to an oxidized chemical state, and a corresponding clear optical state, to a volatile, self-switching operating state corresponding to a neutral chemical state, and a corresponding colored optical state, and self-switching back to the stable, un-powered operating state and corresponding oxidized chemical state, and corresponding clear optical state. Exemplary polymers of this type include dioxythiophenes (e.g. certain XDOT, such as PProDOT, PEDOT).

Another group of electrochromic polymers are switchable from a stable, un-powered operating state corresponding to a neutral chemical state, and a corresponding first, colored optical state, to a volatile, self-switching operating state corresponding to an oxidized chemical state, and corresponding second, colored or predominately clear optical state, and self-switching back to the stable, un-powered operating state and corresponding neutral chemical state, and corresponding first, colored optical state. Exemplary polymers of this type include thiophene based polymers (e.g. poly(methylthiophene)).

It should be noted that it is possible to achieve various color combinations by blending of two or more of such polymers within the same group and further switching them according to their specific threshold voltages. Additionally, and apart from electrochromic polymers, certain other materials including those based on transition metal oxides or derivatives of bipyridinium, such as, viologen, are self-switching. For instance, viologen can be adsorbed by a porous material, such as nanoparticle-based TiO₂, to form an active layer (e.g. in place of the polymer layer 710), or added to the EC mix 703, and may additionally function or co-function as the electrolyte.

It may further be advantageous to include an optional layer (also known as a charge storage layer) consisting of a complementary conducting polymer material 714 on the counter (back) electrode 705, to facilitate the self-switching process and/or to add additional material layers to protect the counter (back) electrode 705 from the electrolyte 703. Examples of such polymers include anodically coloring polymers, such as XDOPs (dioxypyrroles) or alternating copolymers of XDOT and carbazoles such as PEDOT-NMe(Cbz), and cathodically coloring polymer such as XDOTs such as PEDOT or PProDOT, which self-switch to an oxidized state. Cathodic materials may also be deposited to protect a bare counter electrode including derivatives of bipyridinium, such as viologen, and anthraquinone and its derivatives in solution. An opaque or reflective (e.g. TiO₂ additive) EC mix may mask the electrochromic characteristics of the above materials, or they may be intentionally included in the resulting optical states as seen from the front side or back side (for a two-sided display).

Self-switching polymer films are typically prepared by spray casting 5 mg/mL polymer solutions in toluene. When cured, the deposited layer may become a film less than sub-micron thick. Self-switching polymers may be deposited onto the electrode using a variety of methods including: spray, spin, or drop casting neutral electrochromic polymer solutions; printing technology such as inkjet printing; dip casting from solution; and oxidative chemical vapor deposition of conducting polymer films or electrochemical deposition. The properties of self-switching polymer films may further be manipulated through a chemical defunctionalization step rendering the film less soluble, allowing for deposition of additional layers such as the layer of EC mix 703.

Referring again to FIG. 5A, an individual pixel of the polymorphic display 700 is switched by an electrical signal applied to its corresponding electrode pair (704 and 705 or 711 and 705). Initially, both the states of the bi-stable pixel 701 and the mono-stable pixel 702 are stable and each having a first, white optical state, 712 and 713, as determined by the reflective TiO₂ of the EC mix and the transmissive property of the electrochromic polymer layer 710. Further, initially the corresponding voltages across each respective electrode pair is 0V (715 and 716).

FIG. 5B illustrates the respective optical states 718, 720 of the polymorphic display 700 after application of respective independent switching signals. The switching signal for irreversibly transitioning the bi-stable pixel 701 into an irreversible and permanent operating state (e.g. dark blue optical state) can be accomplished through a variety of switching protocols such as those disclosed in U.S. Pat. No. 9,030,724 Flexible and Printable Electrooptic Devices and U.S. provisional patent application Ser. No. 14/797,141 Device and Method to Fix a Message on a Display, including e.g. applying a voltage above a certain threshold (as indicated by 719 of e.g. 3V) for a defined time duration (e.g., 2 s). Note that the anode typically is the (front) electrode 704 such that the polymerized monomer 717 is (anodically) formed on or at the electrode, displacing the (white) EC mix and further providing a substantial change of color (e.g. from white to dark blue) as observed from the viewing side. After the switching is complete, the operable (and optical) state will remain as it is permanent and irreversible.

The switching signal for reversibly transitioning the mono-stable pixel 702 into a volatile operating state (corresponding, e.g., to a red color of the polymer layer 721 resulting in a red optical state 720 of the pixel) can be accomplished by, for example, applying a voltage above a certain threshold (as indicated by 721 of e.g. 1V) for a defined time duration (e.g., 1 s). Note that the cathode is the front electrode 711 in case of electrochromic polymers providing chemically neutral (reduced) volatile states (as shown in FIG. 5B) and oxidized stable states (as shown in FIG. 5A) whereas the anode is the (front) electrode in case of electrochromic polymers providing chemically oxidized volatile states and neutral stable states. After the switching is complete, a maintenance signal is applied with the same effective polarity as the switching signal, in order for pixel to maintain its current state. Upon termination or disruption of the maintenance signal the volatile state will self-switch back to its original white state (713 in FIG. 5A). It should be noted, that depending on the deposition method employed of the electrochromic polymer layer in manufacture of the polymorphic display, some cycling (“break-in”) between the reversible states of the self-switching polymer may be advantageous to achieve faster switching times and/or higher color saturation. This is in particular applicable to deposition processes not providing for intercalated electrolyte within the polymer layer.

### Example 2 (Polymorphic Pixel)

In this exemplary embodiment polymorphic functionality is achieved in a single pixel, called a polymorphic pixel. Note that multiple (two or more) polymorphic pixels with the same operable properties can also form a polymorphic display, as discussed above.

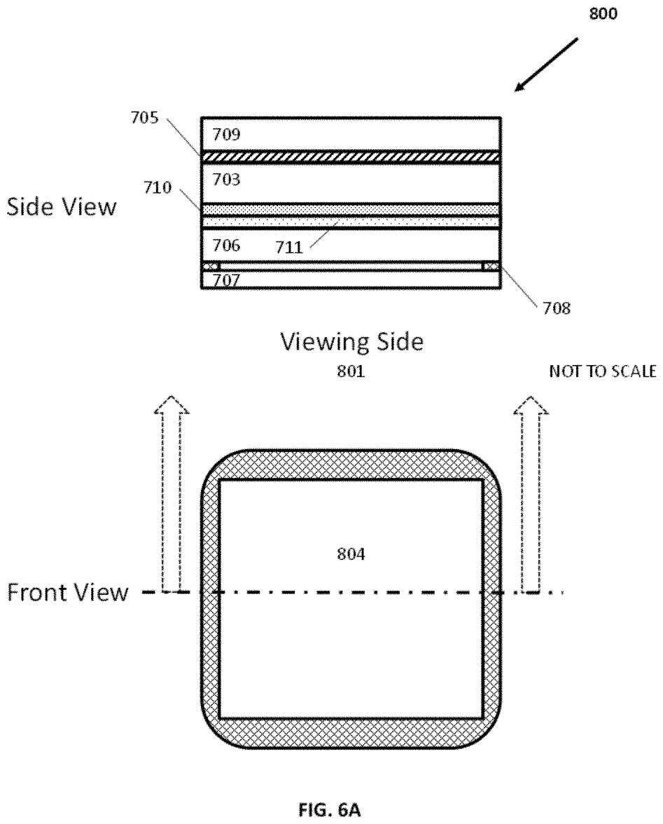

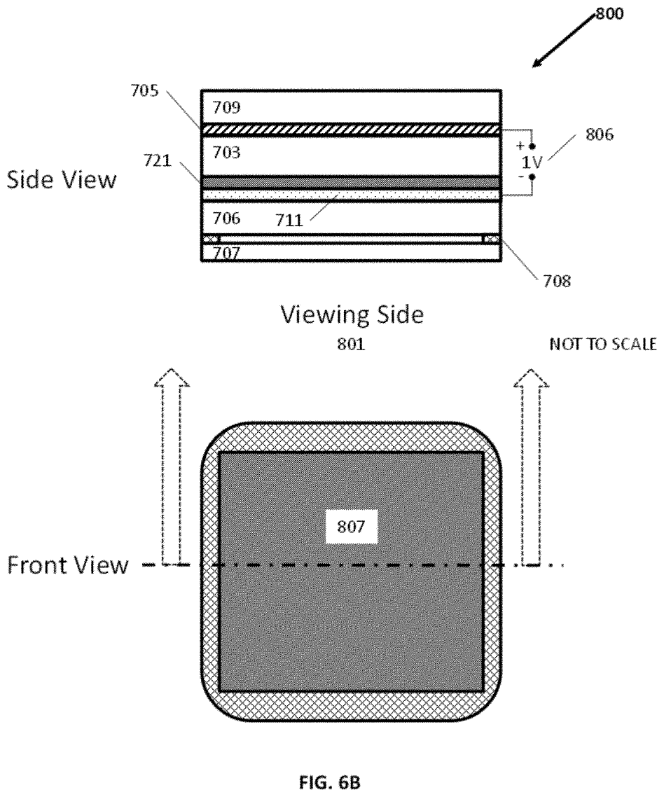

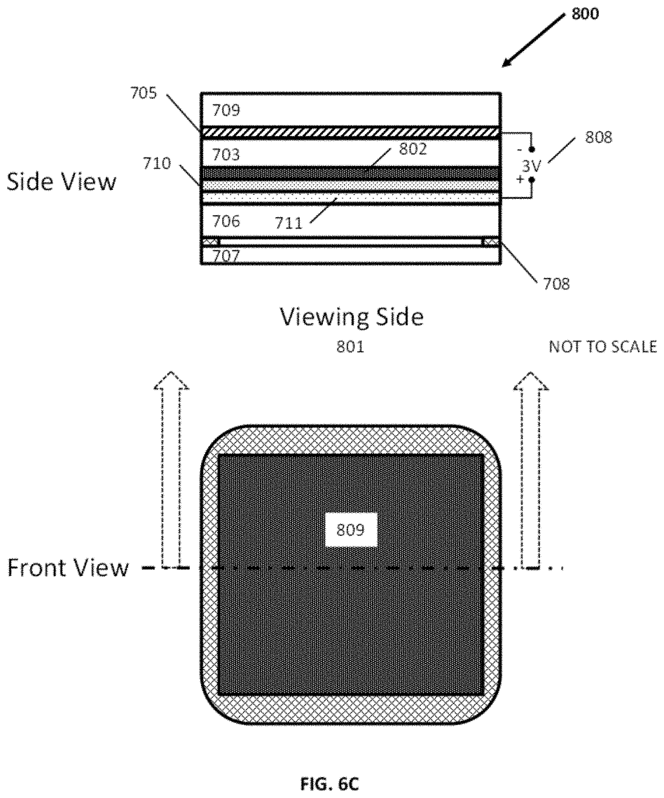

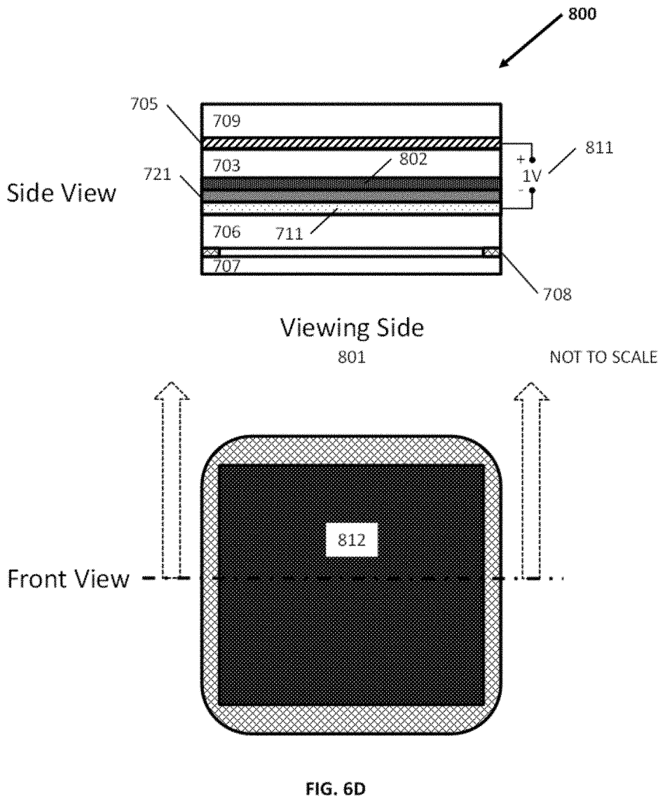

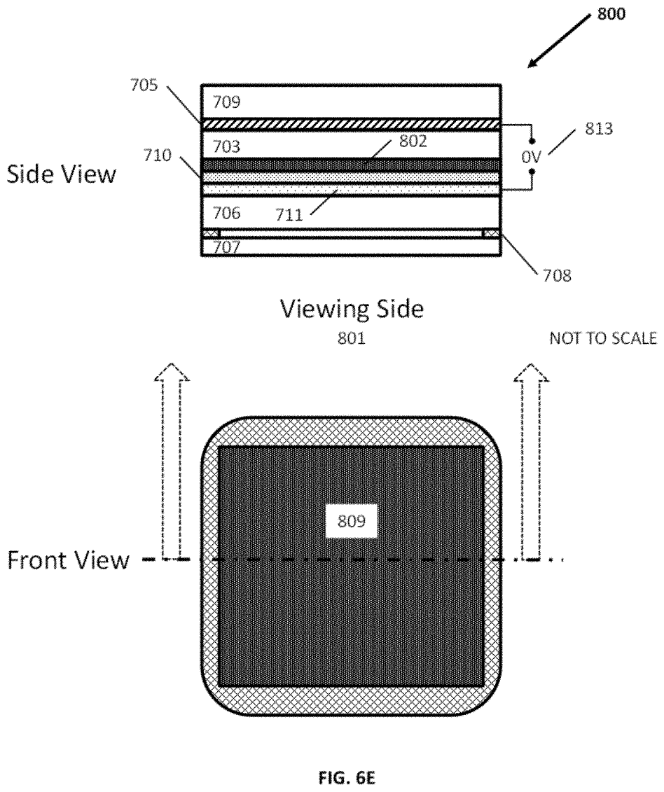

FIG. 6A illustrates an exemplary embodiment 800 of a polymorphic pixel 801, in side view and front view. The pixel 801 follows the same vertical structure configuration as that of pixel 702 shown in FIG. 5A, and will thus not be described in detail except wherein there are differences that pertain to the polymorphic functionality. To this end, and for simplicity, the (optional) complementary conducting polymer material 714 is not shown and the EC mix 703, which together with the conducting polymer layer 710 form the electro-optic layer, initially will be assumed to contain highly reflective particles (e.g. TiO₂) as an additive to the otherwise natively transmissive (clear) EC mix. Further, the polymer layer 710 is assumed be self-switchable, comprising an initial stable, clear optical state and a corresponding oxidized chemical state, switchable to a volatile red optical state with a corresponding reduced chemical state. A polymer which such characteristics includes, e.g., poly{3,4-di(2-ethylhexyloxy)thiophene-co-3,4-di(methoxy)thiophene}.

The functionality of the polymorphic pixel 801 will now be described with reference to the corresponding structure FIGS. 6A-E, and FIG. 7 illustrating the operable states 900 through its applicable switching sequences along branches 902 and 903.

Analogously to pixel 702, the initial (i.e., before any application of an electrical signal to its front 711 and back 705 electrodes) operable state 905 of pixel 801 is stable with a corresponding white optical state 804 (FIG. 6A), as determined by reflected light from the TiO₂ particles of the EC mix 703 transmitted through the clear polymer layer 710. After providing a switching signal (along branch 902) as indicated by 806 in FIG. 6B, the operable state of the pixel switches to a volatile state 906 with a corresponding red optical state 807. As previously discussed, this optical state will remain for the duration of the maintenance signal, after which it will self-switch back to its operable state 905.

The pixel 801 will remain in a self-switchable state along branch 902 as long as the switching signal level does not exceed the threshold (e.g. 3V) for electrochemical polymerization of the monomer in the EC mix 703. If, however, the applied voltage reaches the threshold voltage, with the front electrode 711 being the anode, the monomer polymerizes 802 (FIG. 6C) onto (or near) the self-switchable polymer layer 710. Note that during the switching the polymer layer 710 is in an oxidized chemical state, clear optical state, and electrically conductive state, which facilitates the polymerization process. After applying a switching signal (along branch 903) as indicated by 808, the operable state of the pixel switches irreversibly to a stable state 908 with a corresponding, e.g., dark blue optical state 809. This optical state is determined by the color of the polymerized layer 802. Note that after the switching is complete, the self-switchable polymer layer will remain in a clear state.

It is important to further note that even though operable state 908 sequenced irreversibly from state 905, the pixel is now in a mono-stable and self-switchable operable state, as further applying a switching signal 811 (FIG. 6D) with a continued maintenance signal results in a volatile state 910 with red color of the self-switchable polymer layer 721. Accordingly, the resulting optical state 812 will generally be a combination of 721 (here, red) and 802 (here, dark blue). For instance, and in this particular case, if layer 721 is relatively thick, the optical state will be a predominantly red color; if layer 721 is relatively thin (i.e. largely transmissive), the optical state will closely match the dark blue color of layer 802; or, if 721 has a thickness somewhere in the middle, the color may be a compound purple. Again, after removal of the maintenance signal, indicated by 813 in FIG. 6E the pixel will self-switch back to operable state 908 (and corresponding optical state 809).

In an alternative embodiment of pixel 800, the reflective TiO₂ particles are not included in the EC mix 703 resulting in a transmissive (clear) optical property. This alters the optical state of the initial operable state 904, depending on the reflective properties of the back electrode 705. In this alternative embodiment the back electrode 705 is presumed light absorbing (e.g. carbon black) resulting in an initial optical state of black as illustrated by 1001 of the operable states of this embodiment 1000 in FIG. 8. However, the operable and optical states of the other states along branches 1002 and 1003 are the same as those illustrated and discussed in FIGS. 7, 902 and 903, respectively (here assuming, for simplicity, that layers 721 and 802 are largely reflective, and the yellow tint of the EC mix 703 does not contribute).

However, this particular embodiment enables additional operable states by analogously polymerizing the monomer of the EC mix onto (or near) the back electrode by applying an opposite polarity of the switching signal onto the pair of electrodes. These additional operable states are shown along an extended branch indicated by 1005, as well as, an additional third branch 1004, with operable states as indicated. Note that the volatile optical states 1006 and 1008 are the same as 906, and that the stable optical states of 1010 and 1011 are virtually the same as 908 (ignoring any effect of viewing through the transmissive EC mix).

In a further alternative embodiment of pixel 800, the reflective TiO₂ particles are again not included in the EC mix 703, but an inert dye (here assumed yellow) is added resulting in a corresponding yellow tint of the EC mix. In this further alternative embodiment the back electrode 705 is presumed light reflective. Advantageously, the concentration of the dye is such that light will be reflected through a double pass of the pixel stack yielding, in this case, an initial yellow optical state 1001. Note that for this embodiment all other optical states remain the same as above except for states 1010 and 1011, which will have a new optical state of green, resulting from the dark blue polymerized layer on the back electrode viewed through the yellow tinted EC mix. Thus this configuration can exhibit five different optical states, three stable states and two volatile states, with a variety of operable properties including irreversible and mono-stable states.

### Example 3 (Polymorphic Pixel with Non-Switchable Operable State)

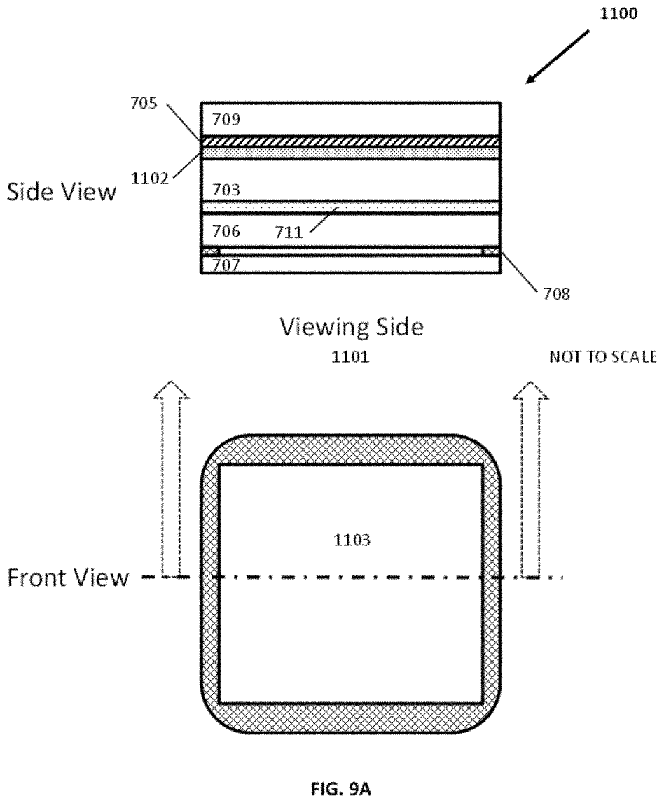

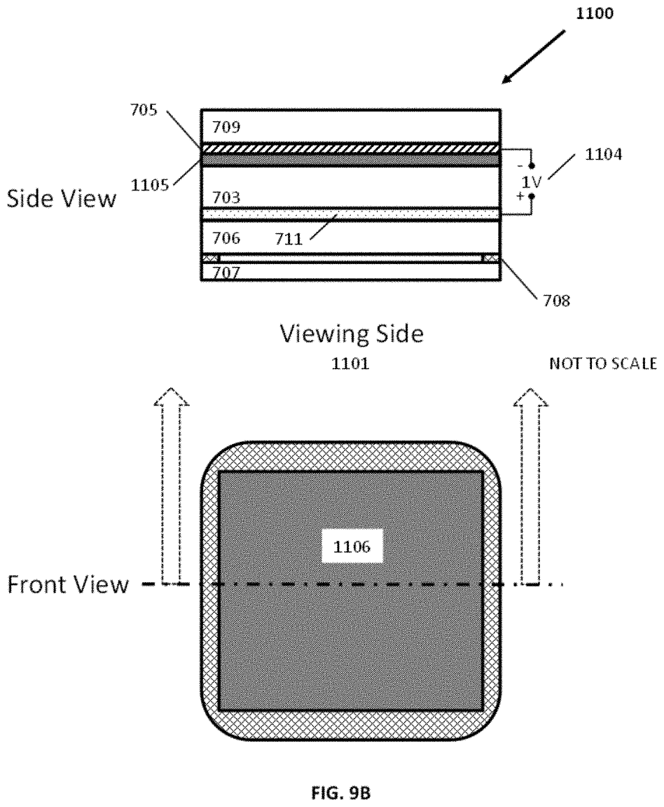

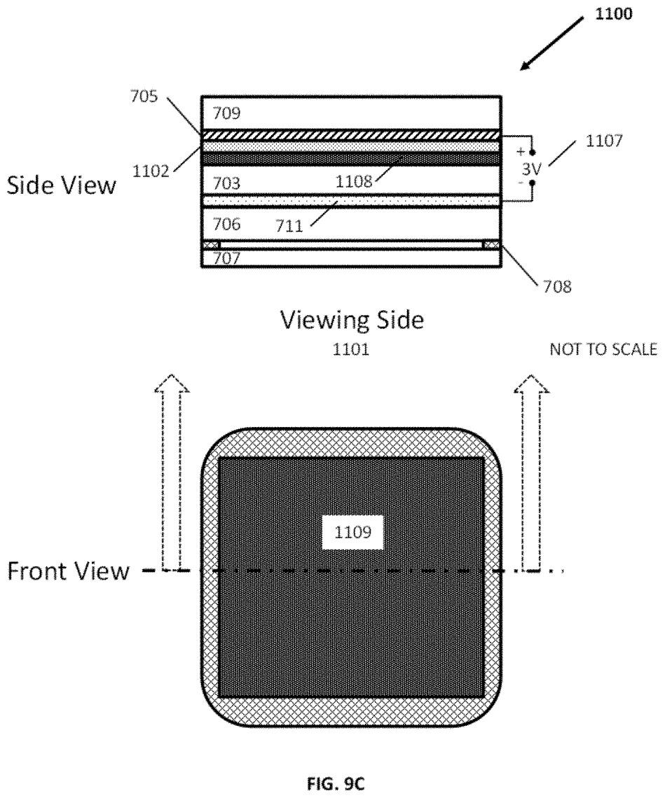

FIG. 9A illustrates another exemplary embodiment 1100 of a polymorphic pixel 1101 with a non-switchable operating state, in side view and front view. The pixel 1101 follows the same vertical structure configuration as that of pixel 801 shown in FIG. 6A, and will thus not be described in detail except wherein there are differences that pertain to the polymorphic functionality. To this end, the reflective TiO₂ particles are not included in the EC mix 703 resulting in a transmissive (clear) optical property. Further, the polymer layer 1102 is again assumed be self-switchable, comprising an initial stable, clear optical state and a corresponding oxidized chemical state, switchable to a volatile red optical state with a corresponding reduced chemical state. However, the self-switching polymer layer 1102 is present on the back electrode 705 (as opposed to the front electrode 711 as in FIG. 6A). Additionally, the back electrode 705 is reflective or transparent with an additional diffuse reflective layer behind it (not shown in FIG. 9A).

The functionality of the polymorphic pixel 1101 will now be described with reference to the corresponding structure FIGS. 9A-C, and FIG. 4 illustrating the operable states 600 through its applicable switching sequences along branches 601 and 602.

Analogously to pixel 801, the initial (i.e., before any application of an electrical signal to its front 711 and back 705 electrodes) operable state 610 of pixel 1101 is stable with a corresponding white optical state 1103, as determined by reflected light from back electrode 705. After providing a switching signal (along branch 601) as indicated by 1104 in FIG. 9B, the operable state of the pixel switches to a volatile state 620 with a corresponding red optical state 1106. As previously discussed, this optical state will remain for the duration of the maintenance signal, after which it will self-switch back to its initial operable state 610.

The pixel 1101 will remain in a self-switchable state along branch 601 as long as the switching signal level does not exceed the threshold (e.g. 3V) for electrochemical polymerization of the monomer in the EC mix 703. If, however, the applied voltage reaches the threshold voltage, with the back electrode 705 being the anode, the monomer polymerizes 1108 (FIG. 9C) onto (or near) the self-switchable polymer layer 1102. Note, again, that during the switching the polymer layer 1102 is in an oxidized chemical state, clear optical state, and electrically conductive state, which facilitates the polymerization process. After applying a switching signal (along branch 602) as indicated by 1107, the operable state of the pixel switches irreversibly to a stable state 630 with a corresponding, e.g., dark blue optical state 1109. This optical state 630 is determined by the color of the polymerized layer 1102 as the EC mix 703 is transmissive. Note, again, that after the switching is complete, the self-switchable polymer layer will remain in a clear state. However, in contrast to Example 1 above, this operable state does not allow for any further switching affecting the corresponding optical state 1109, thus it is in an operable state which is non-switchable.

### Example 4 (Interdigitated Electrode Structure)

In the exemplary embodiments discussed above, the electrode layers for switching the electro-optic layers have been focused on non-patterned configurations with either transparent or opaque optical properties. However, in some cases it may be advantageous to use an interdigitated pair of electrodes. Such configurations enable a single patterned electrode layer instead of two separate non-patterned electrode layers simplifying the manufacturing process of polymorphic pixels and displays. Furthermore, this allows for two activation surfaces per interdigitated electrode pair in a single layer with a multitude of operable states. Note that such an interdigitated transparent electrode structure (e.g. ITO) can also be employed on both sides of the electro-optic layer, e.g., for a two-sided display.

FIG. 10A shows (in a back side view) a conceptual electrode layout 1200 consisting of four pairs of interdigitated electrodes (corresponding to four pixels of the completed polymorphic display). In this configuration one digitated electrode of each of the four pairs is (optionally) connected to a common electrode connection 1220. Thus any particular pair of electrodes can be addressed using the common electrode 1220 and a pixel specific digitated electrode (e.g. 1210).

Typically the interdigitated electrode layer is deposited (e.g. directly printed or by patterning of a uniform film using, e.g. photolithography or laser ablation) onto a substrate 1230 (outlined). This process is further followed by deposition (e.g. printing) of one or more self-switching polymers (all in the same layer), such as shown in 1300 by a first self-switching polymer 1310 and a second self-switching polymer 1320. Note that the deposition can continuously span of more than one electrode pair (such as in the case of 1310).

Advantageously, the widths and separation of the electrode digits are optimized with respect to the particular properties of the self-switching polymer (e.g. thickness) and switching protocol. However, also depending on these properties, it may be preferable (e.g. for better color contrast) to only deposit (e.g. print) the self-switchable polymer along the electrode digits (i.e. with gaps), and further only on one side of the interdigitated pair (a complementary polymer layer may optionally be deposited on the other side of the interdigitated pair).

After completion of the self-switching polymer layer, the EC mix layer can be deposited (e.g. by a further printing process), as shown by layer 1410 in FIG. 10B. In this particular case, the EC mix is opaque (white, containing TiO₂ particles), however, it may also be transparent (without TiO₂ particles) as shown in 1500 by layer 1510. Note that the EC mix can also be deposited onto select pixels using different EC mix compositions (e.g. a different monomer polymerizing to a unique color). Furthermore, depending on the operable states desired for the polymorphic display, some pixels may only have an electrolyte printed on top (i.e. no EC mix).

The above examples disclose embodiments of polymorphic displays and pixels with various operable states corresponding to optical states determined by reflective properties of the pixels. However, the method and means can advantageously be extended to transmissive and/or polarization properties. For example, the self-switching polymer or polymerized monomer layers can be designed (with appropriate activation protocols) such that the transmitted light through (the colored layers in) the pixels determine the optical state. In this case, both the back electrode and substrate are at least partially transmissive as well. Advantageously, electrochromic materials could be combined with a liquid crystal material to from an electro-optic layer capable of generating both polarization and color changes to transmitted light through the layer (with corresponding operable states). Optionally, polarizers in front and behind the electro-optic layer (e.g. on the outer surface of front (and back, if transmissive) substrate or cover layer, could, e.g., convert the polarization changes to light intensity changes.

Additionally, the above exemplary embodiments primarily working in the visible wavelength range. However, as discussed above, the embodiments of the current invention also include wavelength outside of the human visible range (e.g. machine reading). Advantageously, as electrochromic polymers typically exhibit significant reflectivity changes in the IR wavelengths between the oxidized (conductive) and reduced (non-conductive) states, these materials can thus also be utilized for generating operable state changes outside of the visible range for polymorphic pixels and displays.

### Example 5 (Polymorphic Display Fixed-Image Shutter Mode)

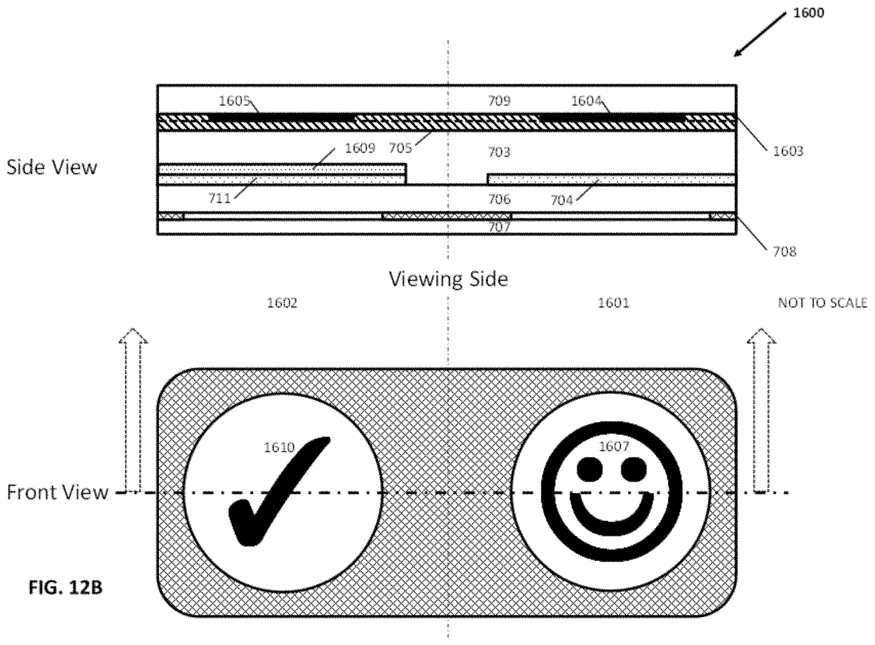

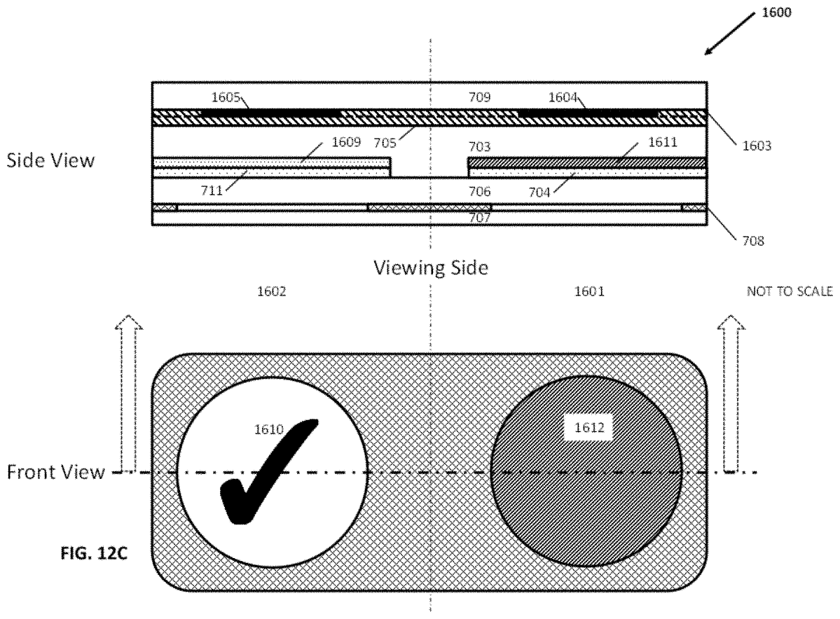

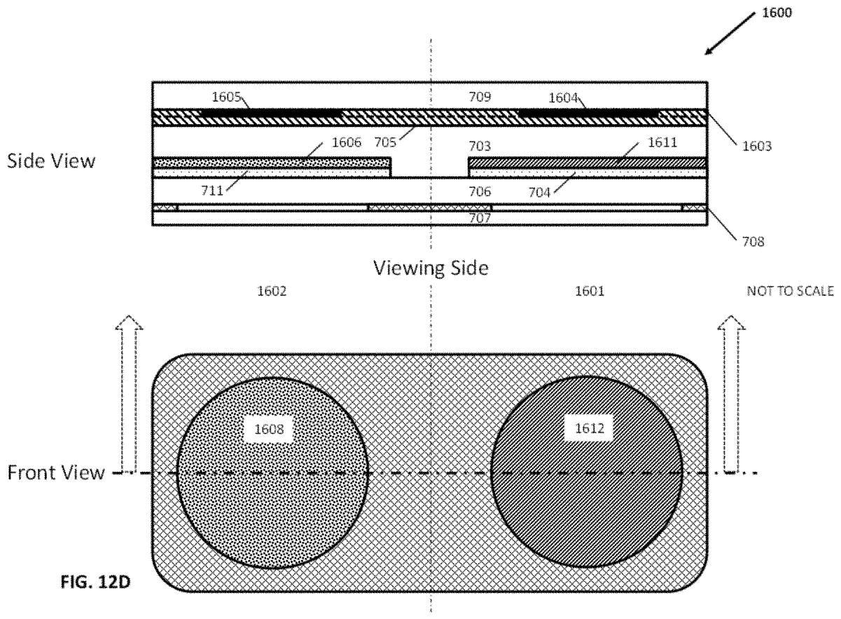

FIG. 12A-D illustrates another embodiment of the current invention in side view and front view, in which the pixels of a polymorphic display 1600 operates in a shutter mode (i.e., a means for either transmitting or reflecting/absorbing light). This embodiment is similar to that illustrated in FIG. 5A, thus only differences will be highlighted. The EC Mix 703 spanning both the right pixel 1601, with a bi-stable, permanent and irreversible second operating state, and the left pixel 1602, which is monostable and self-switchable, is predominantly transparent (i.e., without any TiO2 in the EC Mix). Although the (optional) complementary conducting polymer material 714 of FIG. 5A is not shown, it should be noted that the complementary conducting polymer material 714 can be patterned appropriately to all or a set of pixels of the polymorphic display. Additionally, the material may be pixel specific according to the intended properties of the corresponding pixel. As presented in FIG. 5A, embodiment 1600 additionally comprises a fixed-image layer 1603 containing fixed-images 1604 (here a “smiley face”) and 1605 (here a “check mark”), which both can be revealed or obscured to the viewing side depending on the transmissive properties of the respective pixels 1601 and 1602. Note that here the polymorphic display is illustrated functionally as an indicator with two pixels large enough to each contain a legible image. It should be understood that the image layer may contain one or more images (also referred to herein as messages) and a polymorphic display may comprise multiple fixed-image layers. Further note that fixed-image layer 1603 may include only discrete images (such as 1604 and 1605) with no (printing) layer material in-between, as shown in FIGS. 12A-D.

The fixed-images, 1604 and 1605, may e.g. be printed or otherwise constructed or placed directly onto substrate 709 or onto a separate thin substrate or film (not shown) which subsequently is adhered to substrate 709. The back electrode 705 of this embodiment shown in FIG. 12A is transparent such that a fixed-image located on the back-side of the back electrode may be seen from the viewing side. However, it will be appreciated that the fixed-image may also be printed or placed directly onto the front side (not shown) of an optionally opaque back electrode 705, for instance, with the fixed-images printed using conductive ink of a favorably different color than the opaque electrode to provide image contrast. In either case the fixed-images may also be printed in full color. Additionally, the fixed image may also be printed or placed directly on the front side of the optional complementary conductive polymer material 714 shown in FIG. 5A), advantageously with an image construction and material which provide for sufficient image contrast and ion conductivity (e.g., porous, containing small holes). Note that “fixed images”, as the term as used herein, may also include “dynamic” images that are generated after manufacture of the polymorphic display (at a preferable point during the switching cycle). For instance, with a patterned back electrode 705 (e.g., interdigitated pair per Example 4 or segmented) a desired image could be generated by polymerization of EC mix 703 onto the corresponding electrode pattern (by respective application of an activation signal across the interdigitated pair of electrodes or back segmented and front electrodes).

In the particular embodiment 1600 illustrated in FIG. 12A-D, the self-switching polymer 1606 is different than those previously discussed in Example 1, in that its stable (non-powered) state is colored (e.g. black or blue), whereas its volatile state is transparent or clear (here, for example, in the human visible wavelength range). Exemplary polymers with such characteristic include anodically coloring conductive polymers with low oxidation potentials, such as, PBEDOT-NMeCbz and PProDOP-NPrS.

FIG. 12A illustrates the initial state of the polymorphic display 1600 prior to any application of switching signals across electrodes 704 and 705 of pixel 1601 and 711 and 705 of pixel 1602. In this stable pre-switched state, the vertical structure of pixel 1601 is transparent allowing fixed-image 1604 (“smiley face”) to be seen 1607 from the viewing side (indicated by 1607 in the front view of FIG. 5A). The self-switchable polymer of pixel 1602 however is colored (and favorably also opaque) in its unpowered stable state, thus the fixed-image 1605 of pixel 1602 is obscured or hidden from the viewing side (indicated by 1608 in the front view of FIG. 5A). After subsequent application of a switching signal to pixel 1602 (e.g. −1V onto front electrode 711 relative to common electrode 705) a resulting transparent state of the self-switching polymer layer 1607 reveals fixed-image 1605 (“check mark”), as shown by 1610 in FIG. 12B. The fixed-mage 1605 will remain visible for the duration of the maintenance signal (e.g. indicating that device is operating). Analogous to pixel 701 in Example 1 and as illustrated in FIG. 12C, pixel 1601 is switched by applying a voltage above a certain threshold (e.g. +3V), such that the polymerized monomer layer 1611 is formed at the front electrode 704 of pixel 1601. This switching signal can for instance be in response to an event, e.g., the temperature of the display itself or the good the polymorphic display is attached to, exceeded a set threshold. As the polymerized monomer layer 1611 is colored (e.g. dark blue), and advantageously opaque, fixed-image 1604 is now hidden in a permanently and irreversibly hidden or obscured, as indicated by 1612 in FIG. 12C. Subsequently, and as illustrated in FIG. 12D, upon termination of the applied maintenance signal to the electrodes of pixel 1602 (e.g., in this case indicating a power failure), the self-switchable polymer reverts back to its stable colored state 1606, resulting in both fixed-images being hidden, as indicated by 1608 and 1612 in FIG. 12D.

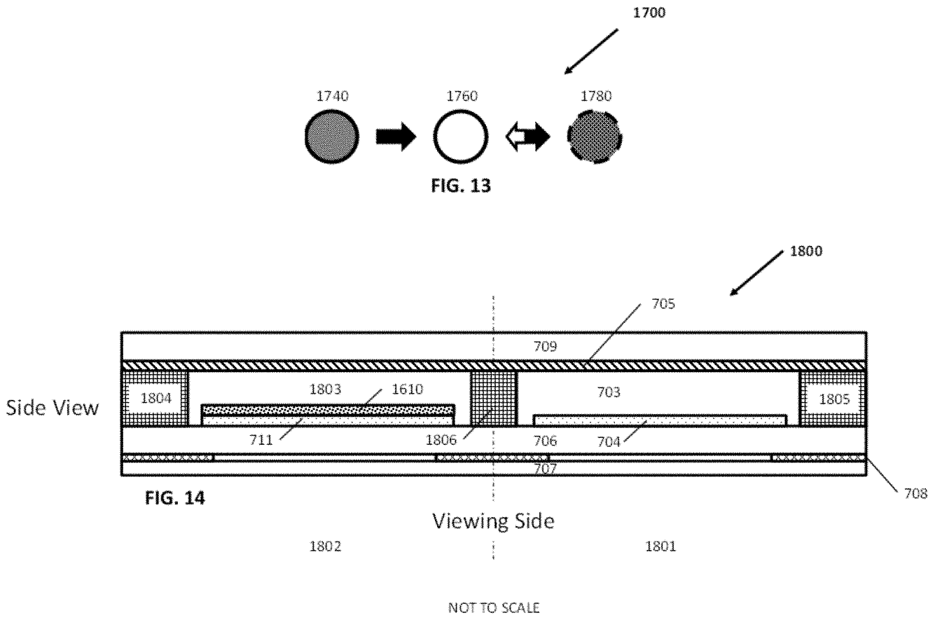

As discussed above, there are many electrochromic conductive polymers which are mono-stable and self-switchable and could be used as layer with either a transparent (clear) state in the stable state (e.g., 710 in FIG. 5A) or self-erasing state (as indicated by 1609 in FIG. 12B). However, there are also some that are bi-stable with both self-switchable and irreversibly switchable operable properties. Such polymers provide for expanded shutter mode functionality. Specifically, the operable states of such a pixel 1700 as shown in FIG. 13, exhibit a first colored stable state 1740 as deposited (e.g. spray casted), and are irreversibly switchable to a second colored or transmissive stable state 1760 after applying a first switching signal, and further switchable to a third colored volatile state 1780 after applying a second switching signal. Analogous to above, it will remain in the volatile third state 1780 for the duration of the maintenance signal. When the maintenance signal is terminated (or disrupted for any reason) it self-switches (transitions back) to the stable, second state 1760.

For example, the first stable state for a spray cast film of a disubstituted poly(propylenedioxythiophene) PProDOT(CH₂OEtHx)₂ [Macromolecules, 2004, 37 (20), pp 7559-7569] (prior to power being applied for the first time) is red 1740, the second stable state corresponding to an oxidized chemical state (after a first switching signal is applied) is transparent (or clear) 1760, and the third volatile state corresponding to a neutral (reduced) chemical state (after a second switching signal followed by a maintenance signal is applied) is blue 1780. The third state is achievable through a phenomenon called “doping induced order” where the expulsion of the electrolyte allows a reorganization of the polymer backbone to a lower energy state. Such an exemplary three-state polymer could advantageously be applied as layer 1606 of pixel 1602 of the polymorphic display shutter structure 1600 in FIG. 12A. For example, with such a three-state polymer, pixel 1602 could provide augmented indication (or message), that the display (and associated good) has never been powered up or activated by indication of a stable red state, which is irreversibly switchable to a second clear and stable state (revealing image 1605), followed immediately by a second switching signal transitioning to the third volatile blue state (indicating the power is on). If the maintenance signal in this state is subsequently terminated (for instance, when power is no longer available), it self-switches back to the second clear state revealing image 1605 (which, in this case, may indicate a “no power” symbol).

Note that polymers with such characteristics can, for example, also be utilized as material layer 710 of pixel 702 in FIG. 5A or of pixel 801 in FIG. 6A, to provide for bistable, irreversibly switchable, and self-switchable operable properties in conjunction with appropriately selected switching signals and signal protocol.

### Example 6 (Compartmentalized Structure)

In some polymorphic display configurations it may be desirable to contain the EC mix or electrolyte material by means of compartments within a common structure as illustrated by polymorphic display embodiment 1800 in FIG. 14. This is, in particular, applicable for cases in which the EC mix or electrolyte is characterized by a relatively high viscosity (e.g., after deposition or printing). However, it is also advantageously utilized for polymorphic displays for which individual pixels require different types of electrolytes (for optimized electrochromic functionality) or comprise distinct electro-optic materials. Such electro-optic materials may comprise any material that can affect reflected, transmitted, or emitted electro-magnetic radiation (e.g., amplitude, intensity, polarization, and/or wavelength) based on an electric input (e.g. switching) signal. Examples of such electro-optic materials include liquid crystals (e.g., cholesteric and ferroelectric), electrophoretic (particle systems), electrochromic materials, electrowetting fluids, electro-liquid powder materials, plasmonic nanostructures, optical interference stacks (including those switched by microelectromechanical systems), photonic crystals, and phosphorescent materials, as well as, emissive materials such as LED materials, OLED (and other electroluminescent) materials, quantum dot materials (photo-emissive or electro-emissive), or any combination thereof. Note that such compartmentalized structures may also be utilized for hybrid displays for which the achievable operable states of each pixel are the same but, for instance, the achievable optical states are different.

Embodiment 1800 is similar to embodiment 1600 in FIG. 12A without the fixed-image layer 1603, and will not be explained in detail expect where there are differences. The key difference of embodiment 1800 as compared to embodiment 1600 is the integration of a compartmentalized structure (vertically) spanning the front transparent substrate 706 and the back (here common) electrode 705, thus providing containment of the EC mix 703 of pixel 1801 and electrolyte 1803 (e.g. ionic liquid) of pixel 1802. The thickness of the containment wall 1806 in-between pixels (here 1801 and 1802) may be different (e.g. thinner as shown) as compared to those containing edge pixels of the polymorphic display (here 1804 and 1805). The thicknesses and aspect ratios of the walls are favorably optimized taking into account the compartmentalized structure material (e.g., flexible polymer), rigidity (or viscosity) of the EC mic 703 and electrolyte 1803, flexibility of the display, as well as, functionality and lateral fill factor of the pixels. For high resolution displays, it may further be preferable that the compartmentalized structure material be made opaque (e.g. by adding a light absorbing dye or ink particles) to enhance the image quality of the completed polymorphic display.

The compartmentalized structure may, for instance, be fabricated from a solid uniform film by accordingly removing material (e.g. by laser ablation), before it is applied (with e.g. an adhesive) to the front substrate 706 or back substrate 709 (with transparent of opaque conductive layer 705), or generated in place by a photolithographic process.

In an alternative variation of embodiment 1800 (commonly used for pixelated electrophoretic displays), the compartmentalized structure may be generated through an embossing process, e.g., by embossing a thermoplastic or photopolymer layer onto conductor layer 705 supported by back substrate 709, with subsequent filling/sealing of the electro-optic material, and attachment to the front substrate 706 (with pixelated transparent conductors). Such a structure would enable switching of polymorphic display pixels based on, for example, electro-optic materials that respond to an electric field including, e.g., electrophoretic and liquid crystal materials. However, in this alternate embodiment without direct exposure to back electrode 705 (e.g. through removal of any residual embossing material), electro-optic materials requiring low resistive interface to its corresponding electrodes (such as electrochromics) would not switch. Advantageously, however, such electrochromic functionality can be achieved by substituting the front pixel electrode (e.g. 704 or 711) with a pair of interdigitated electrodes (as illustrated in Example 4).

### Example 7 (Alternate Compartmentalized Structure)

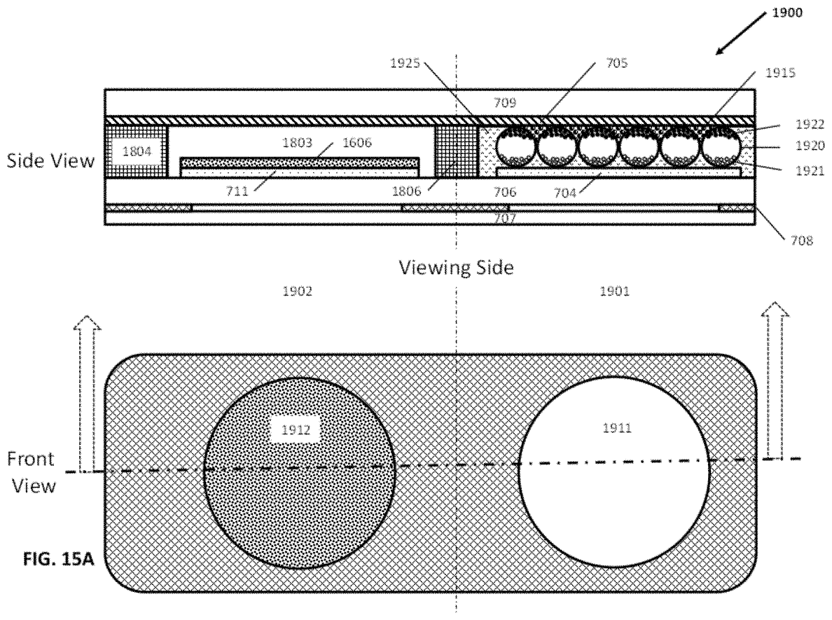

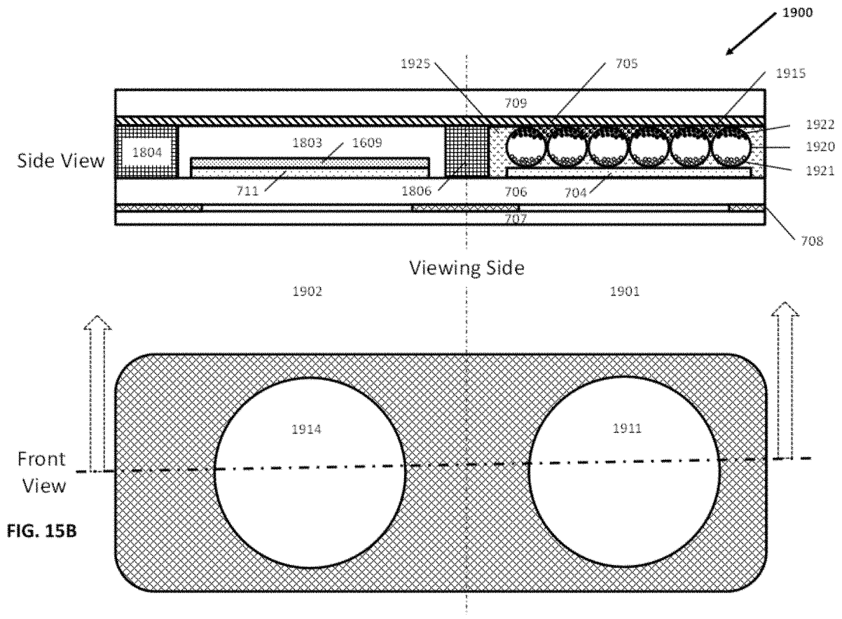

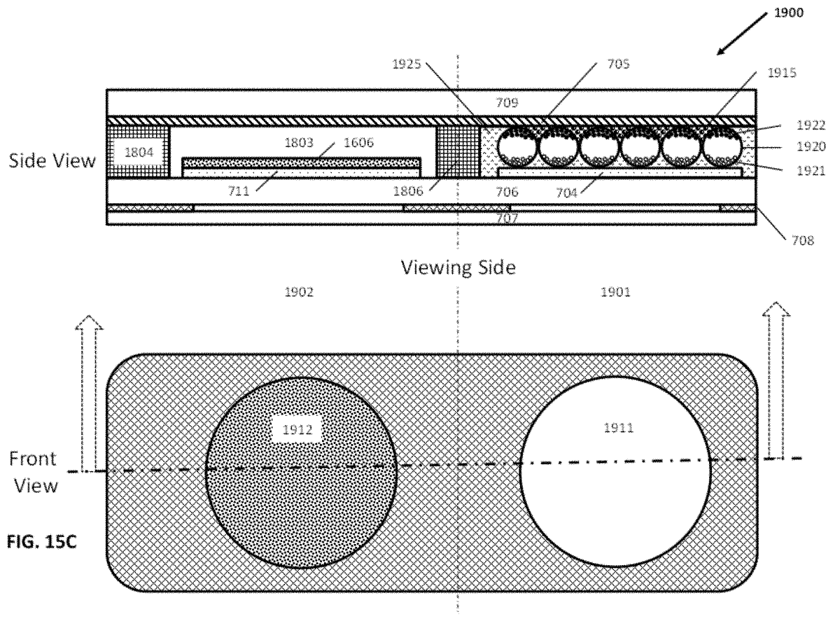

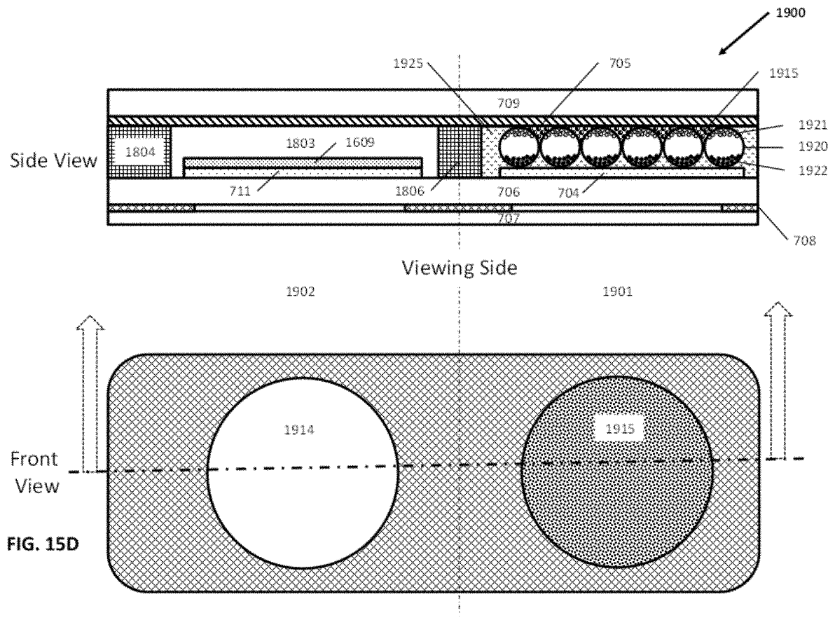

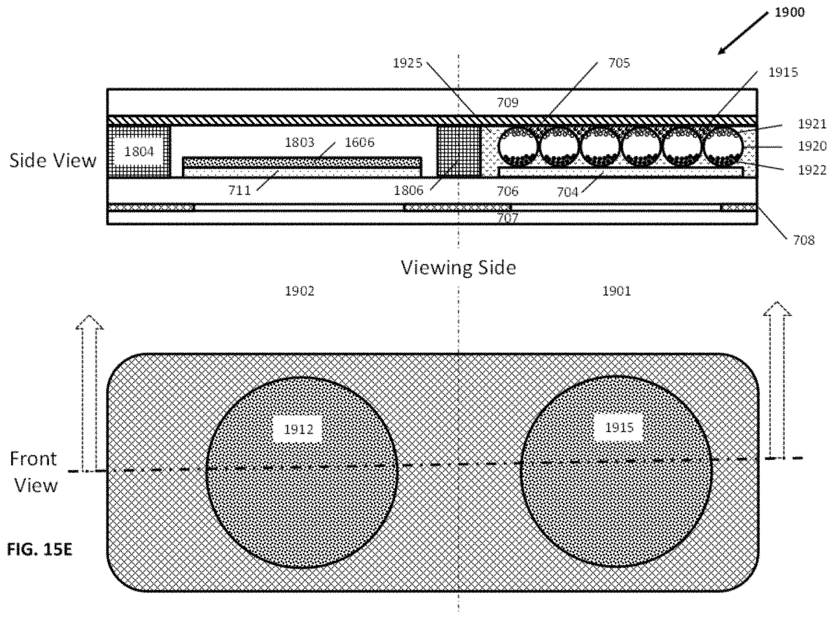

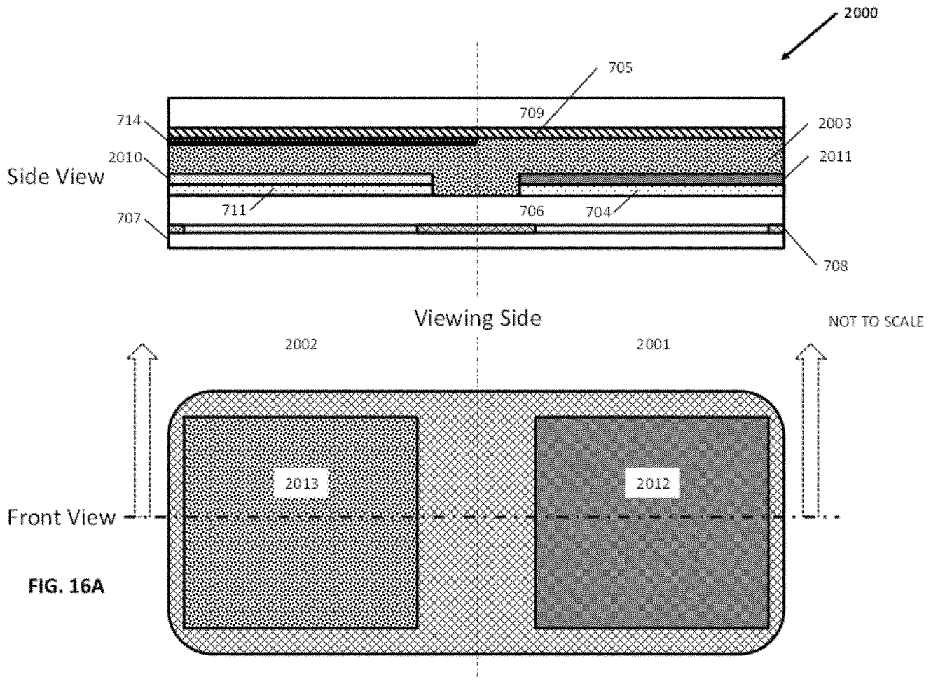

In some polymorphic and hybrid displays it may advantageous to provide a common compartmentalized structure for only some of the pixels in the display. For instance, electro-optical material compositions that are relatively solid or semi-solid after deposition (and potentially curing or solidifying) may not require a permanent support structure. Such electro-optic materials include those favorably formed into films, with or without a permanent (or temporary) supporting substrate, in separate processes for subsequent integration into the polymorphic or hybrid display. FIG. 15A illustrates an embodiment 1900 of such a polymorphic display in its pre-powered state, in side and front views, with two (indicator) pixels comprising a bi-stable electrophoretic right pixel 1901 and a monostable and self-switchable left pixel 1902.

The left pixel is functionally similar to pixel 702 illustrated in FIG. 5A, thus only differences will be highlighted. For simplicity, the optional complementary conductive polymer material 714 is not shown. The electrolyte 1803 (e.g., ionic liquid) may be transparent or contain a coloring additive (e.g., TiO₂). Structurally, pixel 1902 is similar to that of 1802 of embodiment 1800, discussed in Example 6, with containment walls 1804 and 1806. In the stable pre-powered colored (here shown as black) state of the conductive polymer layer 1606, the indicator output 1912 of pixel 1902 is black, as shown in FIG. 15A.

The right pixel 1901 comprises an electrophoretic microencapsulated electro-optic layer of spheres 1920 filled with suspension fluid containing two types of oppositely charged ink particles, white 1921 and black 1922. These particles move in response to an applied electric field between electrodes 704 and 705, such that white ink particles 1921 remain stable at the front surface after application of a switching signal applied to the electrodes (of a specific polarity), whereas the black ink particles 1922 (of opposite charge) remain stable at the back of the electro-optic layer as shown in FIG. 15A. Thus as shown in FIG. 15A, the resulting indicator output 1911 of pixel 1901 is white.

With the pre-powered state of embodiment 1900 in FIG. 15A discussed above and referring to FIGS. 15B-E an exemplary switching sequence of embodiment 1900 is now detailed. In FIG. 15B pixel 1902 is switched (analogously to pixel 1602 in FIG. 12B) to its volatile state (e.g. indicating the display is powered up), resulting in a clear state of polymer layer 1609 and a white state of the indicator output 1914 (here assuming, for example, that electrolyte includes a TiO₂ coloring additive). The state of indicator will self-switch back to output 1912, as shown in FIG. 15C, if the corresponding maintenance signal is no longer applied to the electrodes of pixel 1902, e.g., if a loss of power occurs. If, however, the maintenance signal remains with the display (indicator) in a powered state, pixel 1901 can favorably indicate the occurrence of an event (e.g., the temperature of the display or associated good exceeds a set limit) by switching the state of the electrophoretic electro-optical layer such that the black ink particles are now instead at the viewing side, corresponding to a black stable state of the indicator output 1915 as shown in FIG. 15D. Finally, if a subsequent loss of power occurs, pixel 1902 reverts back to black indicator output state 1912 with the bi-stable indicator output remaining black, as indicated by 1915 in FIG. 15E. Note that in this particular embodiment 1900 both pixels are reversible. Thus after a reset of pixel 1901 (to a white state initial state) the entire sequence can be repeated.

Commonly, electrophoretic microencapsulated electro-optic layers are formed in roll-to-roll processes onto a non-patterned electrode layer on a support substrate. This allows for prefabrication of the electrophoretic electro-optic layer of pixel 1901 of embodiment 1900 onto back substrate 709 with the non-pattered electrode layer 705 using an adhesive 1915. The area of the prefabricated substrate 709 with exposed electrode 705, commonly used for required electrical connection (e.g. using conductive adhesive), can also be used, and extended if necessary, as a means to form the compartmentalized structure (1804 and 1806) onto. Advantageously, the compartmentalized structure may also be formed onto front substrate 706 facilitating alignment to pixelated electrodes (704 and 711). In either case the electrophoretic electro-optic layer is attached electrode 704 and substrate 706 by a transparent adhesive 1925, whereas the pre-filled electrolyte material 1803 is sealed by the adhesively attached compartmentalized structure. Note that depending on the particular configuration including the separation (“dead space”) between pixels 1901 and 1902 and substrate thicknesses of 706 and 709, the thickness of the compartmentalized structures 1806 and 1804 (defining the thickness of electrolyte material 1803) may be different than that of the electrophoretic electro-optic layer of pixel 1901, and the structure wall 1806 may be optional.

It will be appreciated that there are many variations of exemplary embodiment 1900 of FIG. 15A. For example, it may be advantageous to configure in an “inverted” structure such that the prefabricated electrophoretic electro-optic layer with non-patterned electrode layer faces the viewing side. Although this would require the non-patterned electrode layer to be transparent, it would allow the back patterned electrode layer, as well as, the (optionally conductive) adhesive 1925 to be opaque. Further, the self-switching conducting polymer layer could be either printed on the front prefabricated electrode layer or on the back patterned electrode layer. The latter case would preferably include a transparent electrode material 1803, as the polymer layer is viewed through the electrolyte.

Additionally, it should be noted that although exemplary embodiment 1900 in FIG. 15A illustrates an electrophoretic display pixel 1901 with two distinct states, electrophoretic electro-optic materials may also comprise a multitude of stable states (e.g., a number of stable distinguishable grey levels); or contain three or more types of ink particles and/or a colored suspension fluid with corresponding stable color states.

### Example 8 (Pixels Constructed with Different Redox and Electrolyte Layers)

As discussed above, there are many advantages to achieve irreversible modalities in polymorphic pixels and displays using single layers of EC mixtures (comprising monomers and electrolytes). In some cases, however, it may be desirable to achieve different operable properties by creating pixels that comprise separate redox layers (layers comprised of redox materials such as electro-polymerizable monomer(s) or conductive polymers and electrolyte layers). And further, where the redox layers (or the electrolyte layers) are advantageously solid or semi-solid, porous or a gel; flexible, semi-flexible or rigid.

As with electro-polymerizable monomers disbursed within an EC mixture, electro-polymerizable monomer layers are polymerized in-situ, i.e. within the display device. One preferred embodiment is a polymorphic display comprising different sets of pixels, each comprising different redox layers and a shared electrolytic layer that spans multiple pixels—and can provide independent pixel switching. Independent switching is achieved for example with a polymorphic display comprising a permanent and irreversible pixel (constructed with an electropolymerizable monomer layer) and a self-switchable pixel (constructed with a conductive polymer layer), where the two pixels share a common electrolytic layer, even if the respective switching voltage levels are comparable and/or their ranges are overlapping (i.e., not highly non-linear with distinct threshold voltages).

Favorable redox materials (e.g., electropolymerizable monomers and conductive polymers) for redox layers are those that are solid in the temperature range of interest of the display device (e.g. operating and storage temperature ranges), in contrast to those that form liquids (of various viscosities) suitable for single-layer EC mixtures. Further, the electro-polymerizable monomers (and subsequently polymerized monomers) are preferably insoluble in the electrolyte, which improves compatibility with a large range of electrolytes (e.g. ionic liquids). For example, hydrophobic monomers would be less likely to dissolve/disperse in polar ionic liquid.

Of particular interest are electro-polymerizable monomers (including macromonomers and oligomers) that are characterized by relatively high molecular weight, e.g. benzophenone, benzothiadiazoles, carbazoles, fused aromatic ring systems, fluorenone, and further specifically fluorinated monomers (and compounds), as they tend to aggregate together to form solid layers. Electro-polymerizable monomers that oxidize at relatively high potentials (say, for example, at +0.1V vs. Fc/Fc+ or higher) are also advantageous as these are less susceptible to oxidation and therefore more stable in (pre-switched) display devices and thus reducing or eliminating the need for high-performance device barrier layers/encapsulation.

A electro-polymerizable monomer layer may be deposited onto the electrode layer (e.g. 704 or 705 of of pixel 701 in FIG. 5A) using a variety of methods (similar to the conductive polymer layer for self-switchable pixel, see e.g. 710 of pixel 702 in FIG. 5A), including spray casting, screen or inkjet printing, gravure coating, etc. These deposition methods may further be solution based (solvent assisted) using either polar or non-polar solvent depending on the monomer's properties, and include other additives such as polystyrene (to increase viscosity) or adhesion promotors (e.g. Silquest 187-A Silane; or EDOT-acid as a separate sub-layer). Exemplary solvents include cyclopentyl methyl ether (CPME), 2-methyltetrahydrofuran, dihydrolevoglucosenone (cyrene), acetonitrile, etc. Similarly to the EC polymer layer for self-switchable pixels (e.g., 710 of pixel 702 in FIG. 5A-B), electro-polymerizable monomer layers may be patterned onto (partially or substantially conforming to) a pixelated electrode, or deposited as a continuous (shared) layer across multiple pixel electrodes (favorably with sufficient spacing between neighbor pixel electrodes). Deposited (and patterned) electro-polymerizable monomer layers may have pixel-specific monomer properties to achieve pixel particular optical states (e.g. colors) and/or pixel specific modalities for polymorphic displays. The redox layer may also contain multiple electropolymerizable monomers to achieve a broader spectrum of optical states, e.g. by blending the monomers in different ratios to form a single solid layer, forming multiple solid sub-layers each with a different polymerizable monomer, or any combination thereof. The multiple monomers may also comprise dissimilar (e.g. distinct or overlapping but shifted ranges of) polymerization activation thresholds to achieve different optical states by application of distinct switching signals/protocols (e.g. voltage levels, durations, etc.) to the addressing electrodes.

The electrolyte layer may include solid polymer electrolytes, gel polymer electrolytes, and polyelectrolytes, with green alternatives in gel polymer electrolytes based on e.g. cellulose or lignin, or ionic liquids. Advantageously, the electrolyte may also be deposited using a variety of printing techniques, as previously discussed, and may be a liquid (favorably contained) or (highly) viscous layer (with increased mechanical and interfacial stability by additives including, e.g. zeolites, Al₂O₃, MgO, or SiO₂), or advantageously made semi-solid or solid with appropriate additives (e.g. thermally or UV curable monomers, microbeads, etc.) to form fully solid device stacks (including the electrode materials). The electrolyte layer may additionally include colorants (e.g., pigments, dyes, or TiO₂).

Solid electro-polymerizable monomer layers can provide for a multitude of operable properties for polymorphic display pixels and polymorphic pixels. In the case of a single substantially uniform electro-polymerizable monomer layer, the polymodal properties and modalities include a first stable state, corresponding to a first optical state (e.g. a first color) as deposited. The first state is irreversibly switchable to a second state (by oxidatively electropolymerizing the solid monomer layer), corresponding to a second optical state (e.g. a second color), which may be either stable or volatile depending on the properties of the monomer. In case of a stable second state, the polymerized (oxidized) monomer may further be switchable to a volatile third state (i.e., analogous to the operable states 1700 shown in FIG. 13), corresponding to a third optical state (e.g. a third color), and remain in this (reduced polymerized) state for the duration of the maintenance signal (as discussed above). When the maintenance signal is terminated (or disrupted for any reason) it self-switches (transitions back) to the stable, second state. Whereas in the case of a volatile second state, the electropolymerized monomer remains in this state for the duration of the maintenance signal after which it self-switches to a third stable state, corresponding to a third optical state (e.g. a third color). Note that the respective optical states, i.e. first, second, and third colors of the solid EC layer (either the monomer or the electropolymerized monomer) may correspond to a transparent, lightly colored semi-transparent, or colored opaque state, which may be non-reflective (absorptive), semi-reflective, or reflective. In the case of transparent or semi-transparent properties, or relatively thin layers, the pixel color may be different than the monomer layer depending on properties of the layer(s) viewable behind the redox layer (e.g. through intentional color blending by means of a colored electrolyte and/or back electrode/substrate or reflective interference stack effects). The third optical state may also be indistinguishable from that of the second state (e.g. for a wavelength or within a wavelength range).

A single electro-polymerizable monomer layer (including sub-layers of electro-polymerizable monomers) may also be deposited on the back (counter) electrode of a pixel (e.g., instead of the self-switching polymer layer 1102 of polymorphic pixel 1101 in FIG. 9A), or layers of the same or different monomer properties on each electrode (with the completed display device viewable from one or both sides), to achieve different polymorphic modalities. Although an irreversible switching modality can be achieved with a separate electro-polymerizable monomer layer in conjunction with an adjacent electrolyte layer, an EC mix layer (e.g., 703 of embodiment 1100 in FIG. 5A), which includes polymerizable monomers, could also be used as the electrolyte layer to achieve additional irreversible transitions, e.g. with the electro-polymerizable monomer layer and the in-mix monomer layer activated at different polymerization thresholds.

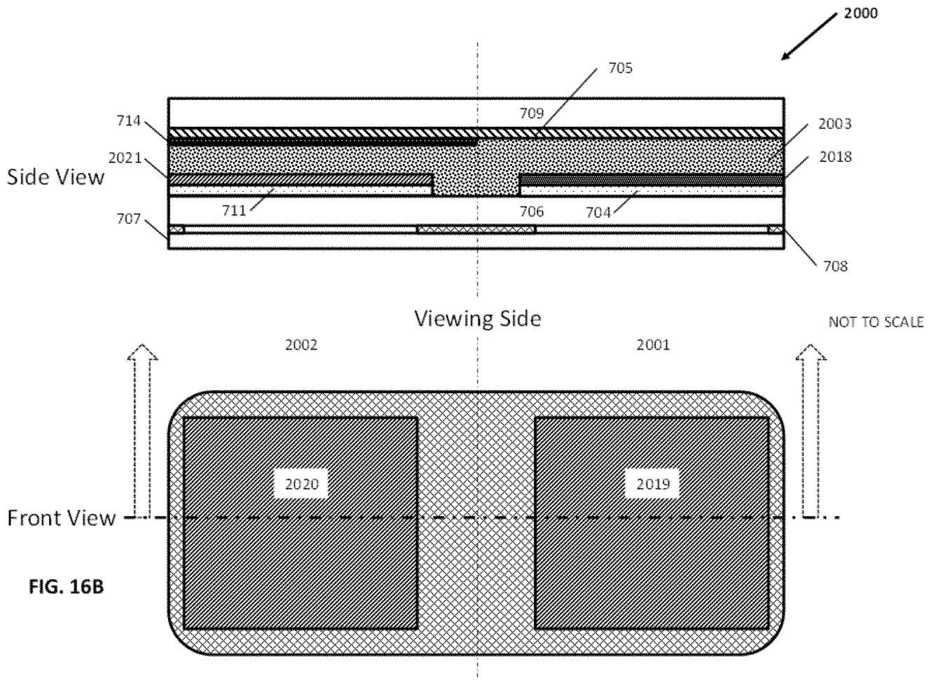

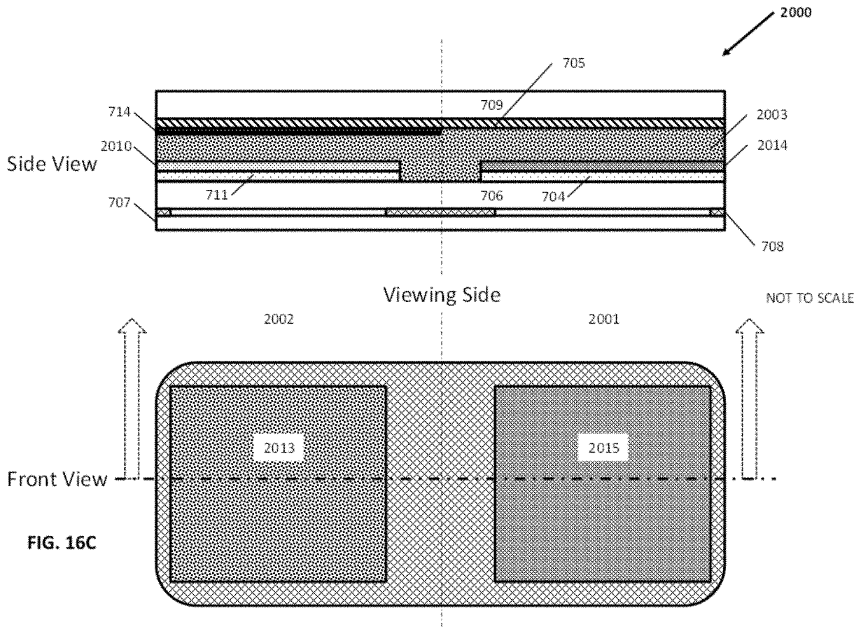

FIG. 16A shows an exemplary configuration of a polymorphic display 2000 comprising two pixels, each having different operable properties, in side view and front view. For illustration purposes, only two pixels are shown although it is to be understood that a polymorphic display may comprise many such pixels (and sets of pixels). The right pixel 2001, comprising a solid monomer (redox) layer 2011, is bi-stable with both self-switchable and irreversibly switchable operable properties (such as 1700 in FIG. 13), whereas the left pixel 2002 is mono-stable and self-switchable (such as 100 in FIG. 1).

The left pixel 2002 of FIG. 16A is similar to pixel 702 in FIG. 5A, thus only differences will be discussed. Specifically, instead of having an EC mix 703 functioning as an electrolyte, pixel 2002 (and pixel 2001) comprises a shared electrolyte (without a monomer) which is colored yellow (e.g. ionic liquid with an appropriate pigment or dye). The self-switchable redox layer comprising a conductive polymer 2010 is green in its volatile state and substantially transparent in its stable state [e.g. a spray cast film of ECP-G Chem. Mater. 2012, 24, 255-268]. FIG. 16A shows pixel 2002 prior to application of a switching signal (to pixel electrode 711 and common electrode 705), with the pixel having a transparent conductive polymer layer 2010, and a corresponding yellow optical state 2013. FIG. 16B shows pixel 2002 after application of a switching signal (and application of a maintenance signal), resulting in a green polymer layer 2021, and a corresponding green optical state 2020. The pixel remains in its volatile state until the maintenance signal is terminated, at which point it self-switches back to its yellow stable state 2013 as shown in FIG. 16C.

The right pixel 2001 is similar to pixel 701 in FIG. 5A, thus only differences will be discussed. Specifically, this exemplary embodiment comprises a redox layer comprising a solid electro-polymerizable monomer 2011 of fluorenone-thienylene vilylene [TVF] (((2,7-bis(5-[(E)-1,2bis(3-octylthien-2-yl)ethylene])-fluoren-9-one) [“Solution versus solid-state electropolymerization of regioregular conjugated fluorenone-thienylene vinylene macromonomers-voltammetric and spectroelectrochemical investigations”, R. Demadrille et al., J Solid State Electrochem (2007) 11:1051-1058]. This exemplary electro-polymerizable monomer 2011 is red in its first stable state (prior to power being applied for the first time), with the pixel 2001 having a corresponding red optical state 2012 as shown in FIG. 16A. This operable state is irreversibly switchable, by applying a switching signal across pixel electrodes 704 and 705, to a second stable state, corresponding to a light blue in color (2018 in FIG. 16B). The change in the operable state and optical state (color) occurs by solid-state electropolymerization of the solid TVF monomer in conjunction with the shared electrolyte layer 2003 of pixel 2001. The light blue polymerized layer 2018 is partially transparent (and reflective) and color blends with the yellow electrolyte layer 2013 to yield an approximately green optical state 2019. It can be appreciated that the composite color of the optical state 2019 can be tuned, e.g. by selection of monomer layer 2011 thickness, concentration and selection of electrolyte colorant, or activation protocol (e.g. duration of activation signal). For example, it may be desirable to color match the composite optical state 2019 to the optical state 2020 of the volatile state of self-switching pixel 2002. Further, after application of a second switching signal the polymerized layer switches to a volatile third state, which is orange/red 2014, with a corresponding orange/red optical state 2015 of pixel 2001, as shown in FIG. 16C (note that the orange/red color and corresponding pattern used in FIG. 16C is not included in the Legend of FIG. 11). Analogous to above, the pixel 2001 will remain in this volatile state (and corresponding optical state 2019) for the duration of the applied maintenance signal. Upon termination of the maintenance signal the pixel self-switches back to its stable, second optical state 2019.

Other combinations of the polymorphic display 2000 are also possible. For instance, pixel 2002 could be constructed as pixel 2001 but with a solid monomer comprising a different modality of e.g. a volatile second state and a stable third state. Alternatively, it could be constructed as a display with pixel 2002 having the same modalities as (polymorphic) pixel 2001, however, with a second monomer having different optical properties in one or more states of those corresponding to pixel 2001.

It will be appreciated that although pixel 2001 comprises a solid electropolymerizable monomer (redox) layer 2011 in combination with an electrolyte layer 2003 which may be a liquid, semi-solid or solid, it could alternatively, or additionally (e.g. two redox sublayers), comprise a liquid electropolymerizable monomer layer in combination with a semi-solid, gel, or solid electrolyte layer. Alternatively, the redox layer may contain a liquid monomer in a mix (e.g. an EC mix as above) or form a gel or semi-solid layer (e.g. by adding for example zeolites, Al₂O₃, MgO, or SiO₂, or polymer such as polystyrene to the mix, or providing a porous or a printed microscale structure for the layer).

Emissive Non-Emissive Displays

Described below are displays that have both emissive pixels (e.g. pixels that can emit light) and non-emissive (passive) pixels. Such displays are collectively referred to herein as emissive/non-emissive (“E/N-E”) displays. In general, E/N-E displays are unitary apparatuses that have a plurality of pixels that include at least one emissive pixel and one non-emissive pixel, and that are configured as an electro-optic layer with electrodes on the surface of the electro-optic device. Of particular interest are E/N-E displays wherein at least two of the plurality of pixels have different operating properties; i.e. that are polymorphic.

E/N-E displays provide many benefits with compact form factors (e.g. thickness, surface area, shape), fit-for-purpose designs (e.g. optical effects and operable properties) and constructions, ease of fabrication (e.g., printing, spray casting, coating, roll-to-roll manufacturing), message integrity, robustness and durability, and lower net-integrated cost into intelligent display devices. Emissive pixels, particularly in combination with non-emissive pixels, advantageously draw a user's attention (e.g. alert/alarm), or provide focus to what's important, e.g. a particular item, good, or package, or change in condition/state of the good. Furthermore, emissive pixel(s) may convey specific messages where the presentation conveys information through color, brightness, or emissive pattern (e.g. flashing, blinking scrolling, radial, fading in/out etc.). Advantageously, the emissive characteristics can enhance the perceptibility of a displayed message, e.g. through increased contrast, colors, particularly in predominantly dark environments. E/N-E displays improve outcomes that depend on local user actions and transactions that depend on them. It should be noted that the emissive light is typically within the human visible spectrum range (intended for a human user), however, it may also be tuned to other wavelengths (e.g. IR or UV) for machine detection. Emissive pixels (or indicators), may further be enhanced with symbols (similarly to non-emissive pixels 1601 and 1602 in FIG. 12B), shapes, patterns, or alphanumeric characters. E/N-E displays, as well as E/N-E display devices and intelligent E/N-E display devices (both described below), may be flexible, semi-flexible, semi-rigid or rigid.

E/N-E Display Devices

E/N-E display may be fabricated as standalone structures, or combined with a wide variety of substrates, and advantageously with switching circuitry and other components. Such devices are referred to herein as E/N-E display devices. A substrate may be comprised, individually or in combination, of a variety of inorganic materials (e.g., many plastics, ceramics, or metals (e.g. foils), organic and biodegradable materials such as cellulose, hemp, certain plastics or other materials common to paper, card stock, packaging, fabric, wood, paperboard etc. Depending on the device construction, a substrate may be semi- or substantially transparent to enable viewing of the underlying E/N-E display.

Intelligent E/N-E Display Devices

Further to previous descriptions of intelligent display devices, an intelligent E/N-E display device is an apparatus comprising an E/N-E display and some or all of electronics, a power apparatus and appropriate to the application, a communication apparatus, sensors, and actuators. An intelligent E/N-E display device is typically a unitary apparatus configured to be coupled or combined with a good or its packaging. Often, but not always, the intelligent display device is low cost, often disposable, low power and small in size. In some applications, though the intelligent display device is significantly larger and designed to present high-content messages or messages to be read by humans, animals or machines at a distance. Exemplary E/N-E intelligent display devices include single use, multi-use, reusable/disposable items including labels, tags, patches (e.g. for healthcare), smart-cards (e.g. loyalty cards, stored-value, payment, security, access), packaging, containers, seals, caps, documents, test/sensing/monitoring devices, terminals, electronic-shelf labels, free-standing displays, electronics devices, finished goods and promotional items, etc. In certain embodiments E/N-E indicators/displays may be configured to be inserted, ejected, replaceable, or swappable.

In some embodiments the emissive and non-emissive properties of intelligent E/N-E display devices are managed to generate messages based on different combinations of emissive and non-emissive states according to internal rules or instructions (or external communications). And further, according to signals generated by actuators, or sensed or monitored conditions such as: temperature, humidity, pressure, shock/vibration, the presence of certain chemicals or biologics, electrical, magnetic, RF, light, sound or other forms of electromagnetic energy, ‘touch’ (resistive, surface capacitive, projected capacitive, surface acoustic wave and infrared sensors etc.), etc., location, proximity, motion, time, wireless communications, or combinations thereof.

In addition to the previous descriptions of signal circuitry, signal circuitry for E/N-E displays and devices controls the emissive output of E/N-E pixels according to an appropriate signal protocol (e.g. colors/patterns/intensity, output e.g. stable or fluctuating, continuous or pulsed/patterned, spectral range or bandwidth). The signal protocol may also determine the switching and maintenance signal according to the duration, pattern, and initiation and decay of the emissive light from E/N-E pixels (in responsive to changes in the signals). The signal protocol may also adjust the switching and maintenance signals according to the output of an ambient light sensor (and/or other environmental sensors such as temperature and humidity).

An exemplary intelligent E/N-E display device (e.g. an intelligent label) comprises a two indicator electro-optic E/N-E display comprised of one emissive “warning” indicator and one “fail-safe” non-emissive indicator. In this example, both indicators are mono-stable. The emissive warning indicator draws the attention of users and communicates a sense of immediacy—the need to act, for example in response to change in a monitored condition of a good. Depending on the application however, it's effectiveness may be diminished if the emissive pixel is ‘always on’ (e.g. continuously emitting, flashing etc.). Moreover, if for any reason the power is disrupted or terminated (e.g. the battery dies or a circuit breaks), the emissive indicator will convey a false-positive message. In other words, the emissive pixel will not emit or flash even though the condition of the good has changed. The companion non-emissive “fail-safe” indicator solves that problem. When the intelligent E/N-E display device is initiated, the non-emissive indicator is switched to an optical state that communicates the device is working. That optical state (and corresponding message—“the device is working”) is maintained as long as a maintenance signal is applied. If for whatever reason power is disrupted or terminated, the non-emissive indicator automatically self-switches to a different (unpowered) optical state that communicates the device is not working correctly—“it failed”.

Emissive Pixels

Emissive pixels are generally, mono-stable (non-emissive in its initial state, volatile in the switched emissive state), self-switching and reversible. An emissive pixel may, however, have one or more emissive states. And further, it may also have multiple non-emissive states and different operable properties (e.g. switching, stability or transition sequencing). Such “E/N-E pixels” may operate as emissive pixels, non-emissive pixels or hybrid pixels, the latter having different emissive and non-emissive properties [modes] depending on the switching protocol. An E/N-E pixel for example, may be switchable between emissive and non-emissive modes. And depending on the composition of the pixel and the switching protocol, the emissive mode maybe switched independently of the non-emissive mode, or the non-emissive mode may be switched independently of the emissive mode. And further depending on the composition of the pixel device configuration, so may the pixel's operable modes. In practice, an E/N-E display may comprise: one E/N-E pixel plus either one emissive pixel or one non-emissive pixel, or two E/N-E pixels. Or in its simplest configuration, an E/N-E display can comprise a single E/N-E pixel where its emissive and non-emissive modes are independently switchable.

Of particular interest are emissive pixels based on light-emitting electrochemical processes. In its simplest configuration, a light-emitting (emissive) electrochemical pixel is constructed as electro-optic layer (or portion thereof) that comprises an electroluminescent compound within an electrolyte configured to be in direct contact with or in close proximity to a pair of electrodes (of which at least one is semi- or substantially transparent). Note that the electro-optic layer of an emissive (and non-emissive) pixel, as generally discussed herein, may comprise a single or a multitude of distinct or blended sub-layers with a pair of electrodes proximate the surfaces of the electro-optic layer. In a preferred embodiment the light emitted from an emissive or E/N-E pixel is generated within the electro-optic layer, without the requirement of an electrode interposed between the surfaces of the electro-optic layer (thus without the need for a backlight).

The electroluminescent compound may e.g. comprise small molecules (e.g. ion transition metal complex—iTMC with or without an electrolyte), electroluminescent polymers, or a blend thereof. The electroluminescent compound (or luminophore) may constitute a major portion (e.g. wt %) of the active layer (common for light-emitting electrochemical cells (LECs)), or the electrolyte may constitute the major portion (common for electrochemiluminesce devices (ECLDs)). The emissive electrochemical pixel may favorably comprise an electro-optic layer of a substantially uniform mixture of electrolyte and electroluminescent compound or have multi sublayers. For instance, a bi-layer construction may comprise separate (semi-) solid electroluminescent and electrolyte layers with, e.g., the electrolyte layer being patterned (e.g. fine lines) onto an electrode (e.g. front), and the electroluminescent layer making contact with the patterned electrolyte layer, as well as, both the electrodes.

Light emission from such emissive electrochemical pixels occurs after application of a suitable drive signal (i.e., switching signal and continued maintenance signal) to its pair of corresponding electrodes and is typically omnidirectional (e.g. favorable for double sided displays). However, predominantly directional light emission (for single-sided displays) can be achieved by absorptive or preferably reflective layers at/or adjacent to the back electrode (presuming a substantially semi- or substantially transparent front electrode) and/or alternatively by providing a focusing layer (e.g. a micro lens array stamped, molded, etched etc. on a separate substrate or part of the display device substrate) at the front of the display. Such as focusing layer (or a separate cover layer) may also be colored, tinted or patterned.

Depending on construction and materials characteristics the light emission (within a range typically from visible to near UV) may originate near or at the middle of the active (single mixture) layer (e.g. typically for LECs), or may originate proximate the electrode(s). In case of a bi-layer construction (discussed above), the light emission may also occur in the electroluminescent layer at or proximate the edges (sides) of patterned electrolyte layer. It should be noted that although the above description pertains to a vertical stack configuration (with separate and vertically spaced electrode layers), the same principles can be applied to structures with a single electrode layer containing pair(s) of electrodes (e.g. arranged as interdigitated electrode pairs such as those show in embodiment 1200 of FIG. 10A).

The drive signal for a light-emitting electrochemical pixel (across its corresponding pair of addressing electrodes) may consist of a DC voltage differential (for example in the 2-6V range typically for LECs) but may also consist of an AC signal (e.g. 2-5V range at less than 1 kHz), or a combination thereof. There may further be a delay (e.g. from less than 1 second to 10's of seconds or more) from the start of the switching signal to the start of the light emission (e.g. in case of the in-situ forming of an effective p-n junction of a typical LEC).

Although in its simplest configuration, the electro-optic layer (or sublayers) of a light-emitting electrochemical pixel comprises only an electroluminescent compound and an electrolyte, additional materials (additives) may be included to provide structure (rigidity, flexibility), provide structure (rigidity, flexibility), facilitate manufacturing processes, e.g., solvents for facilitating printing or spray casting of electro-optic (sub) layers, such as propylene carbonate, ethyl acetate, acetonitrile, tetrahydrofuran, 1.4-dioxane, toluene, N,Ndimethylformamide (DMF), chloroform, polyalkylene glycol and mixtures thereof. Some solvents such as propylene carbonate act as plasticizers and are advantageous to include in the final device. Other additives that improve performance (e.g. switching times or quantum efficiencies), include MWCNTs and poly(ABTS). Also, electron transport and hole transport polymers and compounds can be blended with the electroluminescent material to improve quantum efficiencies (e.g. poly(vinylcarbazole) and 1,3-bis[2-(4-tert-butylphenyl)-1,3,4-oxadiazo-5-yl]benzene (OXD-7)). In addition to additives providing matrixes (i.e., hosts/binders, and associated crosslinkers, activators) previously discussed, of particular interest are PMMA, polycaprolactone (PCL, which also is considered biodegradable), polyethylene oxide (PEO), biological binders such as gellan gum, carboxymethyl cellulose, sodium hyaluronate, xanthum gum, pectin, heparin, DNA, sulfated cellulose, dextran sulfonate, guar gum, and agarose. The formation of a solid matrix is achieved by UV radiation when employing acrylates such as dipropylene glycol diacrylate (DPGDA) which are activated with a photoinitiator such as, e.g., DMPAP. Such materials (in additional to the electrolytic material) advantageously provide a sufficient electrochromic operating window to activate and sustain the light emission appropriate to the application. Furthermore, the electroluminescent material may further be complemented by florescent or phosphorescent materials, or materials displaying thermally activated delay fluorescence (TADP) or photoluminescence.

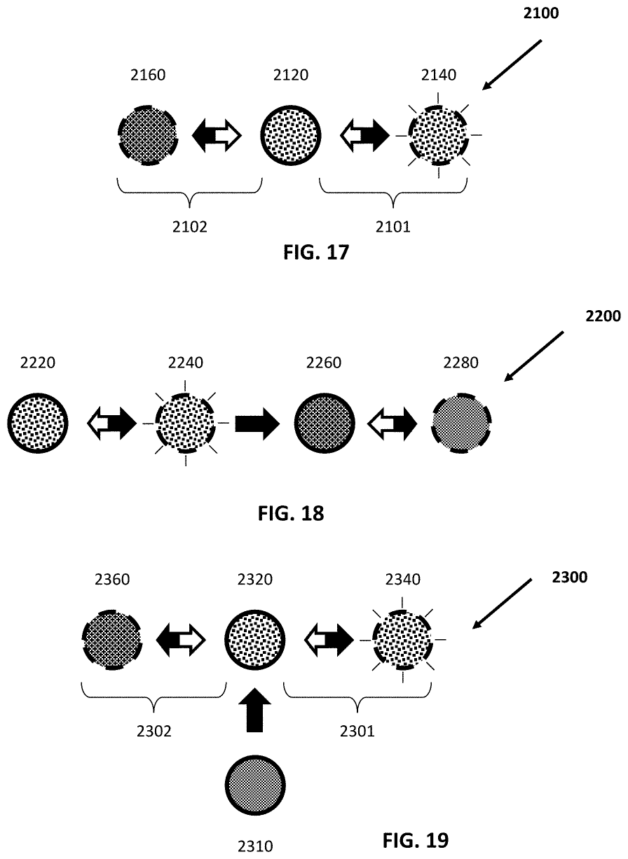

Other additives to the electroluminescent electro-optic layer may add additional operable modalities. For the example, the operable mode of an emissive pixel can be extended by adding an electrochromic (reversible) self-switching material such as viologen (or other bipyridum derivate) to a substantially uniform mix of the electroluminescent electro-optic layer, or by including an electrochromic conducting polymer on, for instance, the front electrode. Such constructions can, for instance as illustrated by the operable states 2100 in FIG. 17, provide a mono-stable, non-emissive 1st state 2120 (before applying any switching or maintenance signal), a volatile emissive 2nd state 2140 (maintained with a maintenance signal) when switched with a 1st protocol (e.g. polarity) along a first branch 2101, a volatile non-emissive 3rd state 2160 (maintained with a maintenance signal) when switched with a second protocol (e.g. opposite polarity) along a second branch 2102, with both the 2nd and 3rd states self-switching back to the 1st state 2120 upon termination of their respective maintenance signal.

The operable mode of an emissive pixel can alternatively be extended to include an irreversible switching transition, by adding, for example, an electropolymerizable monomer to a substantially uniform mix of the electroluminescent electro-optic layer (e.g., an EC mix and EE mix). Such a construction favorably comprising an electro-polymerization voltage threshold of the monomer which is higher than the activation voltage threshold for light emission from the electroluminescent compound can, for instance (as illustrated by the operable states 2200 in FIG. 18) provide the operable states of a mono-stable, non-emissive 1st state 2220 (before applying any switching or maintenance signal), a volatile emissive 2nd state 2240 (maintained with a maintenance signal) when switched with a 1st protocol (e.g. relatively low voltage), a stable non-emissive 3rd state 2260 when switched with a 2nd protocol (e.g. relatively high voltage), which is irreversible to the 1st state 2220 and to the 2nd state 2240, and (optionally) switchable with a 3rd protocol (e.g. opposite polarity) to a volatile, non-emissive 4th state 2280, which self-switches back to the 3rd state 2260 upon termination of its maintenance signal.

In another configuration the operable mode of an emissive pixel can also include an irreversible switching transition by including, for example, an electropolymerizable monomer layer or a polymer layer with operable states as shown in FIG. 13, as a sublayer of the electro-optic layer. Such constructions can, for instance as illustrated by the operable states 2300 in FIG. 19, provide the operable states of a mono-stable, non-emissive 1st state 2310, which can irreversibly switch (with a 1st protocol) to a stable, non-emissive 2nd state 2320. The stable non-emissive state 2320 can further transition to a volatile emissive 3rd state 2340 (maintained with a maintenance signal) when switched with a 2nd protocol (e.g. polarity) along a first branch 2301, or a volatile non-emissive 4th state 2360 (maintained with a maintenance signal) when switched with a 3rd protocol (e.g. opposite polarity) along a second branch 2302, with both the 3rd and 4th states self-switching back to the 2nd state 2320 upon termination of their respective maintenance signal. Note that in this scenario the pixel first needs to go through its first (irreversible) transition before it can emit light, in contrast to the scenario described above (in FIG. 18) in which the irreversible transition prevents the pixel from any further light emission. Further note that in some instances, the ability of a pixel to operate as an emissive pixel (or not), e.g. to enable or disable the emissive operable capability of the pixel, may be considered an operable property.

As previously discussed, E/N-E displays comprising at least one emissive and one non-emissive pixel, can span a multitude of pixel types, modalities, and combinations. A few exemplary configurations will now be discussed that include various E/N-E pixel modalities. For simplicity these structures include only two pixels, wherein one is emissive (i.e., includes at least one state that is emissive), and the other is non-emissive. Furthermore, these exemplary configurations each comprise a shared electro-optic layer (further comprising one or more sublayers) sandwiched between two electrode layers in a vertical structure.

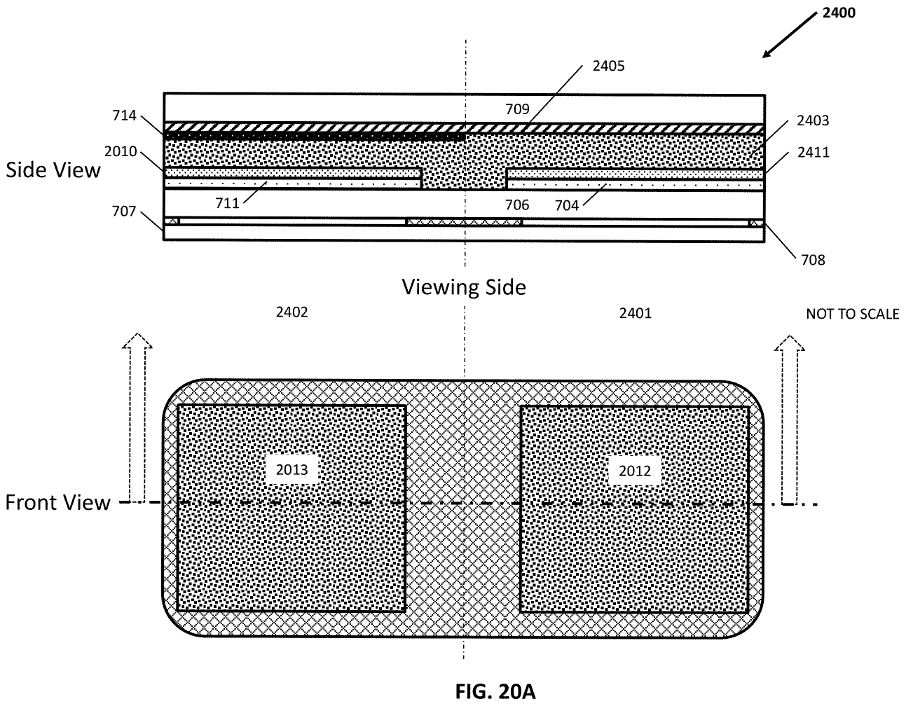

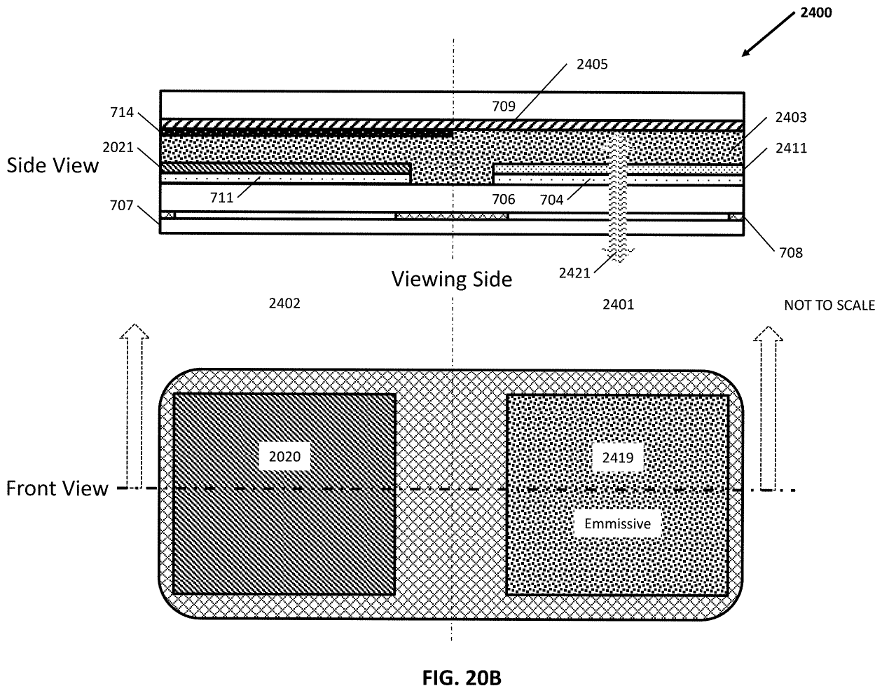

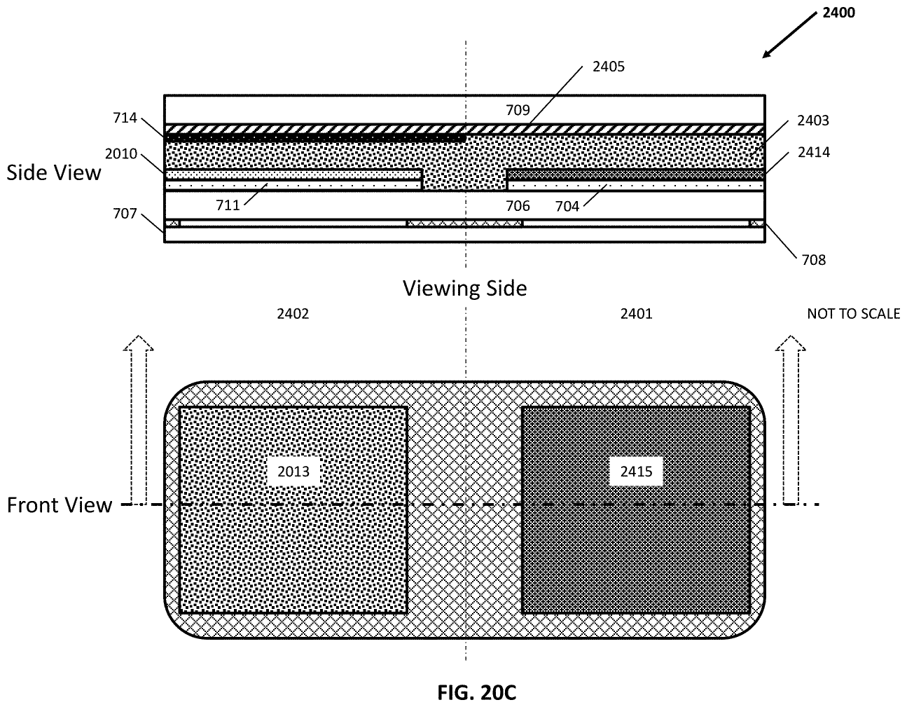

FIG. 20A shows an exemplary configuration of an E/N-E display 2400 comprising two pixels, each having different operable properties, in side view and front view. The left non-emissive pixel 2402, comprising a polymer (redox) layer 2010, is mono-stable and self-switchable having switchable operable properties. Pixel 2402 is similar to pixel 2002 of FIG. 16A, thus only differences will be discussed. Specifically, instead of having an (yellow) electrolyte 2003, it comprises an electroluminescent electrolyte mixture (EE mix) 2403 and a back electrode 2405, both shared with right pixel 2401. The emissive right pixel 2401, is mono-stable with a self-switching modality and an emissive volatile state, and comprises an electroluminescent electrolyte mixture (“EE mix”) 2403 as an electro-optic layer, sandwiched between front electrode 704 with additional hole-transport layer 2411 and back electrode 2405. The EE mix of pixel 2403 comprises an emissive conjugated polymer “Super Yellow” (Livilux PDY-132, Merck), and an electrolyte (e.g. LiCF₃SO₃), and a suitable binder/matrix (e.g. PEO), with a largely clear to slightly yellow transparent (non-emissive) property. The front electrode 704 (at least semi-transparent), typically acting as the anode for emission, may be made of ITO as previously noted, but could also comprise AZO, Ag-wire, carbon nanotubes, graphene, etc. The hole-transport layer 2411 to facilitate the emissive properties, comprises a conductive polymer (here PEDOT:PSS). The back electrode 2504, typically acting as the cathode for emission, is reflective and may also be made of ITO (e.g. for dual side emission), however, preferably Al, Ca, Ba, Ag, Au, or a combination (e.g. alloy) thereof. It will be appreciated that common pixel electrode layer 2405 may also be pixelated with pixel specific material composition.

The EE mix layer 2403 including suitable additives (discussed above), as well as, other layers in the pixel stack, are advantageously formulated to facility layer deposition (e.g. slot-die, spray coating/casting, etc.) or printing (e.g. gravure, off-set, screen, ink-jet, etc.) in sheet-to-sheet (S2S) or roll-to-roll (R2R) processes. The various layers, which may comprise pixel specific compositions, may be consecutively be built up on a single substrate (e.g. 706) and finalized with an encapsulation layer(s), or by dividing the layers onto the front (e.g. 706) and back (e.g. 709) substrate and later combining them. An individual layer or a sub-stack of layers may also be built up on a carrier substrate, with subsequent detachment and integration with an adjoining layer of the final stack configuration. Additionally, light emitting shapes, symbols, patterns, alphanumeric characters may also be included, e.g. by patterning mask layer 708, the hole transport layer 2411, the back electrode 2405, the electro-optic layer (or sublayers) itself, or any combination thereof. The mask layer may further be “color” matched to the non-emissive stable off-state of the missive pixel. The mask may also consist of a non-emissive materials that are electrically addressable to dynamically generate the mask information (e.g. symbol), e.g. with an electrochromic, electrophoretic (shutter mode), or LCD layer.

The operable states of E/N-E display 2400 will now be discussed. As mentioned, non-emissive pixel 2402 is similar to pixel 2202 of FIG. 16A thus only differences will be highlighted. Specifically, FIG. 20A shows pixel 2402 prior to application of a switching signal (to pixel electrode 711 and common electrode 2405), with the pixel having a transparent conductive polymer layer 2010, and a corresponding (slightly) yellow optical state 2013 (due to the EE mix 2403). FIG. 20B shows pixel 2402 after application of a switching signal (and application of a maintenance signal), resulting in a green polymer layer 2021, and a corresponding green optical state 2020. The pixel remains in its volatile state until the maintenance signal is terminated, at which point it self-switches back to its yellow stable state 2013 as shown in FIG. 16C.

The operable states of pixel 2402 shown in FIG. 20A-C will now be discussed in reference to FIG. 17. Specifically, FIG. 20A shows emissive pixel 2401 prior to application of a switching signal (to pixel electrode 704 and common electrode 2405), with the pixel having a transparent hole-transport layer 2411 (i.e., stable reduced state of PEDOT.PSS), corresponding to (slightly) yellow optical state 2012 (due to the EE mix 2403), and stable operable state 2120 of FIG. 17. FIG. 20B shows pixel 2401 after application of a switching signal (and application of a maintenance signal), resulting in light 2421 being emitted from EE mix layer 2403, corresponding to emissive optical state 2419, and operable emissive state 2140 of FIG. 17. The pixel remains in its volatile state until the maintenance signal is terminated, at which point it self-switches back to its yellow stable state 2012 as shown in FIG. 20A (and stable operable state 2120 of FIG. 17). The switching and maintenance signals may in this case consist of DC voltage (e.g. 5V) across anode 704 and cathode 2405. Note that the double-arrow simplistically denotes light 2421 from the emissive EE mix layer, although the light originates from the electroluminescent material (“Super Yellow”) located within the in-situ formed p-n junction in the EE mix layer (advantageously near the vertical middle, extending laterally and bound by the pixelated electrode 704). It will be appreciated that other emissive colors than the relatively wide spectrum emission from Super Yellow can be achieved, with other electroluminescent materials, or blends thereof. For instance, depending on the particular selection, different optical states (i.e. emitted wavelength(s) or ranges) may be achieved by optical state specific driving protocols (e.g. the voltage levels of the maintenance signals).

Stable pixel 2401 in FIG. 20A (corresponding to the stable operable state 2120 in FIG. 17) may also be switched (and maintained) along branch 2102 (in FIG. 17) upon applying a second protocol (e.g. comprising 1V DC with opposite polarity to that of branch 2101) to a non-emissive volatile state 2160. In this volatile state the PEDOT:PSS layer is reduced resulting in a blue layer 2414 corresponding to a blue optical state 2415 (shown in FIG. 20C). Upon termination of the maintenance signal pixel 2401 self-switches to back to the initial stable state 2120 (in FIG. 17), and corresponding optical state 2012 as also shown in FIG. 20A. It should be noted that, the self-switchable non-emissive operable property of pixel 2401 may alternatively be “switched off” (i.e. removing branch 2102) by preventing electrochromic reactions in hole transport layer (PEDOT:PSS), e.g., by adding a buffer layer in-between the hole-transport layer 2010 and the EE mix 2403, e.g. of ZnO, CdO or SiC). Note that in this case the conducting polymer layer may be considered part on the electrode, as opposed to part of the electro-optic layer.

The operable states of an emissive pixel of E/N-E display in reference to FIG. 19, having irreversible, and emissive/non-emissive self-switchable operable properties, will now be discussed. For this case the emissive pixel is identical to emissive pixel 2401 of FIGS. 20A-C with the exception that hole-transport layer 2411 is replaced with either a solid electropolymerizable monomer layer (e.g. as discussed in Example 8) or a polymer layer (e.g. poly(propylenedioxythiophene) as discussed in Example 5), with both having self-switchable and irreversibly switchable operable states as illustrated in FIG. 13. In either case, the first state 2310 (of FIG. 19) is stable (as deposited before any switching signal is applied) with a corresponding optical state (e.g. red in case of the exemplary polymer). Upon applying a switching signal the layer irreversibly switches to second stable (substantially transmissive) state 2320 with a corresponding optical state of (slightly) yellow, similar to pixel 2401 in FIG. 20A. Note that in either (monomer or polymer) case the second stable state is provided by a (stable) polymerized and oxidized layer. Such an oxidized (and conductive) polymer layer may favorably act as hole-transport layer for further reversible switching to the volatile and emissive state 2340 along branch 2301, similar to pixel 2401 in FIG. 20B. Furthermore, it may also be further switched to non-emissive volatile state 2360 along branch 2302 with a corresponding optical state of blue (for the polymer case; orange/red for the monomer case), similar to pixel 2401 in FIG. 20C. It should be noted that in this example the pixel cannot emit light in its emissive state 2340 without first undergoing the irreversible switching between initial non-emissive stable state 2310 and non-emissive second stable state 2320 due to the largely insulating (and thus emission-inhibiting) properties of the electro-optic sublayer in state 2310.

One particular advantage of E/N-E displays is their total thickness: preferably less than 10 microns, more preferably less than 5 microns, most preferably less than 1 micron.

Multi-Layer Polymorphic Pixels and Polymorphic Displays

Described below are multi-layer polymorphic (MLP) pixels and MLP displays. MLP pixels have two or more vertically stacked electro-optic layers that cooperate to create novel combinations of operable properties and composite optical properties, and in operation, novel combinations of operable states and associated optical states. Of particular interest are MLP pixels where one of the electro-optic layers is polymorphic (which is equivalent to the electro-optic layer in a single layer polymorphic pixel-one that has at least two stable and one volatile operating states).

MLP displays may comprise two or more sets of multi-layer (ML) pixels wherein one of the sets are polymorphic (MLP pixels) and one of the sets of ML pixels are not polymorphic. MLP displays may also comprise two or more sets of MLP pixels, wherein the operable properties of one set are different from those of a second set. And, MLP displays may also comprise one or more sets of MLP pixels wherein one of the electro-optic layers of a set of MLP pixels is polymorphic.

Various configurations have been previously described with different combinations and types of electro-optic layers and sublayers, electrodes and circuitry, masks and supporting structure (e.g., substrates, cover or protective layers, containment walls, spacers or other structures), bonding agents, adhesives and sealants etc., and their selection for producing desired operable and optical states (e.g., transparency, reflectivity, color etc.). Accordingly, it should be understood that they are similarly used in the construction of ML pixels and ML polymorphic displays even when not explicitly described in the following discussions.

Note that a “layer” as the term is used herein in context of individual MLP and non-polymorphic ML pixels, may be discrete (e.g., patterned or segmented) or shared with, or common to, other pixels of the same set or with pixels of other sets. Note as well, the patterns, composition and order of the layers within the pixel stacks are not limited to those described below. And further, that the individual electro-optic elements may be individually addressed (e.g., the electro-optic layer of a single pixel), or addressed as groups (e.g., a single electro-optic layer spanning the pixels of a single pixel set or a plurality pixel sets).

Optical States/Visible Messages

The optical state of an MLP pixel is the composite of the respective optical states of their electro-optic layers (and electrodes, substrates, masks etc.) that correspond to their operable states. Filters, reflectors (e.g. single or dual sided reflective layers), absorbers (e.g. light absorptive layers), lenses, diffractive elements, anti-reflection coatings, treated surfaces etc. may also contribute to the individual and composite optical states.

The composite optical state of an MLP pixel or a set or sets of MLP pixels, form human or machine readable visible messages. Visible messages may comprise one or more, or a combination of: colors or patterns, shapes, symbols, icons, text etc., or transparency/opacity (e.g., optical shutters that reveal supplemental information—below).

Visible messages may be supplemented with information that alone or in cooperation with other visible elements produces an intended message. Supplemental information may be:
Fixed, stable, dynamic
Positioned in front of, behind, between or adjacent to the surfaces of an electro-optic layer
Non electro-optic (e.g., printed or otherwise deposited, thermochromic or other type of indicator) or electro-optic, or part of a status indicator, dashboard (described below) or display device as originally manufactured, or added post manufacture (e.g., printed after the fact, or when combined/assembled with another item or device such as a media, display, or smart device).

An exemplary MLP pixel set comprising supplemental information may have a transparent state that reveals a colored, patterned or symbolic (e.g., absorptive black, reflective colored, or semi-transmissive colored on a reflective white background) layer behind an electro-optic layer; or would obscure, complement, enhance an image presented by the electro-optic layer (the supplemental information, e.g., semi-transparent or opaque, positioned in front of the electro-optic layer).

Signal Protocol, Switching Signals

Driver circuitry and electrodes may be advantageously configured in various ways so that for example a switching signal can switch (in series or in parallel/concurrently) the operable (and thus optical) states of one or more electro-optic layers of a MLP pixels or a set of MLP pixels, or one or more co-layer (or sublayer) within them. Further, the switching signals may leverage the different thresholds (e.g., voltage, current), polarities and durations, for switching the materials (or subset of materials, e.g., one of two monomer redox materials) that comprise an electro-optic layer or the entirety of one or more electro-optic layers. For instance wherein the switching signals are asynchronous.

Exemplary Multi-Layer Polymorphic Pixels and Polymorphic Displays

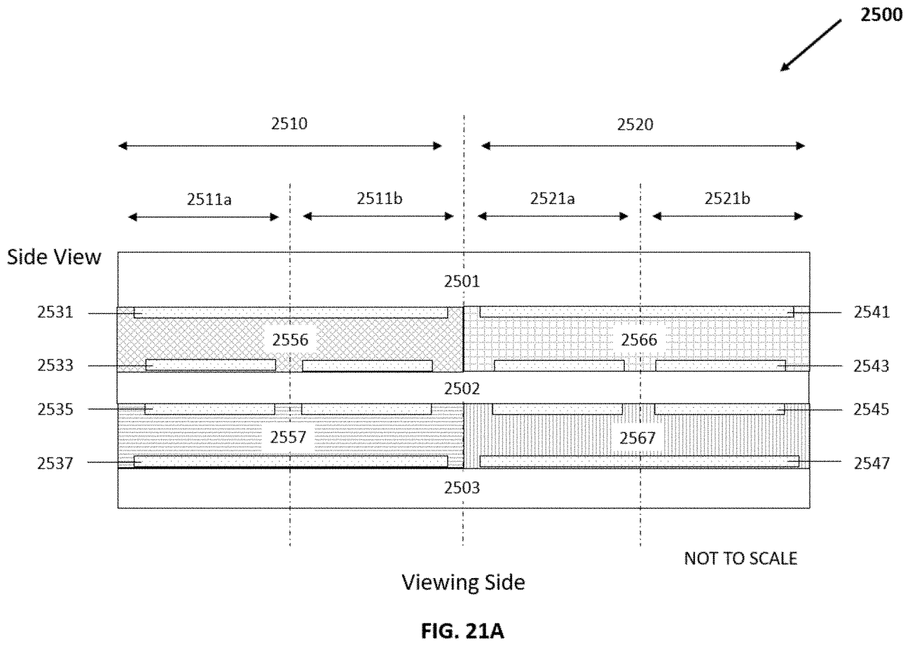

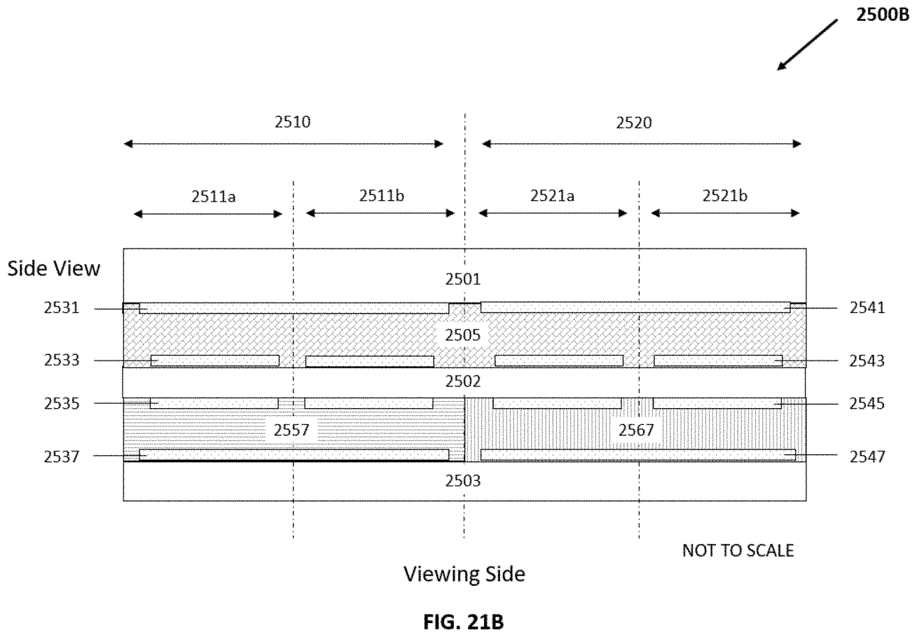

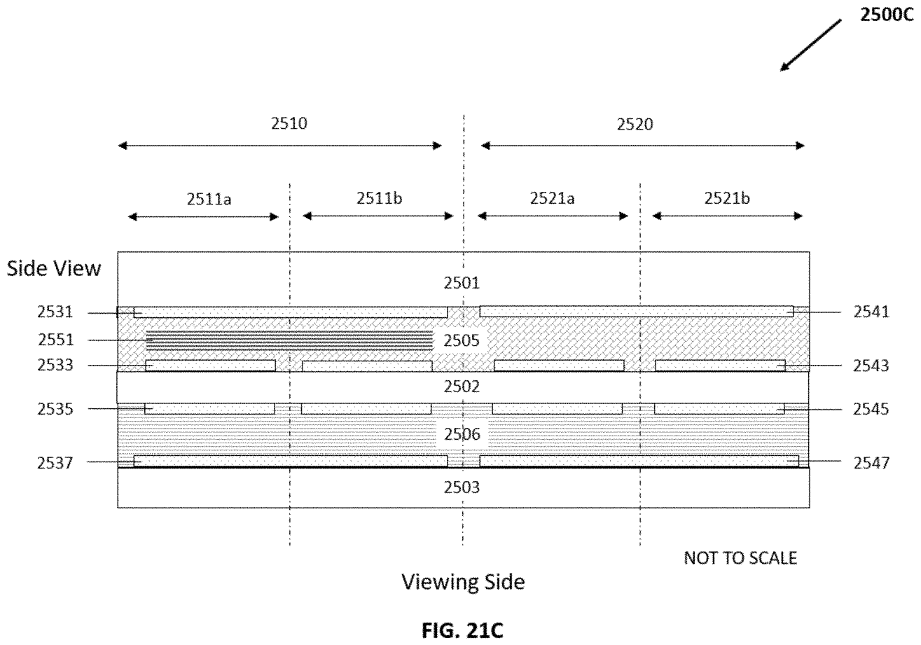

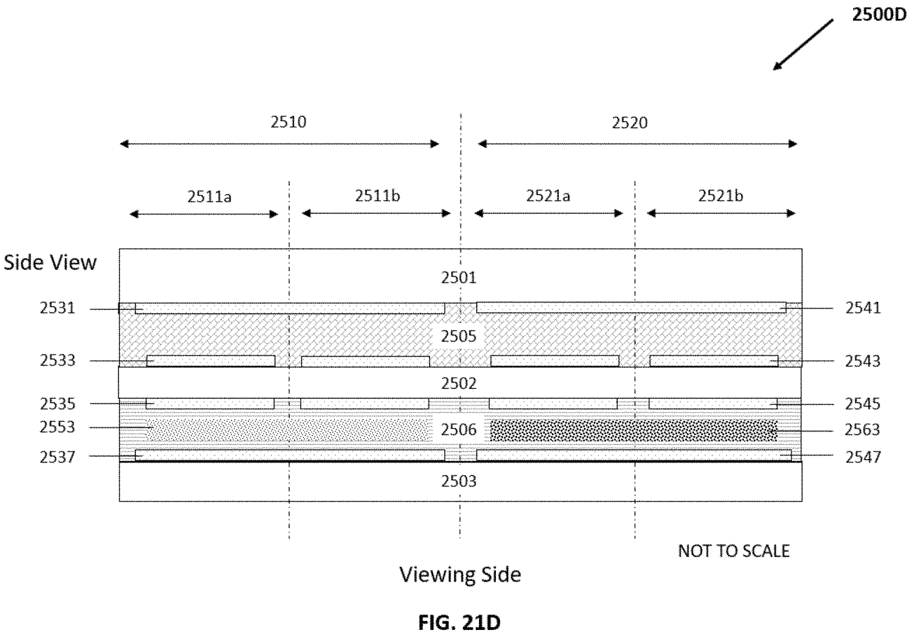

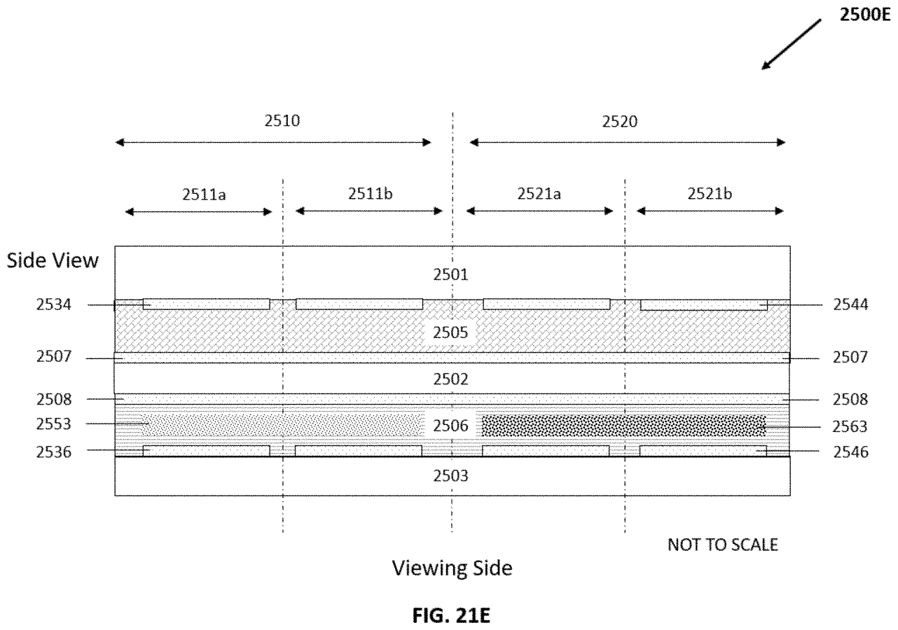

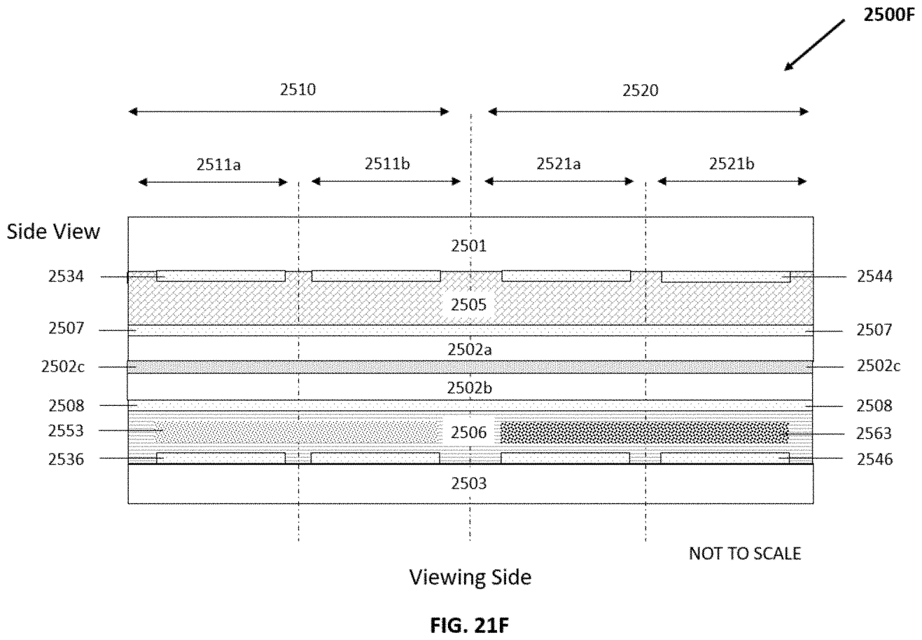

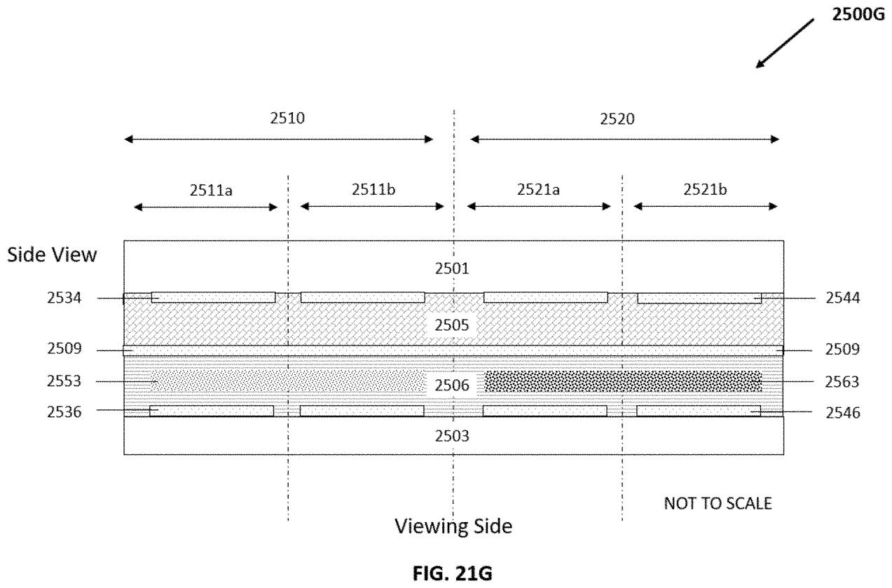

Described below and illustrated in FIGS. 21A-23B are exemplary MLP pixels and MLP displays. Note that the patterns used to illustrate the electro-optic layers (and other elements) in the figures are only intended to illustrate their differences from one another (e.g. operable properties, construction, composition, type etc.) and not their optical properties. Note too that the embodiments described and illustrated herein are presented as single-sided (a front viewing surface). It should be understood that dual-sided (viewable from the front and the back surfaces) are also possible using the same methods and with appropriate regard for the transparency of the materials (e.g., both front and the back substrates and adjacent electrodes need to be transparent).

FIG. 21A illustrates (in side view) a simple MLP display 2500 comprising a first MLP pixel set 2510 comprising two MLP pixels 2011a and 2011b and a second MLP pixel set 2520 comprising two MLP pixels 2521a and 2521b. MLP display 2500 comprises a back substrate 2501 (opaque or transparent), a middle substrate 2502 (transparent) and front substrate 2503 (transparent). Not shown are any structures between horizontally adjacent electro-optic layers, masks, protective layers, encapsulants etc. as previously described for polymorphic displays.

In this embodiment MLP pixels 2511a and 2511b of pixel set 2510 comprise a first electro-optic layer 2556 with adjacent electrode 2531 shared by MLP pixels 2511a and 2511b (front of back substrate 2501) and electrodes 2533-one for MLP pixel 2511a and one for MLP pixel 2511b (back of middle substrate 2502), and a second electro-optic layer 2557 with adjacent electrode 2537 shared by MLP pixels 2511a and 2511b (back of front substrate 2503) and electrodes 2535-one MLP pixel 2511a and one for MLP pixel 2511b (front of middle substrate 2502).

Similarly the MLP pixels 2521a and 2521b of MLP pixel set 2520 comprise (1) a first electro-optic layer 2576 with adjacent electrode 2541 shared by MLP pixels 2521a and 2521b (front of back substrate 2501) and electrodes 2543-one for MLP pixel 2521a and one for MLP pixel 2521b (back of middle substrate 2502), and (2) a second electro-optic layer 2567 with adjacent electrode 2547 shared by MLP pixels 2521a and 2521b (back of front substrate 2503) and electrodes 2545-one MLP pixel 2521a and one for MLP pixel 2521b (front of middle substrate 2502).

In this example, each of the electro-optic layers 2556, 2557, 2566 and 2567 have different operable properties. MLP pixel set 2511 will therefore have different operable properties than MLP pixel set 2521. As will be illustrated in FIGS. 21B-F if one of the electro-optic layers in the first set of MLP pixels is different from one of the electro-optic layers of another MLP pixel set, then the operable properties of the two MLP pixel sets are different from each other and ML display is polymorphic.

FIG. 21B illustrates MLP display 2500B which is similar to MLP polymorphic display 2500. In this embodiment MLP pixel set 2510 and MLP pixel set 2520 share a common electro-optic layer 2505 (back). As with the MLP display 2500, the two MLP pixel sets have different electro-optic layers 2557 and 2567 each of which has different operable properties than the other. MLP pixel set 2510 and MLP pixel set 2520 therefore have different operable properties and accordingly, ML display 2500B is also polymorphic.

FIG. 21C illustrates a MLP display 2500C similar to MLP display 2500B illustrated in FIG. 21B. In this embodiment however both MLP pixel sets 2511 and 2521 share a common front electro-optic 2506 as well as common back electro-optic layer 2505.

The composition within electro-optic layer 2505 where it spans the MLP pixels 2511a and 2511b of MLP pixel set 2510 also comprises one or more material sublayers 2551 (e.g., conductive polymers, viologen compounds, or monomers as previously described). The material sublayer or sublayers 2551 may be patterned or continuous, and located advantageously at different locations, and in different orders, within electro-optic layer 2505 (e.g., adjacent the surface of electrodes 2531 or 2533). The material sublayers determine the operable (and optical) properties of the MLP pixels 2511a and 2511b—and thereby MLP pixel set 2510. Accordingly the operable properties of MLP pixel set 2510 are different from those of MLP pixel set 2520 and ML display 2500C is polymorphic.

FIG. 21D illustrates a MLP display 2500D similar to MLP display 2500C however instead of having material sublayer 2551 within electro-optic layer 2505, electro-optic layer 2506 comprises one or more material sublayers 2553 spanning MLP pixel set 2510 and one or more material sublayers 2563 spanning MLP pixel set 2520, wherein the material sublayers 2553 and 2563 produce different operable properties.

FIG. 21E illustrates a MLP display 2500E similar to MLP display 2500D however in this embodiment (1) the electrode layer adjacent back substrate 2501 is patterned to form electrodes 2534-one for MLP pixel 2511a and one for MLP pixel 2511b, and 2544-one for MLP pixel 2521a and one for MLP pixel 2521b. The electrode layer adjacent front substrate 2503 is also patterned to form electrodes 2536-one for MLP pixel 2511a and one for MLP pixel 2511b, and 2546-one for MLP pixel 2521a and one for MLP pixel 2521b. And, electrode layers 2507 and 2508 adjacent middle substrate 2502 (back and from respectively) the MLP pixels of both MLP pixel set 2510 and 2520.

FIG. 21F illustrates a MLP display 2500F similar to MLP display 2500E, however in lieu of a single middle substrate 2502, a substrate 2502a is configured adjacent to the front of electrode 2507 and a substrate 2502b is configured adjacent to the back of electrode 2508. Interposed between substrate 2502a and 2502b is a bonding material 2502c (adhesive, epoxy, glue, laminate etc.). Note that a bonding material may not be required, e.g. and substrate 2502a and substrate 2502b may be fused together.

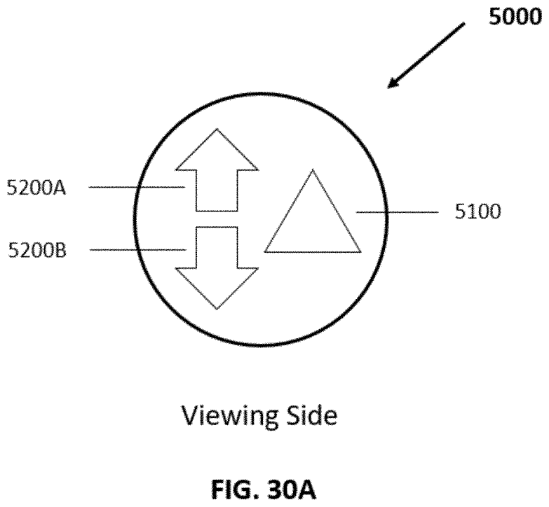

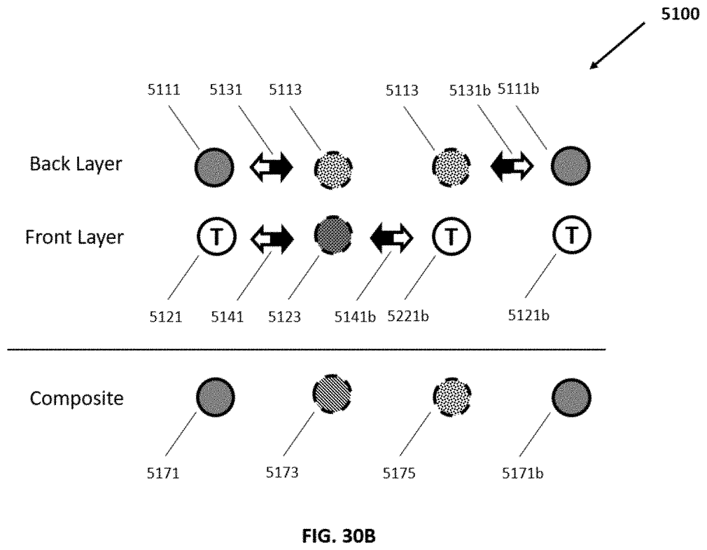

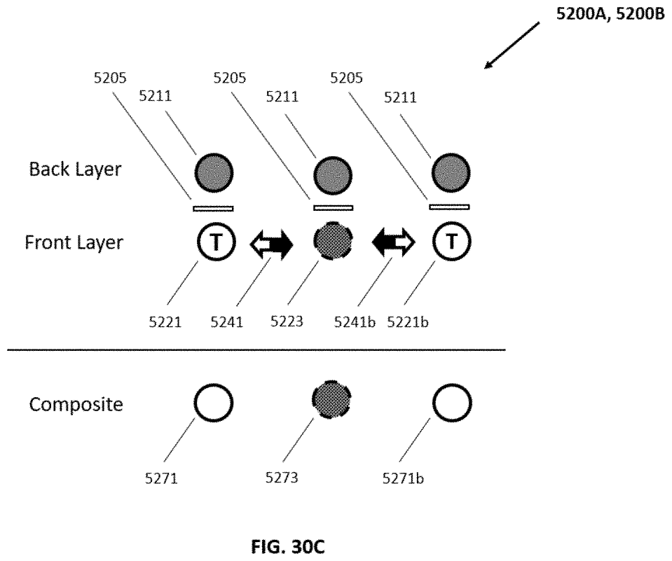

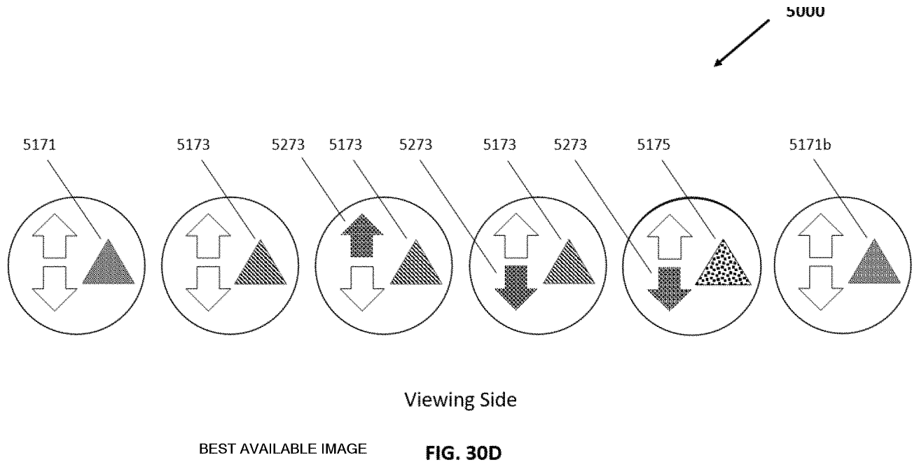

An advantage of this embodiment is that the front electro-optic layer, adjacent electrodes and substrates, and the back electro-optic layer, adjacent electrodes and substrates, may be efficiently fabricated as two separate structures (e.g., thin films) and then combined. And further films of different compositions, operable and optical properties and types may be efficiently combined to create different MLP pixels and MLP displays (including those with more than two electro-optic layers. Such films also facilitate the inclusion of ‘masks’ between the films to create different polymorphic pixels and corresponding operable and optical effects. See for example FIG. 30C.

FIG. 21G illustrates a MLP display 2500G which is similar to MLP display 2500E, however in lieu of middle substrate 2502 and adjacent electrode layers 2507 (back) and 2508 (front), a single electrode 2509 is configured adjacent to both electro-optic layers 2505 and 2506. Advantageously either electro-optic layer 2505 or electro-optic layer 2506 is solid or semi-solid to facilitate fabrication.

Multi-Layer Polymorphic Displays with Polymorphic Electro-Optic Layers

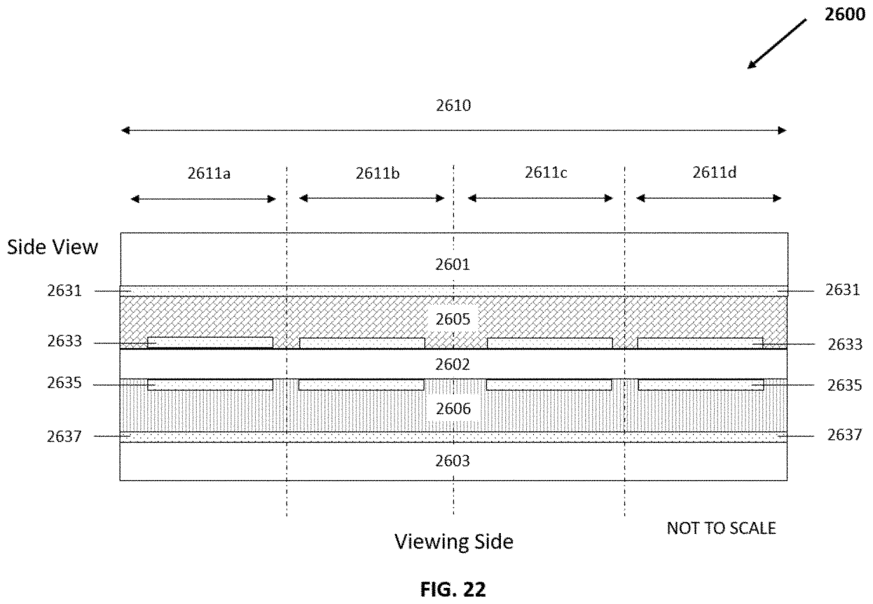

FIG. 22 illustrates a simple MLP display 2600 with a single pixel set 2610 comprising four MLP pixels 2611a, 2611b, 2611c and 2611d. Each MLP pixel has in common polymorphic electro-optic layer 2605 and non-polymorphic electro-optic layer 2606, substrates 2601 (back, opaque or transparent), 2602 (middle, transparent) and 2603 (front, transparent); and common electrode layers 2631 (front of back substrate, transparent or opaque) and 2633-one for each ML pixel (back of middle substrate, transparent), and 2635-one for each MLP pixel (front of middle substrate, transparent) and 2637 (back of front substrate, transparent).

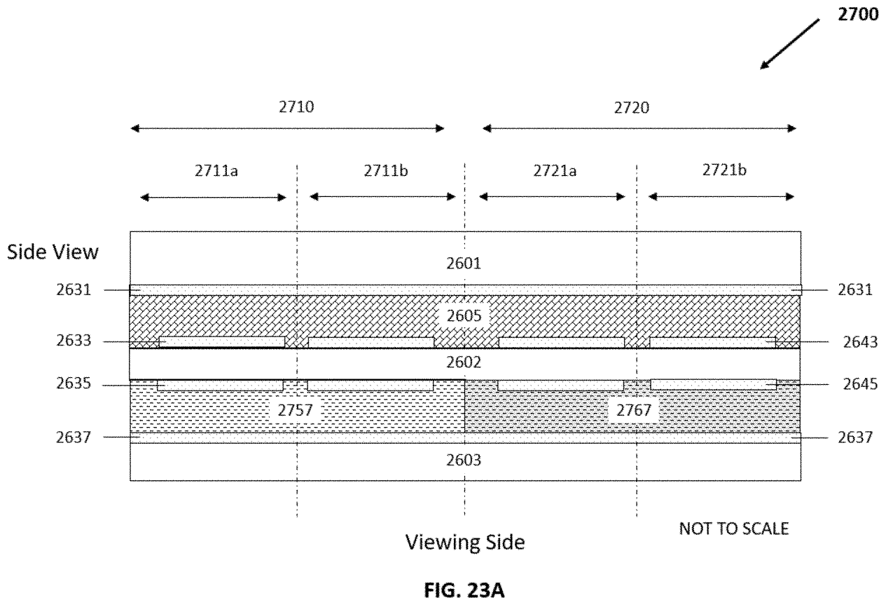

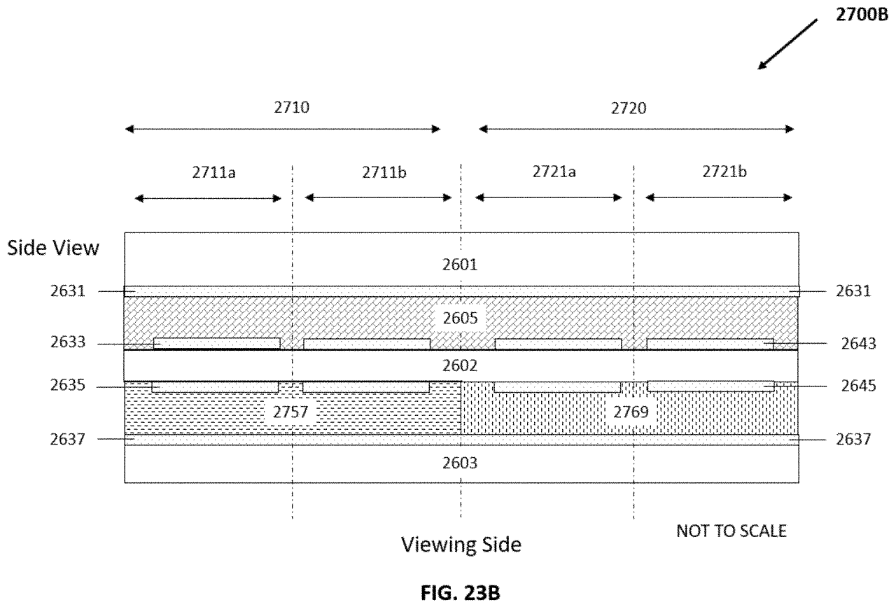

FIG. 23A illustrates a MLP display 2700 comprising the same substrate configuration as MLP display 2600. This embodiment however comprises a first MLP pixel set 2710 comprising MLP pixels 2711a and 2711b and a second MLP pixel set 2720 comprising MLP pixels 2721a and 2721b. The pixels of MLP pixel sets 2710 and 2720 have in common electrodes 2631 and 2637, and polymorphic electro-optic layer 2605. The pixels of MLP pixel set 2710 comprise electrodes 2633—one for each MLP pixel (back of middle substrate, transparent), and 2635—one for each MLP pixel (front of middle substrate, transparent), and non-polymorphic electro-optic layer 2757. The pixels of MLP pixel set 2720 comprise electrodes 2643—one for each MLP pixel (back of middle substrate, transparent), and 2645-one for each MLP pixel (front of middle substrate, transparent), and non-polymorphic electro-optic layer 2767, where non-polymorphic electro-optic layer 2767 has the same operable properties as those of non-polymorphic electro-optic layer 2757 but different optical states according to their respective operable states. Accordingly, the pixels of MLP pixel set 2710 and the pixels set 2720 have the same operable properties but different optical states according to their respective operable states.

FIG. 23B illustrates a MLP display 2700B is similar to MLP display 2700. In this embodiment however non-polymorphic electro-optic layer 2769 of MLP pixel set 2720 has different operable properties than non-polymorphic electro-optic layer 2757 of MLP pixel set 2710.

Polymorphic Status/Fail-Safe Indicators

A single MLP pixel, or a set of MLP pixels comprising concurrently switchable or self-switching MLP pixels having the same operable properties, can be thought of as MLP “indicator.” Of particular interest are status/fail-safe MLP indicators that alone or in combination automatically present different visible “messages” (e.g. status alerts or alarms using different colors, shapes, symbols, colors, patterns etc. or combinations thereof) in response to the absence, disruption or termination of an electrical signal. Or more generally, that automatically self-switch from a volatile state having an optical state indicative of a first operating condition to a stable state having an optical state indicative of a second operating condition, wherein the optical state indicative of the second operating condition is different from the optical state preceding the optical state indicative of the first operating condition.

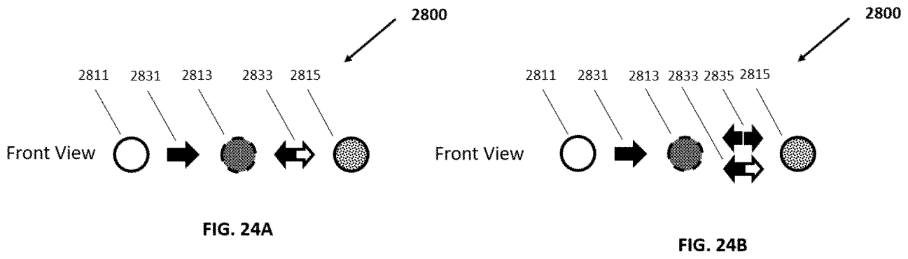

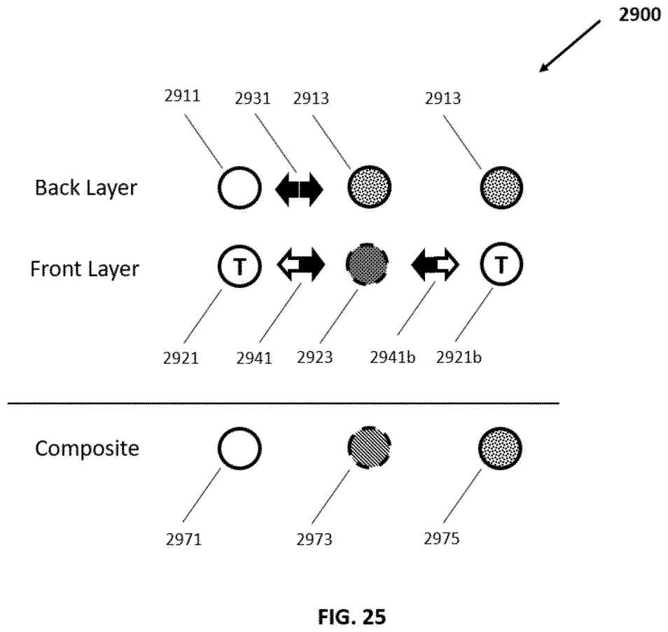

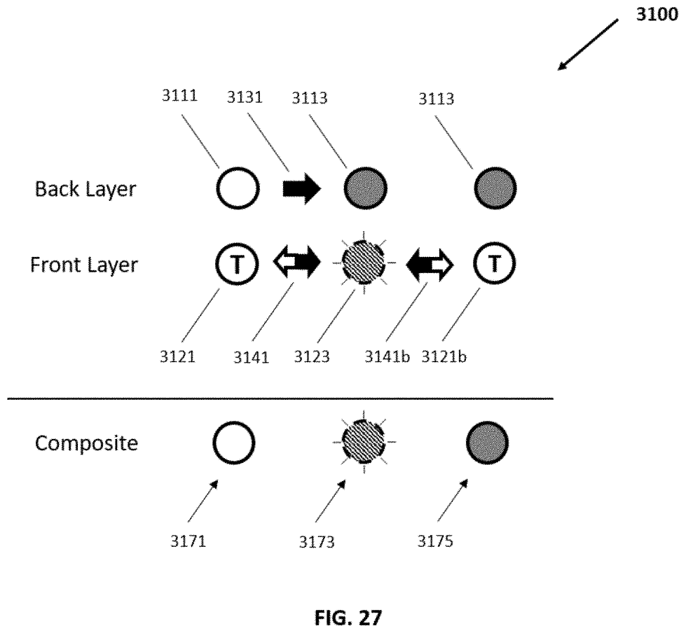

Exemplary single layer and MLP status/fail-safe indicators (pixels) are now described and illustrated in FIGS. 24A-28 as single indicators (pixels) with perceptible transitions changes in optical states (visible messages) that correspond to different combinations of their operable states. The symbols used in the illustrations follow the conventions described the Legend in FIG. 11. In addition, used herein are symbols for transparent or substantially transparent optical states—the letter “T” (see for example, FIG. 25 indicator 2900, operable state and optical state 2921). Also used is the symbol for emissive displays (see for example FIG. 27 indicator 3100, operable state and optical state 3123). The term “device” as used below, refers to any electronic device to which the indicator is directly or indirectly electrically coupled (and depending on context, also includes the indicator).

While the exemplary visible messages (composite optical states) are illustrated using only colors and simple combinations thereof (and later in combination with shapes), it should be understood that polymorphic status indicators may comprise multiple independently addressable elements (e.g., pixels, segments) configured to generate compound or other complex images, symbols or alphanumeric characters.

FIG. 24. A illustrates operable states, transition sequences and corresponding visible messages (optical states) for a single layer polymorphic status indicator 2800. In this embodiment visible message 2811 is neutral (e.g., colorless, a neutral color) indicative that “the device is new, never been ‘turned on’ (activated, switched)”. The status indicator 2800 may then be switched 2831 to irreversibly transition from stable state and visible message (neutral) 2811 to a volatile state and visible message (blue) 2813 that indicates “all is well”: “the device is ‘on’, working correctly and monitored conditions are OK”. If power is disrupted status indicator 2800 automatically self-switches 2833 and transitions to a stable state and visible message (yellow) 2815 indicating that “the device failed and an action is required”.

Because the transition from the initial stable state and visible message 2811 to volatile state and visible message 2813 is irreversible—it cannot be switched to transition from the volatile state and visible message 2813 back to the initial stable state and visible message 2811, users can be assured that a used, failed or expired device is not confused with a new, fresh or unused device.

FIG. 24B illustrates that single layer polymorphic status indicator 2800 also supports a transition sequence where the indicator may be intentionally switched 2835 to transition from volatile state and visible message 2813 to stable state and visible message 2815 to indicate for example that “a monitored condition exceeded a preset threshold—and an action is required”. If for example a battery is replaced or power otherwise restored, status indicator 2800 may be reset: intentionally transitioned (reversed) from stable state and visible message 2815 back to volatile state and “all is well” visible message 2813. As noted above in regards to FIG. 24A, the status indicator cannot however be further transitioned back to the initial stable state and visible message 2811.

FIG. 25 illustrates operable states, transition sequences and corresponding optical states of electro-optic layers, and their composite operable states and visible messages (transitions are not shown for the composites) for an MLP status indicator 2900. In this embodiment the initial visible message (neutral) 2971 is a composite of the back layer optical state (colorless, a neutral color) 2911 and the front layer optical state (transparent) 2921. The back layer may then be switched (2931) to transition to stable state and optical state (yellow) 2913, and concurrently the front layer switched (2941) to volatile state and optical state (cyan) 2923 producing a composite volatile state and visible message (green, e.g. by subtractive color blending/mixing) 2973. In the event of termination, disruption or absence of an electrical signal, the front layer automatically self-switches 2941b and transitions to stable state and optical state (transparent) 2921b producing a composite stable state and visible message (yellow) 2975.

MLP status indicator 2900 also supports a transition sequence wherein the front layer of status indicator may be intentionally switched 2941b to transition from volatile state and optical state (cyan) 2923 to stable state and optical state (transparent) 2921b. In general, although not shown in the following figures, self-switching transitions from a volatile state to a stable state may alternatively be intentionally switched (depending on the signal protocol).

Note that the self-switching transition 2941b to stable state and optical state 2921b is the same as the transition from volatile state and optical state 2923 back to stable state and optical state 2021. The latter sequence is repeated—and the states and transitions appended with a “b”, to illustrate the effect on the composite operable state and visible message, which in this illustration is composite stable state and visible message (yellow) 2975. The same approach is used in the following figures.

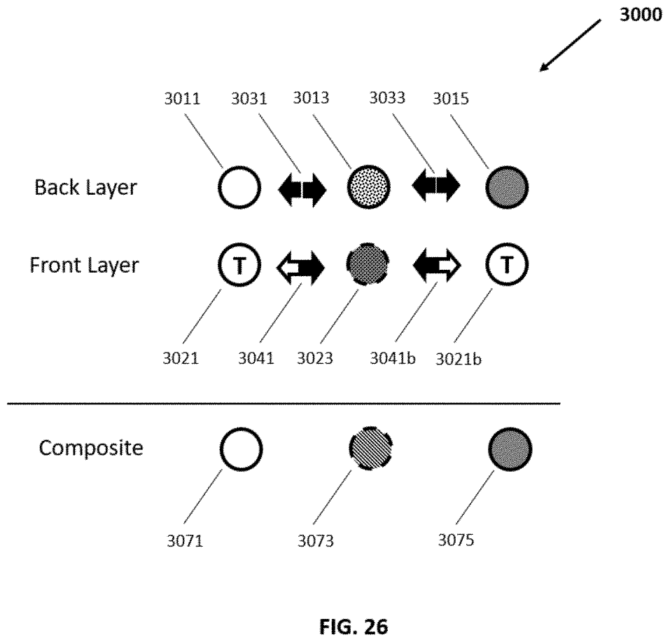

FIG. 26 illustrates operable states, transition sequences and corresponding optical states of electro-optic layers, and their composite operable states and visible messages (transitions are not shown for the composites) for a MLP status indicator 3000. In this embodiment the initial visible message (neutral) 3071 is a composite of the back layer optical state (colorless, a neutral color, e.g., reflective white) 3011 and the front layer optical state 3021 (transparent). The back layer may be switched 3031 to transition from stable state and optical state (neutral) to stable state and optical state (e.g., reflective yellow) 3013, and concurrently the front layer switched (3041) from stable state and optical state 3021 to volatile state and optical state (cyan) 3023 producing a composite volatile state and visible message (green) 3073.

The back layer may then be switched 3033 to transition from stable state and optical state (yellow) 3013 to stable state and optical state (red) 3015. Concurrently the electrical signal maintaining the volatile state and optical state (cyan) 3023 of the front layer may be intentionally terminated causing the front layer to self-switch 3041b and transition to stable state and optical state (transparent) 3021b producing a composite stable state and visible message (red) 3075.

Although not shown in FIG. 26, depending on the signal protocol the front layer alternatively may be intentionally switched from the volatile state and optical state (cyan) 3023 to transition to the stable state and optical state (transparent) 3021b. Note that MPL status indicator 3000 status also “fails-safe”. If prior to the back layer being intentionally switched from volatile state and optical state (yellow) 3013 to stable state and optical state (red) 3015, power to the status indicator 3000 is unintentionally terminated (absent) or disrupted, the front layer will automatically self-switch 3041b to stable state and optical state (transparent) 3021b as described above, and together with the stable state and optical (yellow) 3015 produce a composite stable state and visible message (yellow)—not shown.

FIG. 27 illustrates operable states, transition sequences and corresponding optical states of electro-optic layers, and their composite operable states and viewable messages (transitions are not shown for the composites) for a MLP status indicator 3100. In this embodiment the initial stable state and visible message (colorless, a neutral color) 3171 is a composite of the back layer optical state (neutral, reflective white) 3111 and front layer optical state (non-emissive, transparent) 3121.

The back layer may be switched 3131 to transition from stable state and optical state (neutral) 3111 to stable state and optical state (red) 3113. Concurrently the front layer may be switched (3141) from stable state and optical state 3121 (non-emissive, transparent) to volatile state and optical state (emissive, green) 3123 creating a composite volatile state and visible message (emissive, green) 3173. The front layer may then self-switch 3141b (or be intentionally switched) to stable state and optical state (transparent) 3121b, producing a composite visible message (red) 3175. The emissive optical state 3123 being bright enough to effectively overwhelm the contribution of the back layer optical state 3123 to the composite visible message 3173.

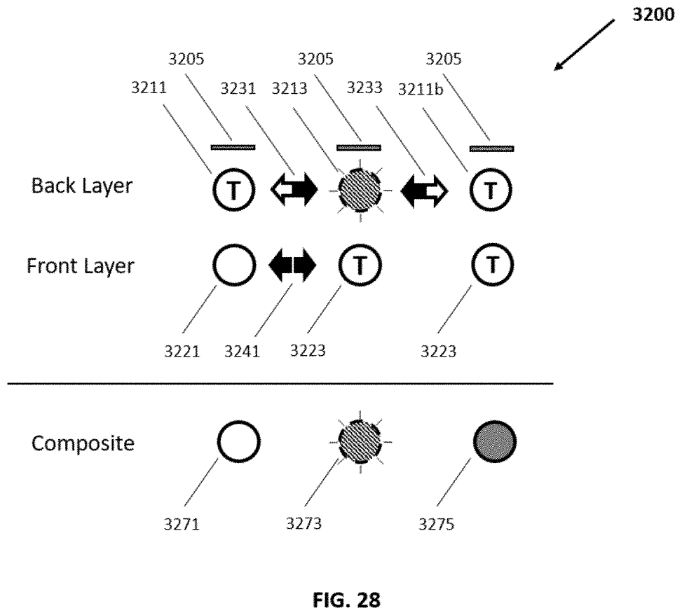

FIG. 28 illustrates operable states, transition sequences and corresponding optical states of electro-optic layers and a non electro-optic reflective layer behind the back electro-optic layer, and their composite operable states and viewable messages (transitions are not shown for the composites) for a MLP status indicator 3200. In this embodiment a reflective non electro-optic layer 3205 is configured behind the back electro-optic layer of the status indicator that contributes to the composite visible message.

The initial stable state and visible message (neutral, white) 3271 is a composite of the non electro-optic reflective layer optical state (red) 3205, the back layer optical state (non-emissive, transparent) 3211 and the front layer optical state (neutral, reflective white) 3221. The back layer may be switched 3231 to transition from the stable state and optical state (transparent) 3211 to volatile state and optical state (emissive, green) 3213. Concurrently the front layer can be switched from stable state optical state (neutral, white) 3221 to stable state and optical state (transparent) 3223, producing a composite visible message (emissive, green) 3273. The back layer can then be switched to transition from volatile state and optical state 3213 to stable state and optical state (transparent) 3211b, producing, with the reflective non electro-optic layer, a composite visual message (red) 3275.

As with the status indicator 3000, emissive optical state 3213 is bright enough to effectively overwhelm the contribution of the reflective layer 3205 to the composite visible message 3273. Although not illustrated as such the non electro-optic reflective layer may be a non solid fixed image e.g., a pattern, symbol, alphanumeric character etc.

Polymorphic Dashboards

Polymorphic “dashboards” comprise one or more PMD status indicators of the same or different types. The indicators of polymorphic dashboards may be separately encapsulated or preferably, share common materials, structure, circuitry, or encapsulation (e.g., they form a polymorphic display comprised of polymorphic pixels of different types). Dashboards, as the term is used herein “dashboard” are generally thin, flexible and otherwise suited for labels, tags, packaging etc. but should also be understood to apply to any such display or display device. And while the following descriptions and illustrations relate to single (front) viewable surface configurations, it should be understood that with appropriate selection of materials, particularly in regards to transparency, and electrode patterns, the same methods can be used for dual (front and back) viewable surface polymorphic dashboards.

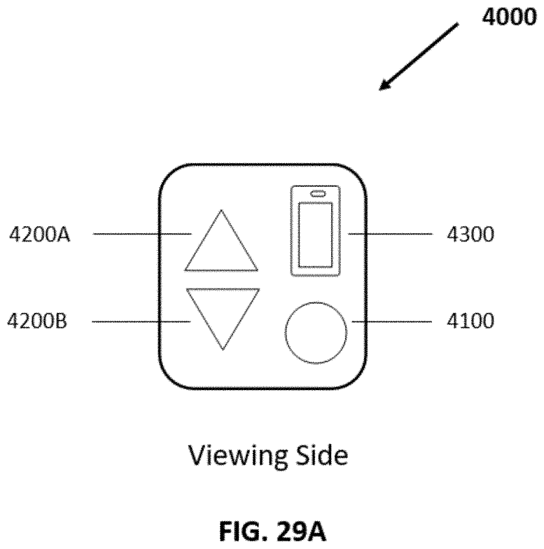

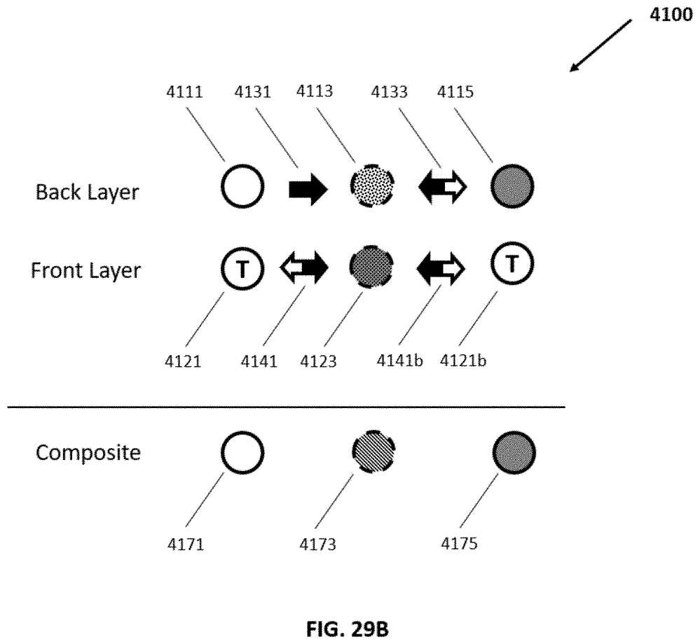

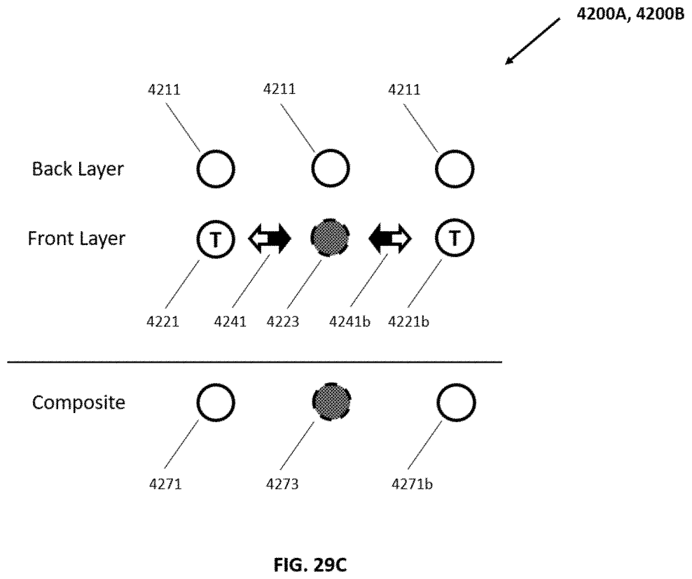

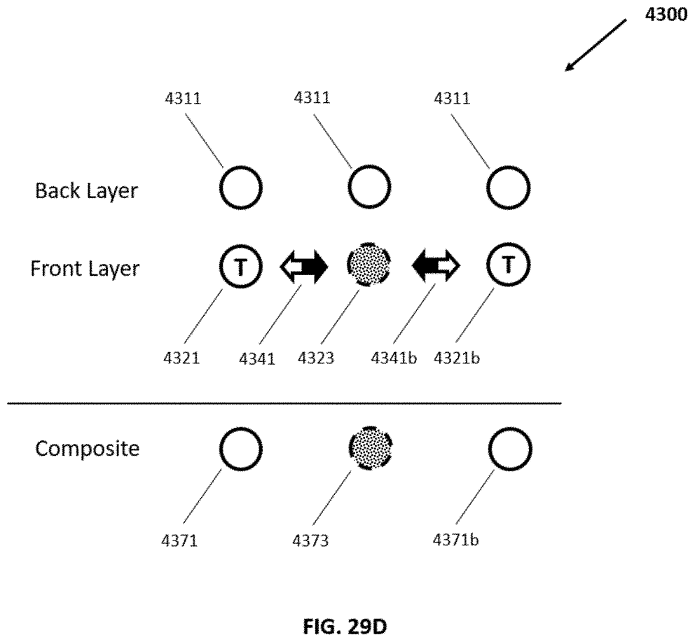

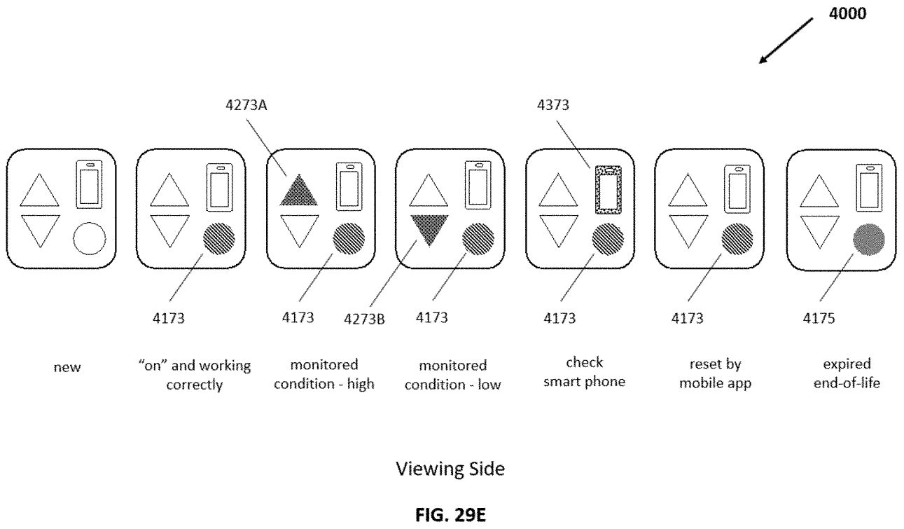

Described and illustrated now in FIGS. 29A-E and 30A-D are two exemplary polymorphic dashboards (4000 and 5000 respectively). The polymorphic indicators of each dashboard comprise two shared electro-optic layers (front and back). The exemplary applications are wirelessly enabled medical wearable devices (monitors) but it should be understood that there are many other configurations and applications as well.

FIG. 29A illustrates a polymorphic dashboard 4000 comprising four polymorphic status indicators 4100, 4200A and 4200B, and 4300. Status indicator 4100 visibly messages the operable status of the wearable device: that it is working, working correctly, about to expire, expired or reached its end-of-life. Status indicator 4200A visibly messages whether a monitored condition is high while status indicator 4100B visibly messages whether the monitored condition is low. Status indicator 4300 visibly messages that an action is required of a user: the user should check that status of the wearable device with their smart phone.

As noted above, the front and back electro-optic layers of each status indicator are common to all of the status indicators that comprise polymorphic dashboard 4000. The differences in operable states and optical states, and composite operable states and visible messages, are determined by the signal protocol and the status of the monitored conditions for each indicator.

FIG. 29B illustrates operable states, transition sequences and corresponding optical states of the electro-optic layers, and their composite operable states and viewable messages (transitions are not shown for the composites) for status indicator 4100. As with status indicators 4200A, 4200B and 4300, the initial stable state and visible message (colorless, a neutral color) 4171 is a composite of the back layer optical state (neutral color, white) 4111 and front layer optical state (transparent) 4121.

For status indicator 4100 the visible message (neutral) 4171 communicates that the wearable device has never been “turned on” (activated), is not “on” (and working correctly) or it has not expired. When the wearable device is turned on for the first time, the back layer is switched 4131 and irreversibly transitions from stable state and (neutral) optical state 4111 to volatile operable state and optical state (yellow) 4113. Concurrently the front layer is switched 4141 from stable state and optical state (transparent) 4121 to volatile state and optical state (cyan) 4123, producing composite visible message (green) 4173—the wearable device has been turned on and is working correctly.

If the wearable device fails (power is disrupted or unintentionally terminated), or expires the back layer self-switches 4133 (or is intentionally switched—not shown) from volatile state and optical state (yellow) 4113 and transitions to stable state and optical state (red) 4115. Concurrently, the front layer automatically self-switches 4141b (or is intentionally switched not shown) from volatile state and optical state (blue) 4123 and transitions to stable state and optical state (transparent) 4121b, producing composite visible message (red) 4175—the wearable device has reached its “end-of-life” and is not fit-for-use.

FIG. 29C illustrates operable states, transition sequences and corresponding optical states of the electro-optic layers, and their composite operable states and viewable messages (transitions are not shown for the composites) for status indicators 4200A and 4200B. The initial stable state and visible message (neutral) 4271 for both indicators is a composite of their back layer optical state (colorless, a neutral color) 4211 and their front layer optical state (transparent) 4221.

For status indicator 4200A the optical state (neutral) 4271 visibly messages that the monitored condition is “not high”. For status indicator 4200B the optical state (neutral) 4271 visibly messages that the monitored condition is “not low”. In the presence of visible message (green) 4173 presented by status indicator 4100 (described above and illustrated in FIG. 29A), the two visible messages 4171 presented by status indicators 4200A and 4200B cooperate to indicate that the monitored condition is “OK”—it's neither high or low, and not an indication that the wearable device is not be working correctly.

According to the shape (‘up’ direction symbol) of status indicator 4200A, if the monitored condition is high, then the front layer of status indicator 4200A is switched 4241 and transitions from the stable state and optical state (transparent) 4221 to volatile state and optical state (blue) 4223, producing composite visible message (color: blue and symbol: ‘up’) 4273. According to the shape (‘down’ direction symbol) of status indicator 4200B, if the monitored condition is low, then the front layer of status indicator 4200B is switched 4241 and transitions from the stable state and optical state (transparent) 4221 to volatile state and optical state (blue) 4223, producing composite visible message (color: blue and symbol: ‘down’ direction) 4273.

Note that only one of status indicators 4200A or 4200B can present a non-neutral (blue) visible message 4373 at the same time. And, if the monitored condition returns to an “OK” status, then the front layer will be intentionally self-switched 4241b by terminating the maintenance signal (or intentionally switched—not shown) and transition the volatile state and optical state (blue) to the stable state and optical state 4221b, and thus transition visible message (blue) 4273 to visible message (neutral) 4275b.

FIG. 29D illustrates operable states, transition sequences and corresponding optical states of the electro-optic layers, and their composite operable states and viewable messages (transitions are not shown for the composites) for status indicator 4300. As with status indicators 4100, 4200A and 4200B, the initial stable state and visible message (neutral) 4371 is a composite of the back layer optical state 4311 (colorless, a neutral color) and front layer optical state 4321 (transparent).

For status indicator 4300 the initial visible message (neutral) 4371 communicates that the monitored condition does not require a user action-specifically checking the wearable device with their smart phone (e.g., to make sure they're periodically paying attention to monitored condition). If the action is required then the front layer of status indicator 4300 is switched 4341 to transition from stable state and optical state (transparent) 4321 to volatile state and optical state (yellow) 4323 producing a composite visible message (color: yellow and shape: “smart phone”) 4373 that communicates a monitored condition requires a user action. When the monitored condition no longer requires the user action (or the device fails or expires) then the front layer automatically self-switches 4341b (or is intentionally switched—not shown) to stable state and optical state (transparent) 4321b, producing neutral visible message (color and shape) 4371b. The same process may be used to reset indicator 4300 if and when the user checks the wearable device in response to visible message 4373.

FIG. 29E illustrates exemplary visible messages that can be produced by polymorphic dashboard 4000.

FIG. 30A illustrates a polymorphic dashboard 5000 comprising three polymorphic status indicators 5100, 5200A and 5200B. Similar to status indicator 4100, status indicator 5100 visibly messages the operational status of the wearable device: that it has been turned on, it's working and working correctly, about to expire, or it's expired or reached its end-of-life. And similar to status indicators 4200A and 4200B, status indicator 5200A visibly messages whether a monitored condition is high and status indicator 5200B whether the monitored condition is low.

FIG. 30B illustrates operable states, transition sequences and corresponding optical states of the electro-optic layers, and their composite operable states and viewable messages (transitions are not shown for the composites) for status indicator 5100. The initial visible message (red) 5171 is a composite of the back layer optical state (red) 5111 and front layer optical state (transparent) 5121.

For status indicator 5100 the composite optical state (red) 5171 visibly messages that the wearable device is not “on” or otherwise ready for use. When the wearable device is turned “on” and it is functioning correctly, the back layer is switched 5131 from stable state and optical state (red) 5111 to volatile state and optical state (yellow) 5113. Concurrently the front layer is switched 5141 from stable state and optical state (transparent) 5121 to volatile state and optical state (cyan) 5123 producing a composite visible message (green) 5173 that indicates the wearable device is “on” and functioning correctly.

In this example, if the wearable device is about to expire the front layer is then intentionally self-switched by terminating power to the front layer 5141b (or intentionally switched—not shown) from the volatile state and optical state (cyan) 5123 to stable state and optical state (transparent) 5121b, producing a composite visible message (yellow) 5175 that indicates “expiration is pending”. Later if the wearable device expires, fails or otherwise ceases to be fit-for-use, the back layer automatically self-switches 5131b (or is intentionally switched not shown) from volatile state and optical state (yellow) 5113 to stable state and optical state (red) 5111b, producing a composite visible message (red) 5171b that indicates the wearable device has reached its “end-of-life” and is no longer to be used. Other transitions sequences are possible with the same polymorphic dashboard. If for example, the wearable device fails prior to generating an ‘expiration pending’ visible message (yellow) 5175, the “end-of-life” message 5171b would be automatically generated.

FIG. 30C illustrates operable states, transition sequences and corresponding optical states of the electro-optic layers, and their composite operable states and viewable messages (transitions are not shown for the composites) for status indicators 5200A and 5200B. The initial stable state and visible message (neutral) 5271 for both indicators is only the front layer optical state (transparent) 5221 due to reflective mask layer 5205.

Similar to polymorphic dashboard 4000, the front and back electro-optic layers of each indicator are common to all the status indicators of polymorphic dashboard 5000. Status indicators 5200A and 5200B (but not 5100) however also have a mask layer (reflective, white) 5205 interposed between the front and back electro-optic layers. The back layer of status indicators 5200A and 5200B (and 5100) each have an initial stable state and optical state (red) 5211, however because of the mask layer, the optical state of their back layers doesn't contribute to the composite operable state or visible message 5271, and their initial composite visible message 5271 is therefore neutral.

Similar to status indicators 4100A and 4100B, status indicators 5200A and 5200B indicate whether a monitored condition is high or low. If the monitored condition is high or low then the front layer of status indicator 5200A or 5200B respectively, is switched 5241 from an initial stable state and optical state (neutral) 5221 to transition to volatile state and optical state (blue) 5223. The composite visible messages produced (color: blue and shape: ‘up’ direction or “down” direction respectively) 5273 communicate the status of the monitored condition. When the monitored condition is no longer high or is no longer low (or the device fails or expires) then the front layer of status indicator 5200A or 5200B automatically self-switches 5241b (or is intentionally switched—not shown) to stable state and optical state (transparent) 5221b, producing composite visible message (neutral color and shape) 5271b.

Note that depending on the signal protocol the status indicators of polymorphic dashboard 5000 operate individually or in combination. For example, monitored condition status indicators 5200A or 5200B cannot concurrently present a visible message 5271 (a monitored condition cannot be simultaneously high and low)—except when the monitored condition is “OK” at which times the visible messages for both indicators 5200A and 5200B are neutral 5271.

Operating status indicator 5100 however can present an “expiration pending” visible message 5175 concurrently with either monitored condition status indicator 5200A or 5200B. If either status indicator 5200A or 5200B is visibly messaging an ‘active’ status (non-neutral) visible message 5273 and the wearable device fails, the front layer of the status indicator (5200A or 5200B) will automatically self-switch 5241b from the volatile state and optical state (blue) 5223 to stable state and optical state (transparent) 5221b and produce visible message (neutral) 5271b. Concurrently, the back layer of operating status indicator 5100 will automatically self-switch 5131b from volatile state and optical state (yellow) 5113 to stable state and optical state (red) 5111b producing a visible message (red) 5171b: end-of-life”.

FIG. 30D illustrates exemplary visible messages such as those described above that can be produced by polymorphic dashboard 5000.

Polymorphic Dashboards and Display Devices

Polymorphic dashboards (and the polymorphic pixels that comprise them)—and more generally polymorphic display devices, have the advantage of conveying actionable messages without complex circuitry or connections (or substantial power). A single polymorphic (status) indicator for example may require as few as two address lines/connections.

In general, a polymorphic dashboard or polymorphic display device may be:
A discrete device (e.g., a thin film device—typically without electronic components) or printed/fabricated directly on the substrate/circuitry of a smart device (additive manufacturing)
Flexible, semi-flexible, semi-rigid, rigid
Comprised of materials that individually or in combination, are:
   Patterned, layered, common to more than one indicator
   Viscous, semi-solid or solid
   Printed, deposited (e.g., sputtered, evaporated)
   Ablated, scribed, (laser-)textured, etc.
Designed to be outward/user facing when assembled as part of a subassembly or finished good (or viewable from front and back surfaces); snapped, twisted, adhered or otherwise couple to/assembled with another component or assembly (e.g., a cover to a base, or a printed circuit board or flexible hybrid electronic assembly)
Fabricated as, or integrated with, fit-for-purpose structures/forms (e.g., enclosures, covers, bases, shells, containers etc.).
Fabricated by laminating, adhering or otherwise bonding one or more appropriately constructed films, each comprising an electro-optic layer, that cooperate to produce one or more polymorphic indictors. Each film comprising appropriate electrodes/circuitry for independently switching their respective addressable elements. Each film may also comprise a carrier substrate (film) that can be removed prior to merging/adhering to companion film (e.g., to achieve a thinner combined stack). For example:
   A mono-stable (volatile) film and a bi-stable film
   A mono-stable (volatile) film and a polymorphic film (e.g. having both stable and volatile states)
   A bi-stable film and a polymorphic film

Polymorphic dashboards and polymorphic display devices, and related structures or assemblies may be further advantageously fit-for-purpose with one or more of:
electrical contacts and electro-mechanical connectors
communication circuitry, antennas, receivers (single or multiple types)
energy harvesters (RF, optical or other EM radiation)
sensors
focusing layer (described previously)

The status indicators of an appropriately configured polymorphic dashboards or display device may be externally (and actively) switched via the application of electrical, RF or optical signals. They may also have one or more printed areas adjacent to fail-safe indicators, with or for information related to the messages they present.

A polymorphic dashboard or polymorphic display device may further comprise an emissive backlight or front-light typically in the form of e.g., a thin-film light layer (light guide/channel+side mounted LED emitter), or printed OLED. The light layer may be considered an electro-optic layer (such as described in FIGS. 27 and 28) or a separate layer e.g., positioned for example in front of the front substrate of the front electro-optic layer (reflective) or in back of the back substrate of the back electro-optic layer (transmissive).

Multi-Layer Hybrid Emissive/Non-Emissive Displays and Dashboards

A multi-layer display or dashboard (described above) may comprise one or more hybrid emissive/non-emissive electro-optic layers. A hybrid emissive/non-emissive electro-optic layer may be polymorphic.

Similarly to the ML displays and ML dashboards described above, a ML pixel (or indicator) set comprising a hybrid emissive/non-emissive electro-optic layer may have the same operable properties (e.g., mono-stable, switchable, self-switching) as those of another pixel set (but different optical states corresponding to their operable states) or they may have different operable properties than the other pixel set and be polymorphic. A ML display (or dashboard) may have a set of pixels (or indicators) that comprise a hybrid emissive/non-emissive electro optic layer and a non hybrid emissive/non-emissive electro-optic layer. A ML display (or dashboard) may have a set of pixels that comprise a hybrid emissive/non-emissive electro optic layer and a non hybrid emissive/non-emissive electro-optic layer, and another set of pixels that comprise (1) only one or more hybrid emissive/non-emissive electro-optic layers, or (2) one or more non-hybrid emissive/non-emissive electro-optic layers. A ML display may also comprise a plurality pixels sets that have an emissive-non-emissive electro-optic layer in common.

A ML display or dashboard may be polymorphic according to the composite operable states of the electro-optic layers that comprise its pixels.

Smart Polymorphic Dashboards

A smart polymorphic dashboard is a polymorphic dashboard further comprising some or all of electronics, power apparatus, a communication apparatus, sensors, actuators, and auditor circuitry, and configured to be coupled to, or integrated with, a smart product. These capabilities enable smart polymorphic dashboards to cooperate with the smart products in the event of loss or disruption of power, or hardware or software system malfunctions. And further to share with, and distribute resources between, the smart product and the dashboard, and to simplify manufacturing and integration.

Electronics

Electronics for intelligent display devices are described above and similarly, smart polymorphic dashboards advantageously include preprogrammed or programmable ICs or ASICs

that include the functionality of processors, memory, and clocks/timers, and enable and manage the following apparatuses.

Power Apparatus

A smart polymorphic dashboard may comprise one or more fit-for-purpose apparatuses for supplementing the power provided by the smart product to which the dashboard is coupled, or for providing all the power required for the dashboard to operate independently from the smart product, if for example power from the smart product is unintentionally terminated or disrupted. In the latter case the power apparatus would enable the dashboard to switch the dashboard's indicators to present “fail-safe” visible messages or perform audit functions (described below).

In some use cases, the power apparatus of smart polymorphic dashboard may power specific functions of the smart product, for example to enable the dashboard to access stored information from the smart product (e.g., event histories, last-known-good related information) in the event the smart product malfunctions or loses power. Or to provide short duration back-up power to enable the smart product to shut down, archive/store information for later retrieval etc.

Exemplary power apparatus include batteries or charged capacitors, wired interfaces capable of receiving electrical energy, wireless energy harvesters, or a combination thereof. Energy harvesters particularly suited for dashboards include, but are not limited to those that produce electric energy from light (e.g. solar cell), RF energy (e.g., antenna/rectifier).

Communication Apparatus

Smart polymorphic dashboards may have fit-for-purpose wired (contact, contactless) or wireless communication circuitry to enable communication to and from the smart product, and to enable external devices to directly communicate with smart polymorphic dashboards (e.g., to access stored information in the event the smart product loses power or malfunctions). Exemplary wireless communication apparatus particularly suited to smart polymorphic dashboards include Bluetooth, BLE, RFID (e.g. RAIN or NFC), or ZigBee.

Driver Circuitry

A smart polymorphic dashboard may have driver circuitry (e.g., an IC or ASIC and appropriate circuits) configured to receive ‘write’ commands signals (via the communication apparatus) from a smart product (or convert the output of electronics in the dashboard) and accordingly generate and apply electrical signals (e.g., switching and maintenance signals) to the dashboard's polymorphic indicators. This would reduce the number of I/O pins/connectors of the smart product's controller/processor (or those of the dashboard's electronics) and the complexity and risk of failure, of the circuitry between the smart product and the dashboard's indicators.

Verification Circuitry

Alone or in common with driver circuitry, a smart polymorphic dashboard may have state detection or verification circuitry (electrical or optical) such as that described in U.S. Pat. No. 10,152,905 entitled Symbol Verification for an Intelligent Label Device, U.S. Pat. No. 10,078,977 entitled Optically Determining Messages on a Display or U.S. Pat. No. 9,892,663 entitled An Intelligent Label Device and Method. A smart polymorphic dashboard's electronics further may be configured to take the output or results of a verification process and accordingly produce new visible messages (or audible or wireless alerts), or communicate the output or results to the smart product.

In support of optical verification, a smart polymorphic dashboard may comprise a light detection layer, e.g., a thin-film photosensitive material(s) (advantageously patterned) and appropriate circuitry and depending on the embodiment, a light source, e.g., a thin-film light layer (light guide/channel+side mounted LED emitter), or printed OLED.

Actuators

Depending on the application, a smart polymorphic dashboard may have one or more actuators. As previously described, actuators activate, deactivate or otherwise effect control over electrical functions in the dashboard in response to external or internal stimulus, e.g. mechanical action, sensor input, electrical or wireless signals etc. Actuators may also minimize power consumption, and thereby maximize the shelf-life/operating life of the dashboard having an internal power apparatus, by activating the electronics only when appropriate to the application. Actuators, in cooperation with timers/clocks may also be used to establish the time/date an event occurs.

Due to their user-facing position, smart polymorphic dashboards may be a convenient interface for users. Actuators may therefore be strategically placed to receive external stimuli and pass along related signals to companion smart products.

Exemplary actuators for smart polymorphic dashboards include mechanical switches (e.g. the open or close an electrical circuit), electro-optic, electrochemical, electro-mechanical and electro-acoustic devices, wired connectors (for receiving electrical signals), wireless receivers (for harvesting RF energy, receiving RF signals). Actuators may also include tactile user interfaces that favorably activate or transition the electronics from a low (idle) power/energy state via user action. Exemplary tactile user interfaces include: haptic/touch (e.g., capacitive sensor/film) and “taptic” (e.g., single, double, pattern).

Auditor Circuitry (“Auditor”)

A smart polymorphic dashboard (or an intelligent display device as previously described) may also comprise an auditor. An auditor comprises electronics and circuitry electrically coupled to an energy source (e.g., battery) from the smart product, or an energy source integrated with the dashboard (e.g., a charged capacitor). Periodically, on demand or in response to an external signal or communication, the auditor audits, that is determines, the operational state of the hardware or software, processor and/or other components, of the smart product. Alternatively, the processor of the smart product performs the audit and the dashboard periodically (or on demand) receives from the smart product receipts of the audits. The absence of an audit communication from the smart product is by itself an indication of a malfunction.

The auditor is advantageously configured such that, if according to the audit the smart product or an element thereof is not functioning correctly (or fails to receive a receipt of a successful audit as scheduled or demanded) the auditor automatically executes a visual alert process(es), e.g.:
Terminates a maintenance signal to an indicator so the indicator will automatically self-switch to a visual alert message, or
Switches an indicator from a volatile state to a stable visual alert state (accelerates self-switch), or
Switches an indicator from a stable state to another stable visual alert state

Depending on the configuration of the dashboard and determined operable state of the hardware and software of the smart product, the auditor may also trigger an audible or wireless or wired, alert or communication. Advantageously, the dashboard's electronics (or the smart product depending on its operable state) record (store in their respective memory) the results of the last-known-good date/time a successful audit was performed (or a receipt of a successful audit), or was not performed if capable of doing so.

The auditor may advantageously or optionally comprise fail-safe transfer switch circuitry which provides for an active switching signal to quickly drive a polymorphic fail-safe indicator volatile state into a (first or second) stable state. E.g., using a fail-safe “transfer switch” (double-pole, double-throw; or 2X single-pole, double-throw) to flip a drive signal to a capacitor (e.g., same substrate, electrolyte as indicator) with enough charge and voltage to drive a polymorphic indicator to its stable state (opposite polarity of maintenance signal). The term “fail-safe transfer switch” refers to a characteristic whereby at a minimum one switch path defaults to a low loss state, when all power is removed.

While particular preferred and alternative embodiments of the present intention have been disclosed, it will be appreciated that many various modifications and extensions of the above described technology may be implemented using the teaching of this invention. All such modifications and extensions are intended to be included within the true spirit and scope of the appended claims.

1. A polymorphic dashboard comprising:
a first set of indicators and a second set of indicators, the indicators in each set comprising:
a front electro-optic layer and a set of electrodes adjacent the front electro-optic layer, the front electro-optic layer having a first set of operable properties;
a back electro-optic layer and a set of electrodes adjacent the back electro-optic layer, the back electro-optic layer having a second set of operable properties;
supporting structure;
wherein the operable properties include (1) stability, (2) transition sequencing, and (3) switching, and the operable property of stability is selected from the group consisting of: mono-stable, bi-stable, multi-stable, and permanent; (2) transition sequencing is selected from the group consisting of: reversible, irreversible, repeatable, non-repeatable, and branching; and (3) switching is selected from the group consisting of: electrically switchable, self-switchable and non-switchable;
wherein the optical states of the front electro-optic layer and the optical states of the back electro-optic layer of each set of indictors are determined by their respective operable states, and the optical state of each indicator is a composite of the optical states of the electro-optic layers that comprise the indicator;
wherein the operable properties of an electro-optic layer of the first pixel set or of the second pixel set, are different from the operable properties of one of the other electro-optic layers.

2. The polymorphic dashboard of claim 1, wherein the supporting structure comprises a substrate adjacent the back of the back electro-optic layer and a substrate adjacent the front of the front electro-optic layer.

3. The polymorphic dashboard of claim 2, wherein the supporting structure further comprises a middle substrate between the front electro-optic layer and the back electro-optic layer.

4. The polymorphic dashboard of claim 2, wherein the supporting structure further comprises a substrate adjacent the back of the front electro-optic layer and a substrate adjacent the front of the back electro-optic layer.

5. The polymorphic dashboard of claim 4, wherein the front electro-optic layer, adjacent electrodes and supporting structure and the back electro-optic layer, adjacent electrodes and supporting structure are constructed as separate films bonded to each other.

6. The polymorphic dashboard of claim 2, wherein the substrate in front of the front electro-optic layer is an encapsulant or a sealant.

7. (canceled)

8. The polymorphic dashboard of claim 1, wherein the first indicator set and the second indicator set have an electro-optic layer in common or an electrode in common.

9. The polymorphic dashboard of claim 1, wherein the front electro-optic layer or back electro-optic layer of the first indicator set, or the front electro-optic layer or the back electro-optic layer of the second indicator set, comprise a patterned material.

10. The polymorphic dashboard of claim 1, wherein the electrode set adjacent the front electro-optic layer or the electrode set adjacent the back electro-optic layer of the indicators comprising the first indicator set or the second indicator set, are patterned.

11. The polymorphic dashboard of claim 1, wherein the indicators comprising the first indicator set and the indicators comprising the second indicator set have an electrode in common.

12. The polymorphic dashboard of claim 11, wherein the electrode in common is interposed between the first electro-optic layer and the second electro-optic layer.

13. The polymorphic dashboard of claim 1, wherein an electro-optic layer of the first indicator set or an electro-optic layer of the second indicator set is polymorphic.

14. The polymorphic dashboard of claim 1, wherein the initial composite optical state of the indicators comprising the first indicator set or the indicators comprising the second indicator set, are transparent, colorless or slightly colored.

15. The polymorphic dashboard of claim 1, wherein the first set of indicators or the second set of indicators comprises a mask layer.

16. The polymorphic dashboard of claim 15, wherein the mask layer is interposed between the first electro-optic layer and the second electro-optic layer.

17. The polymorphic dashboard of claim 1, wherein the first set of indicators or the second set of indicators comprises a fixed image.

18. The polymorphic dashboard of claim 1, wherein the composition of one of the electro-optic layers of the first set of indicators or the second set of indicators is different from at one of the other electro-optic layers.

19. The polymorphic dashboard of claim 18, wherein the composition of the electro-optic layers are from among electrochromic materials, liquid crystals, electrophoretic particles, electrowetting fluids, electro-liquid powder materials, plasmonic nanostructures, optical interference stacks, photonic crystals, organic or inorganic light emitting materials, photo-emissive and electro-emissive materials, or a combination thereof.

20. The polymorphic dashboard of claim 1, wherein one of the electro-optic layers of the first set of indicators or the second set of indicators is emissive or is hybrid emissive/non-emissive.

21. (canceled)

22. The polymorphic dashboard of claim 1, further comprising a backlight wherein the first indicator set or the second indicator set is at least partially transparent or a front light wherein the first indicator set or the second indicator set is at least partially reflective.

23. The polymorphic dashboard of claim 1, wherein the optical states of a set of indicators are viewable from the front or the back of the dashboard.

24. The polymorphic dashboard of claim 1, further comprising a third electro-optic layer, adjacent electrodes and support structure.

25. The polymorphic dashboard of claim 1, further comprising at least one of: electronics, a power apparatus, a communication apparatus, driver circuitry, verification circuitry, an actuator, auditory circuitry, a sensor, or a focusing layer.

26-155. (canceled)
